(19) United States
(12) Patent Application Publication
(10) Pub. No.: US 2026/0098493 A1
(43) Pub. Date: Apr. 9, 2026

(54) Turbine Control for Improved Dosing

(71) Applicants: Cummins Emission Solutions, Inc., Columbus, IN (US); Cummins Ltd., Paddington (GB)

(72) Inventors: Samuel Johnson, Columbus, IN (US); Atif Mahmood, Huddersfield (GB); Chetan Kishorrao Chawane, Pune (IN); Mohemmedtayab A. Mujawar, Pune (IN)

(21) Appl. No.: 19/113,121

(22) PCT Filed: Sep. 19, 2023
(86) PCT No.: PCT/GB2023/052421

§ 371 Date: Mar. 19, 2025

Related U.S. Application Data
(60) Provisional application No. 63/408,014, filed on Sep. 19, 2022.

(30) Foreign Application Priority Data
Jul. 26, 2023 (GB) 2311447.3

(51) Int. Cl. F02B 37/18; F01N 3/20; F01N 5/04

(52) U.S. Cl. CPC F02B 37/18; F01N 3/206; F01N 5/04; F01N 2900/1404

(57) ABSTRACT

There is disclosed a method of operating an exhaust system for receiving exhaust gas from an internal combustion engine. The exhaust system comprises: a turbine, a dosing module, at least one of a variable geometry mechanism and a bypass control valve, and a controller. The turbine is configured to receive exhaust gas from the internal combustion engine. The turbine comprises a turbine wheel configured to extract energy from the exhaust gas. The dosing module is configured to deliver an aftertreatment fluid to the exhaust gas at a position downstream of the turbine wheel. The variable geometry mechanism is configured to control the flow of exhaust gas delivered to the turbine wheel. The bypass control valve is configured to bypass a portion of the exhaust gas from a position upstream of the turbine wheel to a position downstream of the turbine wheel. The controller is configured to execute the method, the method comprising: determining a current property of the exhaust gas at a position downstream of the turbine wheel; determining a difference between the current property of the exhaust gas at the position downstream of the turbine wheel and a reference property of the exhaust gas at the position downstream of the turbine wheel; and in response to the difference, adjusting the at least one of the variable geometry mechanism and the bypass control valve.

### FIELD OF THE DISCLOSURE

The present disclosure relates to methods of operating an exhaust system, exhaust systems, controllers, a turbocharger system, and an engine arrangement.

### BACKGROUND OF THE DISCLOSURE

Turbochargers are used within internal combustion engine systems to increase the pressure of the intake air entering the internal combustion engine to a pressure above atmospheric pressure. This is known as a “boost pressure”. By increasing the pressure of the intake air entering the internal combustion engine, more oxygen is available within the internal combustion engine to support the combustion of a larger amount of fuel, and therefore increases the amount of power produced by the engine.

Turbochargers comprise a compressor and a turbine. The compressor comprises a compressor wheel configured to impart energy to an incident fluid stream, and the turbine comprises a turbine wheel configured to extract energy from an incident fluid stream. The compressor wheel and the turbine wheel are attached to opposite ends of a turbocharger shaft, such that the two rotate in unison. The compressor receives intake air from the atmosphere and delivers the intake air to an intake manifold of the internal combustion engine. The turbine receives exhaust gas from an exhaust manifold of the internal combustion engine and delivers the exhaust gas to an aftertreatment system. During use, exhaust gas leaving the internal combustion engine passes through the turbine, causing the turbine wheel to rotate. The rotation of the turbine wheel drives the compressor wheel, which acts to compress the intake air as it is delivered to the intake manifold.

Exhaust gases from internal combustion engines contain substances that are harmful to the environment. Most countries have vehicle emission standards which limit the amount of such substances that an internal combustion engine system is permitted to emit. Consequently, modern internal combustion engine systems comprise exhaust gas aftertreatment systems designed to remove harmful substances from the exhaust gas.

Typically, an exhaust gas aftertreatment system will comprise a particulate filter and one or more catalytic reducers. The particulate filter removes heavy combustion products, e.g., soot, from the exhaust gas. The catalytic reducers remove harmful substances such as Nitrogen Oxides (NOx) from the exhaust gas. Catalytic reducers generally comprise a large number of narrow channels made from a material selected to support a chemical reaction that removes NOx from the exhaust gas. The narrow channels provide a large surface area for the catalytic reaction to take place. Several kinds of catalytic reducers are available on the market, such as two-way catalytic reducers, three-way catalytic reducers, diesel oxidation catalytic reducers (DOCs), and selective catalytic reducers (SCRs). DOCs and SCRs are typically employed in diesel engine systems. For the SCRs specifically, in order for the SCR reaction to work, it is necessary to mix an exhaust gas aftertreatment fluid with the exhaust gas before it enters the catalytic reducer. The exhaust gas aftertreatment fluid is usually a mixture of around 30% to 35% by volume urea (CO(NH₂)₂) to about 65% to 70% by volume deionised water (H₂O). The exhaust gas aftertreatment fluid is often referred to as Diesel Exhaust Fluid (DEF) and is commonly available under the registered trademark AdBlue.

Conventionally, the DEF is mixed with the exhaust gas in a decomposition chamber. The DEF is injected into the decomposition chamber using a dosing module. In the decomposition chamber, heat is exchanged from the exhaust gas to the DEF which causes the water within the DEF to evaporate and the urea to thermally decompose into the reductants ammonia (NH₃) and Isocyanic Acid (HNCO) which are required to support the SCR reaction.

A typical decomposition chamber comprises a relatively large cross-sectional area in comparison to the width of standard exhaust gas ducting. Exhaust gas entering the decomposition chamber expands, causing the velocity of the exhaust gas to reduce and the pressure of the exhaust gas to increase. This rapid expansion of the exhaust gas causes the formation of turbulent vortices. DEF is then injected into the decomposition chamber, whereupon the turbulent vortices encourage mixing of the DEF with the exhaust gas. The heat exchange between the exhaust gas and the DEF causes the urea in the DEF to decompose into the reductants, and the mixture of reductants and exhaust gas is then passed to the SCR.

If the exhaust gas and DEF are not mixed well enough, the heat exchange between the DEF and the exhaust gas will not be sufficient to decompose the DEF into the required reductants. Furthermore, poor mixing means that the reductants are not evenly distributed within the flow, and therefore some channels of the catalytic reducer will not receive enough reductant to support the SCR reaction. To ensure adequate mixing, it is common for the decomposition chamber to comprise a mixing plate configured to generate additional turbulence. However, the additional turbulence caused by the mixing plate and the fluidic friction exerted by the mixing plate on the exhaust gas creates a backpressure on the exhaust gas in the decomposition chamber. This back pressure is passed upstream and acts to increase the pumping work required by the internal combustion engine, and accordingly reduces the overall efficiency of the engine system. Accordingly, there is need for improvement in this technical area.

Injecting DEF into exhaust gas can also lead to operational challenges. For example, injecting DEF risks the build-up of deposits in the exhaust system if the DEF is not thoroughly mixed with exhaust gas. Similarly, certain engine operating regimes may reduce the likelihood that the DEF be thoroughly mixed with exhaust gas in operation, and therefore increase the risk of deposit build-up in the exhaust system. The build-up of deposits risks increasing backpressure across the system, and so the reliable, and efficient, operation of the exhaust system.

There exists a need to provide alternative systems which overcome one or more of the disadvantages of known systems, whether mentioned in this document or otherwise.

### SUMMARY OF THE DISCLOSURE

According to a first aspect of the disclosure, there is provided a method of operating an exhaust system for receiving exhaust gas from an internal combustion engine, the exhaust system comprising: a turbine configured to receive exhaust gas from the internal combustion engine, the turbine comprising a turbine wheel configured to extract energy from the exhaust gas; a dosing module configured to deliver an aftertreatment fluid to the exhaust gas at a position downstream of the turbine wheel;
at least one of: a variable geometry mechanism configured to control the flow of exhaust gas delivered to the turbine wheel; and a bypass control valve configured to bypass a portion of the exhaust gas from a position upstream of the turbine wheel to a position downstream of the turbine wheel; and a controller configured to execute the method, the method comprising: determining a current property of the exhaust gas at a position downstream of the turbine wheel; determining a difference between the current property of the exhaust gas at the position downstream of the turbine wheel and a reference property of the exhaust gas at the position downstream of the turbine wheel; and in response to the difference, adjusting the at least one of the variable geometry mechanism and the bypass control valve.

Adjusting the variable geometry mechanism may encompass changing the position of one or more flow influencing elements of the variable geometry mechanism, for example the angular position and/or angle of one or more nozzle vanes relative to an axis of the turbine (e.g., in a so-called “swing vane” variable geometry mechanism), and/or adjusting the axial position of a nozzle ring and/or shroud plate to vary the width of an annular inlet passage configured to guide exhaust gas into an inducer portion of the turbine wheel (e.g., in a so-called “sliding wall” variable geometry mechanism).

The bypass control valve may be a valve of any suitable valve arrangement that is able to bypass a portion of the exhaust gas from a position upstream of the turbine wheel to a position downstream of the turbine wheel. For example, the bypass control valve may be formed integrally with the turbine (e.g., in the form of a wastegate), may be external to the turbine (e.g., in the form of an external bypass), or may form part of an integrated valve system for throttling flow to the turbine and/or directing exhaust gas for exhaust gas recirculation to the engine inlet (e.g., a rotary control throttle valve). The bypass control valve may be a rotary valve, flap valve, poppet valve or other variety of valve. Adjusting the bypass control valve may encompass changing the position of the bypass control valve to vary the amount of fluid that is permitted to pass from one side of the bypass control valve to the other. The exhaust system may comprise a bypass passage within which the bypass control valve is positioned. The bypass control valve and the bypass control passage being configured to permit exhaust gas to pass from a position fluidly upstream of the turbine to a position fluidly downstream of the turbine without passing through the turbine wheel. The bypass passage and/or bypass control valve may be integrated into a turbine housing of the turbine (in a so-called “wastegate” arrangement), or may be non-integrated with the turbine housing.

The exhaust gas may encompass the products of combustion exhausted from the internal combustion engine. This may include, for example: carbon dioxide, carbon monoxide, sulphur dioxide, nitrogen oxides, lead, particulate matter or the like. The aftertreatment fluid may comprise any fluid that can be used in conjunction with a catalyst to treat exhaust gases to reduce one or more of the products of combustion. This may include, for example, hydrocarbons and in particular fuel such as gasoline or diesel for use with an oxidation catalyst, and additionally or alternatively may include ammonia or an ammonia and water mixture, for example in the proportion of 67.5% by volume water to 32.5% by volume urea (sometimes called diesel exhaust fluid (DEF) often sold under the registered trademark AdBlue) for use with a selective catalytic reduction (SCR) catalyst.

Determining a current property of the exhaust gas may encompass measuring, either directly or indirectly, a quantity of one or more physical properties of the exhaust gas. A direct measurement may encompass the use of a sensor exposed within the flow of exhaust gas, the sensor being configured to output a signal indicative of a quantity of a physical property of the exhaust gas, for example: temperature, velocity, pressure or the like. An indirect measurement may encompass a procedure in which the quantity of the physical property is inferred from information received relating to one or more other physical properties that have a physical relationship with the quantity of the property being inferred. For example, a formula or a look-up table stored within the controller may be used to infer a current property from one or more direct measurements of other properties. Described another way, the current property may be obtained indirectly.

The dosing module may deliver the aftertreatment fluid into the exhaust gas at a position downstream of the turbine wheel in such a manner that it creates an exhaust gas mixture. The exhaust gas mixture may encompass a mixture of the exhaust gas and the aftertreatment fluid, and in particular a mixture of the exhaust gas and aftertreatment fluid that has not decomposed into reductants, for example a mixture of exhaust gas and urea and/or water vapour. The current property may be a current property of the exhaust gas mixture, and the reference property may be a reference property of the exhaust gas mixture.

Determining the current property may comprise measuring a quantity of the property. For example, determining the current property may comprise directly measuring the quantity of the property using, for example, a sensor.

Determining the current property may comprise: measuring a quantity of one or more properties of an internal combustion engine system in which the exhaust system is incorporated; processing the measured quantity or quantities in a computational operation; and inferring the current property of the exhaust gas from the computational operation. The one or more properties of the exhaust gas may be different physical properties to the property being determined or may be a mixture of the same and different physical properties to the property being determined. The computational operation may encompass receiving the measured quantity or quantities as inputs in the operation of a mathematical formula stored in a memory of the controller, and/or as inputs in the operation of a dataset, such as one or more so-called ‘look-up’ tables, stored in the memory of the controller. The one or more properties measured as part of the step of determining the current property may be properties of the exhaust gas, however in other embodiments the one or more properties measured as part of the step of determining the current property may be any relevant property of the internal combustion engine system. Measuring a quantity of one or more properties of the exhaust gas and/or mixture may comprise measuring a quantity of one or more physical properties of the exhaust gas and/or mixture.

Measuring the one or more properties of the exhaust gas may comprise measuring one or more of: a turbine inlet pressure; a turbine inlet temperature; a turbine outlet pressure; a turbine outlet temperature; an engine speed; a throttle position; an engine air mass flow rate; an engine inlet pressure; an engine inlet temperature; a NOx concentration; a catalyst gas temperature; an engine fuel flow rate, an engine air flow rate, an engine boost pressure, an engine load, an engine cylinder temperature, an engine cylinder pressure, an engine fuel pressure, or a turbine rotational speed.

The turbine inlet pressure or temperature may be the pressure or temperature of the exhaust gas within an inlet of the turbine, for example, immediately upstream of the turbine wheel, within a housing configured to guide exhaust gas to the turbine wheel for example in a volute, or within a duct immediately upstream of and leading to such a housing.

The turbine outlet pressure or temperature may be the pressure or temperature of the exhaust gas and/or mixture within an outlet of the turbine, for example, immediately downstream of the turbine wheel, within a housing configured to receive exhaust gas from the turbine wheel, for example, in an axial conduit or a diffuser, or within a downpipe immediately downstream of such a housing.

In general, pressure may be measured using a pressure sensor, for example, a pitot tube or other such sensor in gas flow communication with the exhaust gas. Temperature may be measured using a thermometer in gas flow communication with the exhaust gas, a temperature sensitive switch or the like.

The engine speed may be a rotational speed of the engine. The engine speed may be measured, for example, using a tachometer or the like. The engine load may be the load applied to the engine by the system in which the engine is incorporated, for example, vehicular load or the like.

The throttle position may be an angular position of a throttle valve, for example, a throttle on the intake side and/or exhaust side of the engine. The engine air mass flow rate may be the mass flow rate of the air entering the engine. The engine inlet pressure or temperature may be the pressure or temperature of the air entering the engine, for example, in the inlet manifold. The throttle position, engine mass flow rate, engine inlet pressure and engine inlet temperature may be used to infer an engine load. The engine load may be processed in conjunction with one or more measured properties of the exhaust gas in the computational operation to infer the current property of the exhaust gas.

The current property of the exhaust gas may comprise a current temperature profile of the exhaust gas, and the reference property of the exhaust gas may comprise a reference temperature profile of the exhaust gas. The temperature profile of the exhaust gas and aftertreatment fluid mixture may encompass the temperature of a singular spatial position within the mixture and/or a distribution of temperatures across multiple spatial positions within the mixture and/or an average temperature across multiple spatial positions within the mixture. The temperature profile may be a temperature profile of the exhaust gas mixture. Determining a current property of the exhaust gas at a position downstream of the turbine wheel may comprise determining a temperature profile of the exhaust gas at the position downstream of the turbine wheel.

Determining a difference between the current property of the exhaust gas at the position downstream of the turbine wheel and a reference property of the exhaust gas at the position downstream of the turbine wheel may comprise determining a difference between the temperature profile at the position downstream of the turbine wheel and a reference temperature profile at the position downstream of the turbine wheel.

The current temperature profile of the exhaust gas may be determined based upon one or more of a current NOx reduction amount across one or more catalytic converters; an inlet exhaust gas temperature of an aftertreatment device; an outlet exhaust gas temperature of an aftertreatment device; a temperature of exhaust gas within an aftertreatment device; and an excess energy ratio (EER). A catalytic converter may be an example of an aftertreatment device. The EER is the ratio of the total energy available in the exhaust gas divided to the energy required to completely decompose the aftertreatment fluid entrained by the exhaust gas. The EER may be expressed as the thermal energy of the exhaust gas divided by the sum of: the heating energy, and vaporisation energy, of water, and the heating energy, and vaporisation energy, of urea.

If a rate of decomposition of aftertreatment fluid droplets in the flow of exhaust gas and/or if a start-up time of the aftertreatment device falls outside of an acceptable range, the at least one of the variable geometry mechanism and the bypass control valve may be adjusted to increase a temperature of the exhaust gas at the core of the exhaust gas flow.

If a risk of deposit build-up falls outside of an acceptable range, the at least one of the variable geometry mechanism and the bypass control valve may be adjusted to increase a temperature of the exhaust gas at a periphery of the exhaust gas flow.

The current property of the exhaust gas may comprise a current velocity profile of the exhaust gas, and the reference property of the exhaust gas may comprise a reference velocity profile of the exhaust gas. The velocity profile of the exhaust gas may encompass the velocity of a singular spatial position within the mixture and/or a distribution of velocities across multiple spatial positions within the mixture and/or an average velocity across multiple spatial positions within the mixture. The velocity profile may be a velocity profile of the exhaust gas mixture.

Determining a current property of the exhaust gas at a position downstream of the turbine wheel may comprise determining a velocity profile of the exhaust gas at the position downstream of the turbine wheel. Determining a difference between the current property of the exhaust gas at the position downstream of the turbine wheel and a reference property of the exhaust gas at the position downstream of the turbine wheel may comprise determining a difference between the velocity profile at the position downstream of the turbine wheel and a reference velocity profile at the position downstream of the turbine wheel.

Determining the current property of the exhaust gas may be based upon one or more of a pressure ratio across the turbine; a turbine inlet pressure; a turbine outlet pressure; turbine inlet temperature, a turbine outlet temperature, turbine rotational speed, and an engine mass flow rate.

If a risk of deposit build-up falls outside of an acceptable range, the at least one of the variable geometry mechanism and the bypass control valve may be adjusted to vary the velocity profile at the position downstream of the turbine wheel. Specifically, if a risk of deposit build-up falls outside of an acceptable range, the at least one of the variable geometry mechanism and the bypass control valve may be adjusted to or towards a configuration corresponding to a velocity profile which reduces an risk of deposit build-up. This may be a velocity profile with increased velocity in one or more regions of interest and an associated increase in swirl and/or shear stress and/or convective heat transfer. The risk of deposit build-up falling outside of an acceptable range may indicate the presence of one or more zones within the exhaust passage where there is an elevated risk of aftertreatment fluid impingement that may give rise to deposit solidification. The risk of deposit build-up falling outside of an acceptable range may be quantified by a backpressure across the exhaust system or turbine, more specifically, increasing beyond an acceptable level. One example of quantifying the risk, based upon backpressure across the exhaust system or turbine, comprises determining a percentage increase over the nominal backpressure at a given Engine Operating Point. By monitoring the backpressure with reference to a given flowrate, possibly by way of using a lookup table or similar, it can be determined whether the backpressure is higher than expected (indicative of deposit build-up). If the backpressure is, for example, 10% or more higher than an expected (nominal) backpressure, for a given flowrate, the risk of deposit build-up may be considered to be outside of an acceptable range. Alternatively, a particular pressure rise, such as a rise of 3 kPa above a nominal, or expected, pressure, could indicate that a risk of deposit build-up falls outside of an acceptable range. A level of denoxification may also indicate that a risk of deposit build-up falls outside of an acceptable range. A lack of NOx conversion (i.e. a comparatively low level of denoxification) may indicate an undesirable uniformity index (UI) of aftertreatment fluid in the exhaust gas (which may, in turn, indicate an elevated risk of deposit build-up). For example, a denoxification level of less than around 87% may indicate an elevated risk of deposit build-up.

Varying the velocity profile at the position (e.g. region) downstream of the turbine wheel may comprise one or more of: varying a velocity of the exhaust gas; varying a swirl angle of the exhaust gas; and varying a shear stress exerted by the exhaust gas.

The position downstream of the turbine wheel may be a location of the dosing module. The position downstream of the turbine wheel may be downstream of the dosing module. The position may be a bend (e.g. an at least partly arcuate portion of the turbine outlet passage), specifically an inside thereof. The position may be an impingement region (e.g. generally opposite a dosing module). The position may be a joint between components, such as a bellows or flexible pipe (e.g. having a corrugated or pleated surface). The position may be any region having a step change transition (e.g. not a smooth transition) where eddy currents are prone to form. The position may be an expanding joint. The position may be one or more of the aforementioned positions (e.g. multiple different positions may be targeted). Alternatively, a single position may be targeted.

The method may further comprise: identifying, based upon the difference, the existence of an operating condition of the exhaust system in which an insufficient swirl angle of the exhaust gas in the turbine outlet passage is generated; and adjusting the at least one of the variable geometry mechanism and the bypass control valve in response to the identification of the operating condition to increase the swirl angle of the exhaust gas in the turbine outlet passage. The step of identifying the existence of an operating condition of the exhaust system in which an insufficient swirl angle of the exhaust gas is generated about the centreline of the turbine outlet passage may comprise determining whether the quantity of the difference between the current property and the reference property falls outside of an acceptable range or threshold.

Adjusting the variable geometry mechanism to increase the swirl angle of the exhaust gas in the turbine outlet passage may comprise moving the variable geometry mechanism to or towards a configuration corresponding to a maximum swirl angle of the exhaust gas in the turbine outlet passage.

Adjusting the bypass control valve to increase the swirl angle of the exhaust gas in the turbine outlet passage may comprise moving the bypass control valve to or towards a configuration corresponding to a maximum swirl angle of the exhaust gas in the turbine outlet passage.

The current property of the exhaust gas may comprise a current NOx reduction amount across one or more catalytic converters, and the reference property of the exhaust gas may comprise a reference NOx reduction amount across the one or more catalytic converters. The NOx reduction amount may be a measurement of the relative proportion of NOx that has been reduced over the one or more catalytic converters. This may be determined based upon the difference in NOx concentration measured by a NOx sensor upstream of the one or more catalytic converters (for example within the turbine outlet passage) and a NOx sensor positioned downstream of the one or more catalytic converters. The one or more catalytic converters may comprise one or more SCR catalysts.

The operating condition of the exhaust system in which insufficient swirling momentum of exhaust gas is generated about the centreline of the turbine outlet passage may be identified when the NOx reduction amount across the one or more catalytic converters drops below around 98%, around 95%, or around 90%. When the NOx reduction amount decreases, this may be indicative of the amount of swirling momentum in the turbine outlet passage being insufficient to provide enough mixing of the exhaust gas and the aftertreatment fluid to cause the aftertreatment fluid to decompose. Increasing the amount of bypass delivered to the turbine outlet passage may increase the amount of swirling momentum in the turbine outlet passage, thereby increasing mixing between the exhaust gas and the aftertreatment fluid, leading to improved decomposition and providing more reductant at the one or more catalytic converters to increase the amount of NOx reduced by the one or more catalytic converters.

The current property of the exhaust gas may comprise a turbine efficiency, and the reference property of the exhaust gas may comprise a reference turbine efficiency. When the turbine operates at maximum efficiency, the flow in the turbine outlet may be substantially laminar and axial, with little swirling momentum. This may result in poor aftertreatment fluid decomposition, and a drop in the amount of NOx reduced by the exhaust system. Increasing the amount of bypass delivered to the turbine outlet passage may increase the amount of swirling momentum in the turbine outlet passage, thereby improving mixing, decomposition, and consequently NOx reduction.

The operating condition of the exhaust system in which insufficient swirling momentum of exhaust gas is generated about the centreline of the turbine outlet passage may be identified when the turbine efficiency is at least around 70%, around 80%, around 90% or around 95% of the maximum efficiency of the turbine.

The method may further comprise: identifying, based upon the difference, the existence of an operating condition of the exhaust system in which insufficient shear stress is applied to the wall of the exhaust system by the exhaust gas at a particular location; and adjusting the at least one of the variable geometry mechanism and the bypass control valve in response to the identification of the operating condition to increase the amount of shear stress applied to the wall of the exhaust system by the exhaust gas at the particular location.

Adjusting the variable geometry mechanism to increase the amount of shear stress applied to the wall of the exhaust system by the exhaust gas at the particular location may comprise moving the variable geometry mechanism to or towards a configuration corresponding to a maximum shear stress of the exhaust gas at the particular location.

Adjusting the bypass control valve to increase the amount of shear stress applied to the wall of the exhaust system by the exhaust gas at the particular location may comprise moving the bypass control valve to or towards a configuration corresponding to a maximum shear stress of the exhaust gas at the particular location.

The current property of the exhaust gas may comprise an excess energy ratio (EER) and the reference property of the exhaust gas may comprise a reference excess energy ratio. The EER is the ratio of the total energy available in the exhaust gas to the energy required to completely decompose the aftertreatment fluid entrained by the exhaust gas. The EER may be expressed as the thermal energy of the exhaust gas divided by the sum of: the heating energy, and vaporisation energy, of water, and the heating energy, and vaporisation energy, of urea.

The operating condition of the exhaust system in which insufficient shear stress is applied to the wall of the exhaust system by the exhaust gas at the particular location may be identified when the excess energy ratio is less than around 10, around 15, or around 20.

The current property of the exhaust gas may comprise a turbine efficiency, and the reference property of the exhaust gas may comprise a reference turbine efficiency. The operating condition of the exhaust system in which insufficient shear stress is applied to the wall of the exhaust system by the exhaust gas at the particular location may be identified when the turbine efficiency is at least around 70%, around 80%, around 90% or around 95% of the maximum efficiency of the turbine.

The current property of the exhaust gas may comprise a turbine inlet pressure, and the reference property of the exhaust gas may comprise a reference turbine inlet pressure.

The turbine may comprise: a turbine outlet passage configured to receive exhaust gas form the turbine wheel, the exhaust gas received from the turbine wheel defining a turbine bulk flow; and a bypass passage configured to receive exhaust gas from a position upstream of the turbine wheel and to deliver the exhaust gas to the turbine outlet passage, the exhaust gas received by the bypass passage defining a bypass flow, the bypass control valve being configured to regulate the flow rate of bypass flow through the bypass passage; wherein the turbine wheel imparts a swirling momentum onto the turbine bulk flow, the swirling momentum of the turbine bulk flow defining a positive angular direction, and wherein the bypass passage is configured to deliver the bypass flow to the turbine outlet passage in a direction that induces swirling of the bypass flow about a centreline of the turbine outlet passage in the positive angular direction; and the method may further comprise: identifying, based upon the determination of the difference, the existence of an operating condition of the exhaust system in which insufficient swirling momentum of exhaust gas is generated about the centreline of the turbine outlet passage; and adjusting the bypass control valve to increase the delivery of bypass flow to the turbine outlet passage. The identification of the operating condition of the exhaust system in which insufficient swirling momentum of exhaust gas is generated about the centreline of the turbine outlet passage may be made based upon the same parameters previously discussed above.

The turbine may comprise: a turbine outlet passage configured to receive exhaust gas form the turbine wheel, the exhaust gas received from the turbine wheel defining a turbine bulk flow; and a bypass passage configured to receive exhaust gas from a position upstream of the turbine wheel and to deliver the exhaust gas to the turbine outlet passage, the exhaust gas received by the bypass passage defining a bypass flow, the bypass control valve being configured to regulate the flow rate of bypass flow through the bypass passage; wherein the turbine wheel imparts a swirling momentum onto the turbine bulk flow, the swirling momentum of the turbine bulk flow defining a positive angular direction, and wherein the bypass passage is configured to deliver the bypass flow to the turbine outlet passage in a direction that induces swirling of the bypass flow about a centreline of the turbine outlet passage in the positive angular direction; wherein the method may comprise: identifying, based upon the determination of the difference, the existence of an operating condition of the exhaust system in which insufficient shear stress is applied to the wall of the exhaust system by the exhaust gas at a particular location; and adjusting the bypass control valve in response to the identification of the operating condition to increase the delivery of bypass flow to the turbine outlet passage. The identification of operating condition of the exhaust system in which insufficient shear stress is applied to the wall of the exhaust system by the exhaust gas at the particular location may be made based upon the same parameters previously discussed above. The particular location may be a wall of the turbine outlet passage.

According to a second aspect of the disclosure, there is provided a method of operating an exhaust system for receiving and treating exhaust gas from an internal combustion engine, the exhaust system comprising: a turbine configured to receive exhaust gas from the internal combustion engine, the turbine comprising a turbine wheel configured to extract energy from the exhaust gas; a dosing module configured to deliver an aftertreatment fluid to the exhaust gas at a position downstream of the turbine wheel, wherein the dosing module is located within around 10 exducer diameters, along a flow axis, downstream of a downstream end of the turbine wheel; at least one of: a variable geometry mechanism configured to control the flow of exhaust gas delivered to the turbine wheel; and a bypass control valve configured to bypass a portion of the exhaust gas from a position upstream of the turbine wheel to a position downstream of the turbine wheel; an aftertreatment device located downstream of the turbine and configured to receive, and treat, exhaust gas from the turbine; and a controller configured to execute the method, the method comprising: determining a current property of the aftertreatment device; determining a difference between the current property of the aftertreatment device and a reference property of the aftertreatment device; and in response to the difference, adjusting the at least one of the variable geometry mechanism and the bypass control valve to regenerate the aftertreatment device.

Adjusting the variable geometry mechanism may encompass changing the position of one or more flow influencing elements of the variable geometry mechanism, for example, the angular position and/or angle of one or more nozzle vanes relative to an axis of the turbine (e.g., in a so-called “swing vane” variable geometry mechanism), and/or adjusting the axial position of a nozzle ring and/or shroud plate to vary the width of an annular inlet passage configured to guide exhaust gas into an inducer portion of the turbine wheel (e.g., in a so-called “sliding wall” variable geometry mechanism).

Adjusting the bypass control valve may encompass changing the position of the bypass control valve to vary the amount of fluid that is permitted to pass from one side of the bypass control valve to the other. The exhaust system may comprise a bypass passage within which the bypass control valve is positioned. The bypass control valve and the bypass control passage may be configured to permit exhaust gas to pass from a position fluidly upstream of the turbine to a position fluidly downstream of the turbine without passing through the turbine wheel. The bypass passage and/or bypass control valve may be integrated into a turbine housing of the turbine (in a so-called “wastegate” arrangement) or may be non-integrated with the turbine housing.

Determining a current property of the aftertreatment device may encompass measuring, either directly or indirectly, a quantity of one or more physical properties of the aftertreatment device. A direct measurement may encompass the use of a sensor associated with (e.g., in communication with, inside) the aftertreatment device, the sensor being configured to output a signal indicative of a quantity of a physical property of the aftertreatment device, for example, temperature (e.g., temperature of a wall, or temperature of a component or surface to which a catalyst is mounted). An indirect measurement may encompass a procedure in which the quantity of the physical property is inferred from information received relating to one or more other physical properties that have a physical relationship with the quantity of the property being inferred. The current property of the aftertreatment device may be based upon one or more properties of exhaust gas (e.g., a temperature of exhaust gas, pressure drop across the aftertreatment device, reduction of NOx across the aftertreatment device, etc.). For example, a formula or a look-up table stored within the controller may be used to infer a current property from one or more direct measurements of other properties. Described another way, the current property may be obtained indirectly. The catalyst may be mounted to a monolith, e.g., a ceramic monolith.

The dosing module may deliver the aftertreatment fluid into the exhaust gas at a position downstream of the turbine wheel in such a manner that it creates an exhaust gas mixture. The exhaust gas mixture may encompass a mixture of the exhaust gas and the aftertreatment fluid, and, in particular, a mixture of the exhaust gas and aftertreatment fluid that has not decomposed into reductants, for example, a mixture of exhaust gas and urea and/or water vapour. The current property of the aftertreatment system may be inferred from a current property of the exhaust gas and/or exhaust gas mixture (for example, from the temperature of the exhaust gas mixture entering or leaving the aftertreatment device), and the reference property may be a reference property of the exhaust gas and/or exhaust gas mixture.

Determining the current property may comprise measuring a quantity of the property. For example, determining the current property may comprise directly measuring the quantity of the property using, for example, a sensor.

Determining the current property may comprise: measuring a quantity of one or more properties of an internal combustion engine system in which the exhaust system is incorporated; processing the measured quantity or quantities in a computational operation; and inferring the current property of the exhaust gas from the computational operation. The one or more properties of the exhaust gas may be different physical properties to the property being determined or may be a mixture of the same and different physical properties to the property being determined. The computational operation may encompass receiving the measured quantity or quantities as inputs in the operation of a mathematical formula stored in a memory of the controller, and/or as inputs in the operation of a dataset, such as one or more so-called ‘look-up’ tables, stored in the memory of the controller. The one or more properties measured as part of the step of determining the current property may be properties of the exhaust gas, however, in other embodiments the one or more properties measured as part of the step of determining the current property may be any relevant property of the internal combustion engine system.

Determining a current property of the aftertreatment device may comprise determining a temperature of the aftertreatment device. Determining the current property of the aftertreatment device may be based upon one or more of: a time period since a previous regeneration event; a time period since engine ignition; a current NOx reduction amount over one or more catalytic converters; turbine inlet pressure; turbine outlet temperature and/or temperature profile; and pressure drop across the turbine. Determining a difference between the current property of the aftertreatment device and a reference property of the aftertreatment device may comprise determining a difference between the temperature of the aftertreatment device and a reference temperature of the aftertreatment device. The temperature may be a single temperature. The temperature may be a temperature profile, comprising a plurality of temperatures across a range of spatial positions. For example, temperature readings may be recorded by a plurality of thermocouples provided at different positions around, or within, the aftertreatment device.

The method may further comprise: determining if the temperature of the aftertreatment device falls outside of an acceptable range, and adjusting the at least one of the variable geometry mechanism and the bypass control valve to increase the temperature of the aftertreatment device. If the temperature of the aftertreatment device falls outside of an acceptable range, the at least one of the variable geometry mechanism and the bypass control valve may be adjusted to or towards a configuration corresponding to a maximum temperature of the aftertreatment device. Where the bypass control valve is adjusted, the bypass control valve is preferably opened, more preferably to a 100% open configuration, to expose the aftertreatment device to high temperature (bypass) exhaust gases to increase the temperature of the aftertreatment device. Where the variable geometry mechanism is adjusted, the variable geometry mechanism may be adjusted to decrease the relative inlet area to the turbine wheel (i.e., to throttle the inlet to the turbine wheel), to thereby increase engine backpressure, and pumping work, thus increasing the temperature of exhaust gas and thus exposing the aftertreatment device to high temperature exhaust gases to increase the temperature of the aftertreatment device.

According to a third aspect of the disclosure, there is provided an exhaust system for receiving exhaust gas from an internal combustion engine, the exhaust system comprising: a turbine configured to receive exhaust gas from the internal combustion engine, the turbine comprising a turbine wheel configured to extract energy from the exhaust gas; a dosing module configured to deliver an aftertreatment fluid to the exhaust gas at a position downstream of the turbine wheel; at least one of: a variable geometry mechanism configured to control the flow of exhaust gas delivered to the turbine wheel; and a bypass control valve configured to bypass a portion of the exhaust gas from a position upstream of the turbine wheel to a position downstream of the turbine wheel; and a controller configured to: determine a current property of the exhaust gas at a position downstream of the turbine wheel; determine a difference between the current property of the exhaust gas at the position downstream of the turbine wheel and a reference property of the exhaust gas at the position downstream of the turbine wheel; and in response to the difference, adjust the at least one of the variable geometry mechanism and the bypass control valve.

The controller may be configured to: measure a quantity of one or more properties of the internal combustion engine system in which the exhaust system is incorporated; process the measured quantity or quantities in a computational operation; and infer the current property of the exhaust gas from the computational operation.

The controller may be configured to measure one or more of a turbine inlet pressure; a turbine inlet temperature; a turbine outlet pressure; a turbine outlet temperature; an engine speed; a throttle position; an engine air mass flow rate; an engine inlet pressure; an engine inlet temperature; a NOx concentration; a catalyst gas temperature; an engine fuel flow rate, an engine air flow rate, an engine boost pressure, an engine load, an engine cylinder temperature, an engine cylinder pressure, an engine fuel pressure, or a turbine rotational speed.

The current property of the exhaust gas may comprise a current temperature profile of the exhaust gas, and the reference property of the exhaust gas may comprise a reference temperature profile of the exhaust gas.

The current temperature profile of the exhaust gas may be determined based upon one or more of a current NOx reduction amount across one or more catalytic converters; an inlet exhaust gas temperature of an aftertreatment device; an outlet exhaust gas temperature of an aftertreatment device; a temperature of exhaust gas within an aftertreatment device; and an excess energy ratio (EER).

If a rate of decomposition of aftertreatment fluid droplets in the flow of exhaust gas and/or if a start-up time of the aftertreatment device falls outside of an acceptable range, the at least one of the variable geometry mechanism and the bypass control valve may be adjusted to increase a temperature of the exhaust gas at the core of the exhaust gas flow.

If a risk of deposit build-up falls outside of an acceptable range, the at least one of the variable geometry mechanism and the bypass control valve may be adjusted to increase a temperature of the exhaust gas at a periphery of the exhaust gas flow.

The current property of the exhaust gas may comprise a current velocity profile of the exhaust gas and the reference property of the exhaust gas may comprise a reference velocity profile of the exhaust gas.

The controller may be configured to determine the current property of the exhaust gas based upon one or more of a pressure ratio across the turbine; a turbine inlet pressure; a turbine outlet pressure; turbine inlet temperature, turbine rotational speed; and an engine mass flow rate.

If a risk of deposit build-up falls outside of an acceptable range, the at least one of the variable geometry mechanism and the bypass control valve may be adjusted to vary the velocity profile at the position downstream of the turbine wheel.

The position downstream of the turbine wheel may be a location of the dosing module. The position downstream of the turbine wheel may be downstream of the dosing module.

The controller may be configured to: identify, based upon the difference, the existence of an operating condition of the exhaust system in which an insufficient swirl angle of the exhaust gas in the turbine outlet passage is generated; and adjust the at least one of the variable geometry mechanism and the bypass control valve in response to the identification of the operating condition to increase the swirl angle of the exhaust gas in the turbine outlet passage.

The controller may be configured to adjust the variable geometry mechanism to increase the swirl angle of the exhaust gas in the turbine outlet passage by moving the variable geometry mechanism to or towards a configuration corresponding to a maximum swirl angle of the exhaust gas in the turbine outlet passage.

The controller may be configured to adjust the bypass control valve to increase the swirl angle of the exhaust gas in the turbine outlet passage by moving the bypass control valve to or towards a configuration corresponding to a maximum swirl angle of the exhaust gas in the turbine outlet passage.

The current property of the exhaust gas may comprise a current NOx reduction amount across one or more catalytic converters, and the reference property of the exhaust gas may comprise a reference NOx reduction amount across the one or more catalytic converters.

The controller may be configured to identify the operating condition of the exhaust system in which insufficient swirling momentum of exhaust gas is generated about the centreline of the turbine outlet passage when the NOx reduction amount across the one or more catalytic converters drops below around 98%, around 95%, or around 90%.

The current property of the exhaust gas may comprise a turbine efficiency, and the reference property of the exhaust gas may comprise a reference turbine efficiency.

The controller may be configured to identify the operating condition of the exhaust system in which insufficient swirling momentum of exhaust gas is generated about the centreline of the turbine outlet passage when the turbine efficiency is at least around 70%, around 80%, around 90% or around 95% of the maximum efficiency of the turbine.

The controller may be further configured to: identify, based upon the difference, the existence of an operating condition of the exhaust system in which insufficient shear stress is applied to the wall of the exhaust system by the exhaust gas at a particular location; and adjust the at least one of the variable geometry mechanism and the bypass control valve in response to the identification of the operating condition to increase the amount of shear stress applied to the wall of the exhaust system by the exhaust gas at the particular location.

The controller may be configured to adjust the variable geometry mechanism to increase the amount of shear stress applied to the wall of the exhaust system by the exhaust gas at the particular location by moving the variable geometry mechanism to or towards a configuration in corresponding to a maximum shear stress of the exhaust gas at the particular location.

The controller may be configured to adjust the bypass control valve to increase the amount of shear stress applied to the wall of the exhaust system by the exhaust gas at the particular location by moving the bypass control valve to or towards a configuration corresponding to a maximum shear stress of the exhaust gas at the particular location.

The current property of the exhaust gas may comprise an excess energy ratio (EER) and the reference property of the exhaust gas may comprise a reference excess energy ratio.

The controller may be configured to identify the operating condition of the exhaust system in which insufficient shear stress is applied to the wall of the exhaust system by the exhaust gas at the particular location when the excess energy ratio is less than around 10, around 15, or around 20.

The current property of the exhaust gas may comprise a turbine efficiency, and the reference property of the exhaust gas may comprise a reference turbine efficiency.

The controller may be configured to identify the operating condition of the exhaust system in which insufficient shear stress is applied to the wall of the exhaust system by the exhaust gas at the particular location when the turbine efficiency is at least around 70%, around 80%, around 90% or around 95% of the maximum efficiency of the turbine.

The current property of the exhaust gas may comprise a turbine inlet pressure, and the reference property of the exhaust gas comprises a reference turbine inlet pressure.

The turbine may comprise: a turbine outlet passage configured to receive exhaust gas form the turbine wheel, the exhaust gas received from the turbine wheel defining a turbine bulk flow; and a bypass passage configured to receive exhaust gas from a position upstream of the turbine wheel and to deliver the exhaust gas to the turbine outlet passage, the exhaust gas received by the bypass passage defining a bypass flow, the bypass control valve being configured to regulate the flow rate of bypass flow through the bypass passage; wherein the turbine wheel imparts a swirling momentum onto the turbine bulk flow, the swirling momentum of the turbine bulk flow defining a positive angular direction, and wherein the bypass passage is configured to deliver the bypass flow to the turbine outlet passage in a direction that induces swirling of the bypass flow about a centreline of the turbine outlet passage in the positive angular direction.

The controller may be further configured to: identify, based upon the difference, the existence of an operating condition of the exhaust system in which insufficient swirling momentum of exhaust gas is generated about the centreline of the turbine outlet passage; and adjust the bypass control valve to increase the delivery of bypass flow to the turbine outlet passage.

The controller may be further configured to: identify, based upon the determination of the difference, the existence of an operating condition of the exhaust system in which insufficient shear stress is applied to the wall of the exhaust system by the exhaust gas at a particular location; and adjust the bypass control valve in response to the identification of the operating condition to increase the delivery of bypass flow to the turbine outlet passage. The particular location may be a wall of the turbine outlet passage.

According to a fourth aspect of the disclosure, there is provided an exhaust system of operating an exhaust system for receiving and treating exhaust gas from an internal combustion engine, the exhaust system comprising: a turbine configured to receive exhaust gas from the internal combustion engine, the turbine comprising a turbine wheel configured to extract energy from the exhaust gas; a dosing module configured to deliver an aftertreatment fluid to the exhaust gas at a position downstream of the turbine wheel, wherein the dosing module is located within around 10 exducer diameters, along a flow axis, downstream of a downstream end of the turbine wheel; at least one of: a variable geometry mechanism configured to control the flow of exhaust gas delivered to the turbine wheel; and a bypass control valve configured to bypass a portion of the exhaust gas from a position upstream of the turbine wheel to a position downstream of the turbine wheel; an aftertreatment device located downstream of the turbine and configured to receive, and treat, exhaust gas from the turbine; and a controller configured to: determine a current property of the aftertreatment device; determine a difference between the current property of the aftertreatment device and a reference property of the aftertreatment device; and in response to the difference, adjust the at least one of the variable geometry mechanism and the bypass control valve to regenerate the aftertreatment device.

The controller may be configured to determine a current property of the aftertreatment device by determining a temperature of the aftertreatment device.

The controller may be configured to determine the current property of the aftertreatment device based upon one or more of: a time period since a previous regeneration event; a time period since engine start-up (i.e., a ‘key-on’ event such as when the engine is first initiated after a period of inactivity); a current NOx reduction amount over one or more catalytic converters; a turbine inlet pressure; and pressure drop across the turbine.

The controller may be further configured to: determine if the temperature of the aftertreatment device falls outside of an acceptable range and adjust the at least one of the variable geometry mechanism and the bypass control valve to increase a temperature of the aftertreatment device.

The dosing module may be located within around 10 exducer diameters, along the flow axis, downstream of a downstream end of the turbine wheel. The dosing module may be provided at a diverging portion of the turbine outlet passage. In particular, the dosing module may be provided within a portion of the turbine outlet passage that defines a diffuser. The dosing module may be configured to deliver a spray of aftertreatment fluid into the diffuser.

The dosing module may be mounted to the turbine or to a conduit downstream of the turbine (such as a so-called ‘downpipe’). In particular, the dosing module may be mounted to a housing of the turbine, the housing of the turbine defining at least part of or all of the turbine outlet passage, including in some embodiments part of or all of any diffuser portions of the turbine outlet passage.

The turbine may comprise: a turbine housing, the turbine housing defining a turbine inlet passage and the turbine wheel chamber; and a connection adapter, the connection adapter being coupled to the turbine housing and at least partly defining the turbine outlet passage.

The dosing module may be mounted to the connection adapter.

According to a fifth aspect of the disclosure, there is provided a turbocharger system comprising: a compressor, the compressor comprising a compressor housing and a compressor wheel; a bearing housing, the bearing housing being configured to support a shaft for rotation about an axis; and the exhaust system according to the third or fourth aspects of the disclosure; wherein the compressor wheel and turbine wheel are coupled to the shaft in power communication with one another.

According to a sixth aspect of the disclosure, there is provided an engine arrangement comprising: an internal combustion engine; and the turbocharger system according to the fifth aspect of the disclosure wherein the turbocharger is configured to receive exhaust gas from the internal combustion engine.

According to a seventh aspect of the disclosure, there is provided a controller for an exhaust system for receiving exhaust gas from an internal combustion engine, the controller being configured to: determine a current property of the exhaust gas at a position downstream of a turbine wheel of a turbine of the exhaust system; determine a difference between the current property of the exhaust gas at the position downstream of the turbine wheel and a reference property of the exhaust gas at the position downstream of the turbine wheel; and in response to the difference, adjust at least one of a variable geometry mechanism of the turbine and a bypass control valve of the turbine.

The controller may, in particular, be the same controller as the described above that is incorporated within the first and third aspects of the present disclosure. Accordingly, the controller may be configured to carry out substantially identical method steps and/or be configured to make substantially identical determinations based upon identical input parameters and/or be configured to make substantially identical adjustments to the variable geometry mechanism and/or bypass control valve as described previously.

According to a seventh aspect of the disclosure, there is provided a controller for an exhaust system for receiving exhaust gas from an internal combustion engine, the exhaust system comprising: a turbine including a turbine wheel; at least one of a variable geometry mechanism and a bypass control valve; and an aftertreatment device downstream of the turbine and configured to receive, and treat, exhaust gas from the turbine; the controller being configured to: determine a current property of the aftertreatment device; determine a difference between the current property of the aftertreatment device and a reference property of the aftertreatment device; and in response to the difference, adjust at least one of the variable geometry mechanism of the turbine and a bypass control valve of the turbine.

The controller may, in particular, be the same controller as the described above that is incorporated within the second and fourth aspects of the present disclosure. Accordingly, the controller may be configured to carry out substantially identical method steps and/or be configured to make substantially identical determinations based upon identical input parameters and/or be configured to make substantially identical adjustments to the variable geometry mechanism and/or bypass control valve as descried previously.

The controllers of the seventh and eighth aspects may be controllers for an engine system, for example, an engine system in which the exhaust system is incorporated. The controllers may be, in particular, engine control units. However, in other embodiments the controllers may be sub-controllers of the engine system, for example, an aftertreatment system controller or a turbine controller. The controllers need not be a single controller but may comprise a group of controllers configured to collectively provide control over the engine system and/or exhaust system.

Optional and/or preferred features as set out herein may be used either individually or in combination with each other where appropriate and particularly in the combinations as set out in the accompanying claims. The optional and/or preferred features for each aspect of the disclosure set out herein are also applicable to any other aspects of the disclosure, where appropriate.

### BRIEF DESCRIPTION OF THE DISCLOSURE

Specific embodiments of the present disclosure will now be described, by way of example only, with reference to the accompanying drawings in which:

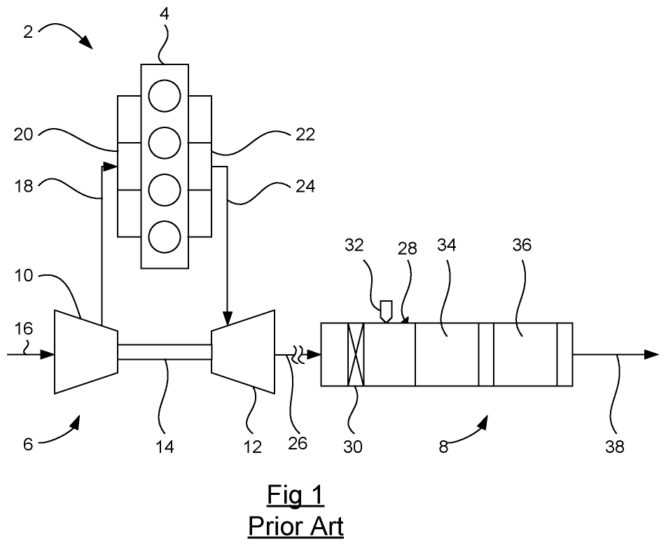

FIG. 1 is a schematic view of a known turbocharged diesel engine system;

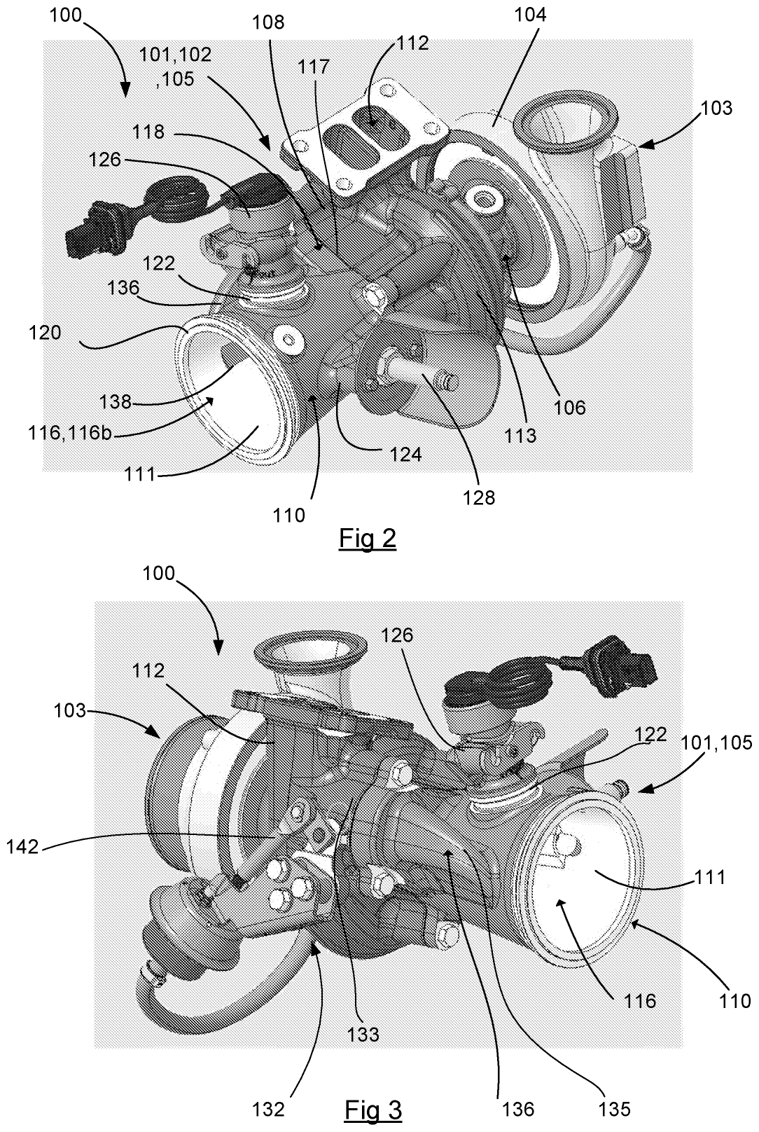

FIG. 2 is a perspective view, generally from above, of a turbocharger comprising an exhaust system according to an embodiment of the disclosure;

FIG. 3 is an alternative perspective view of the turbocharger of FIG. 2;

FIG. 4 is a side cross-sectional view of the turbocharger of FIGS. 2 and 3;

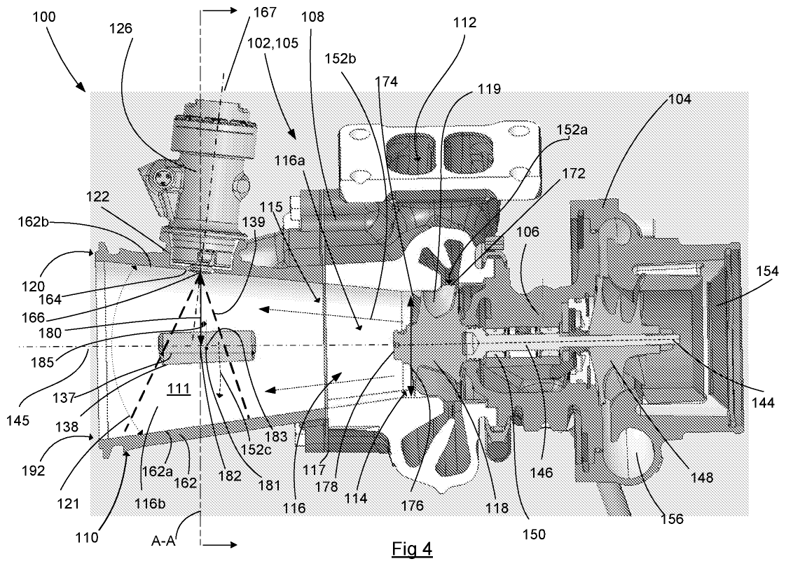

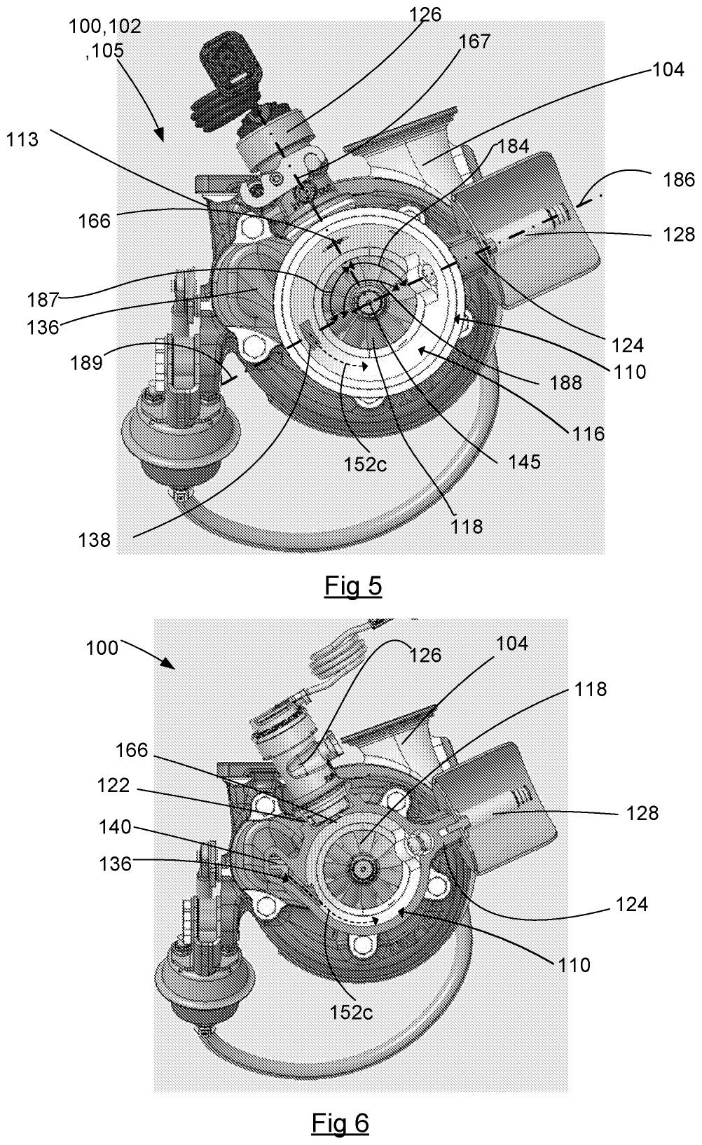

FIG. 5 is an end view of the turbocharger of FIGS. 2 to 4;

FIG. 6 is a cross-sectional end view of the turbocharger of FIGS. 2 to 5, taken through the plane A-A of FIG. 4;

FIG. 7 is a schematic block diagram of an exhaust system according to an embodiment of the disclosure;

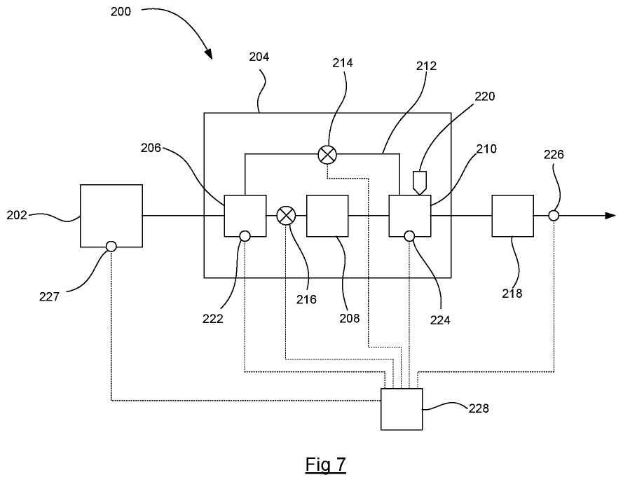

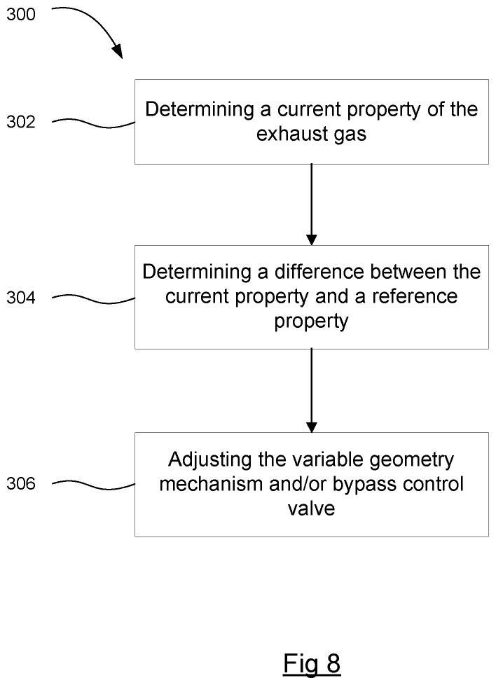

FIG. 8 shows a schematic block diagram of a method of operating the exhaust system of FIG. 7;

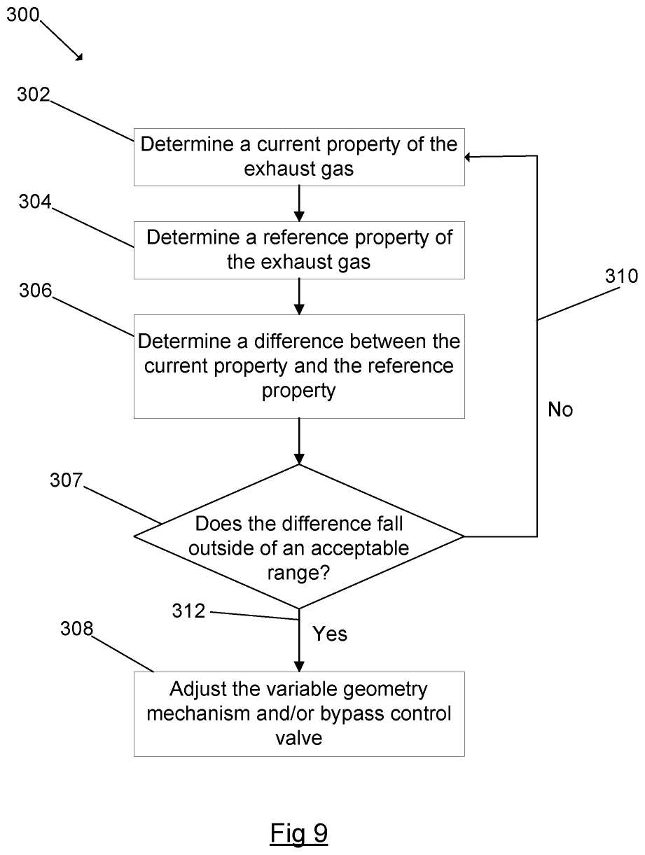

FIG. 9 shows a further embodiment of the method shown in FIG. 8;

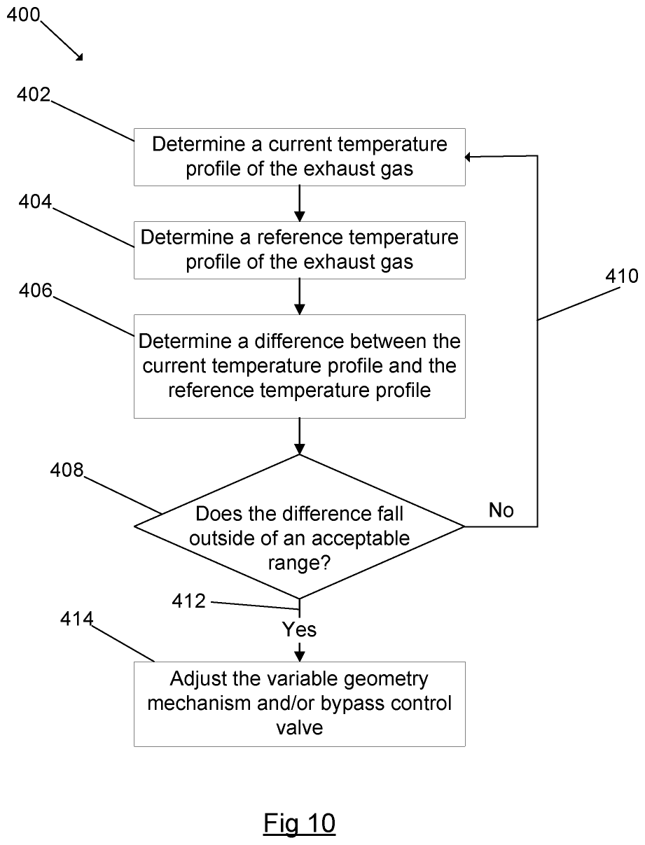

FIG. 10 shows a flowchart which schematically indicates a further embodiment of the method shown in FIGS. 8 and 9;

FIG. 11 shows a plot illustrating a temperature profile of exhaust gas for a first wastegate valve configuration at a turbine wheel nut plane;

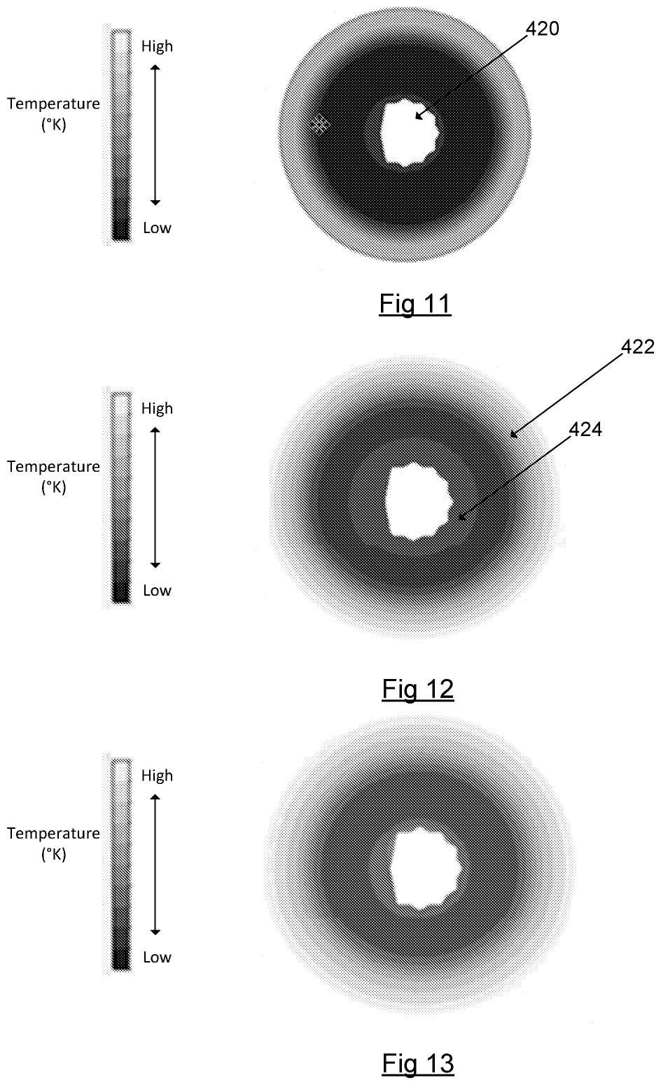

FIG. 12 shows a plot illustrating a temperature profile of exhaust gas for a second wastegate valve configuration at the turbine wheel nut plane;

FIG. 13 shows a plot illustrating a temperature profile of exhaust gas for a third wastegate valve configuration at the turbine wheel nut plane;

FIG. 14 shows a plot illustrating a temperature profile of exhaust gas for the first wastegate valve configuration at a first turbine outlet;

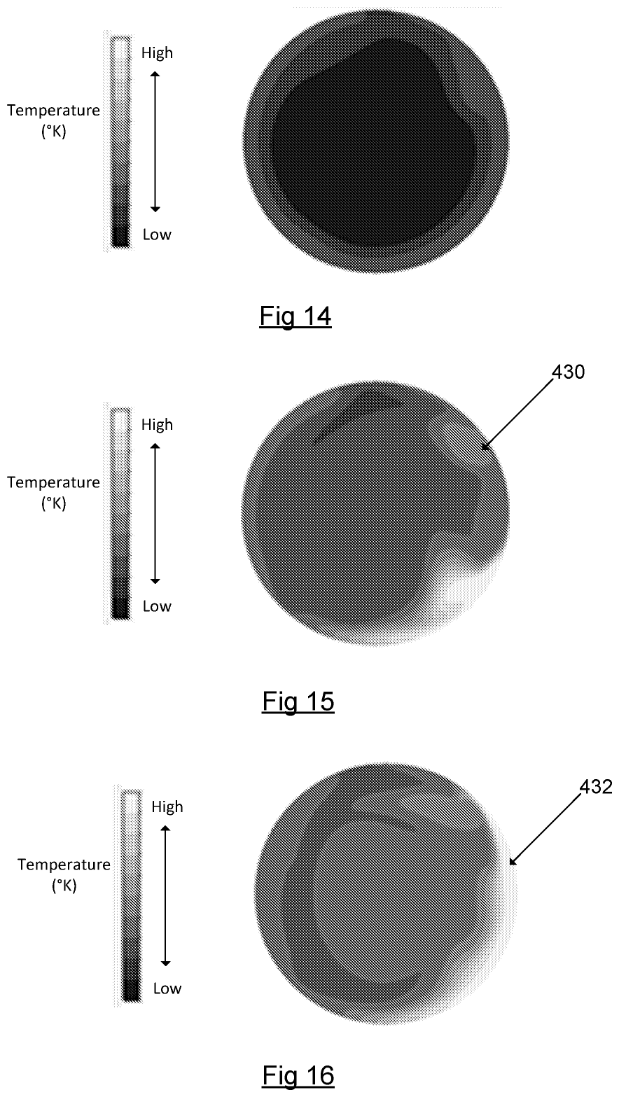

FIG. 15 shows a plot illustrating a temperature profile of exhaust gas for the second wastegate valve configuration at a second turbine outlet;

FIG. 16 shows a plot illustrating a temperature profile of exhaust gas for the third wastegate valve configuration at a third turbine outlet;

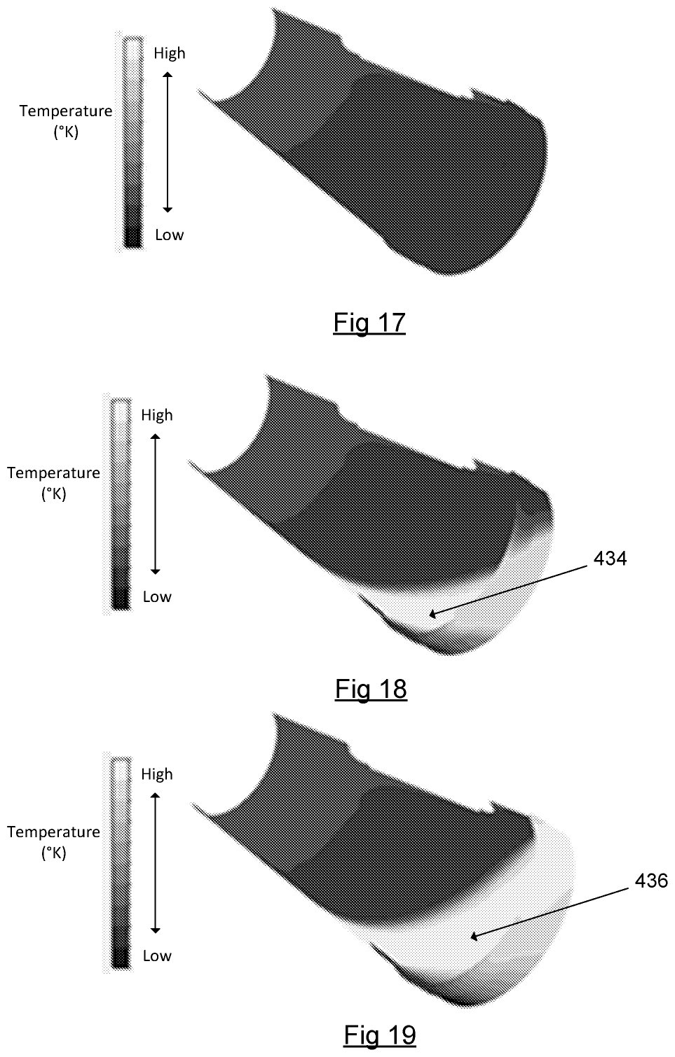

FIG. 17 shows a plot illustrating a temperature profile for the first wastegate valve configuration at a first wall of a diffuser;

FIG. 18 shows a plot illustrating a temperature profile for the second wastegate valve configuration at a second wall of a diffuser;

FIG. 19 shows a plot illustrating a temperature profile for the third wastegate valve configuration at a third wall of a diffuser;

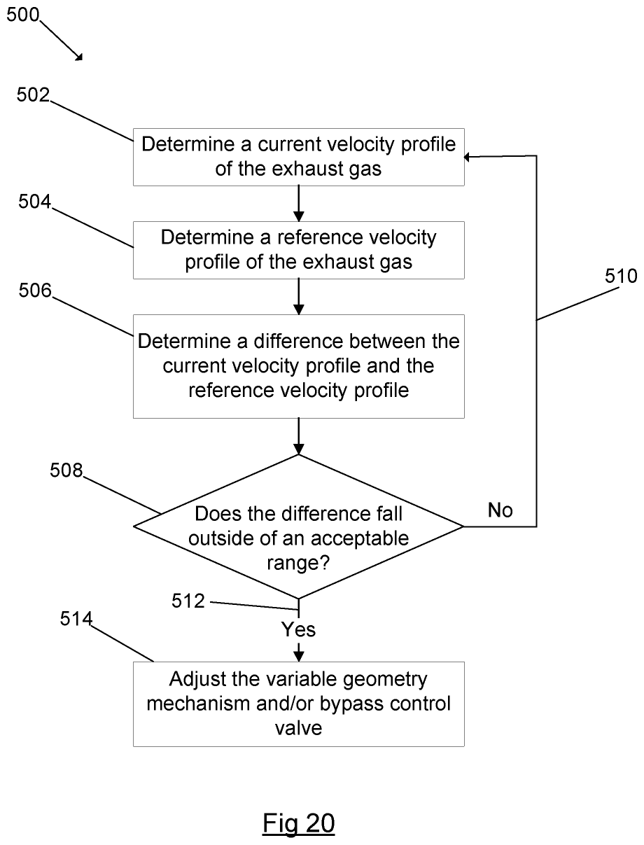

FIG. 20 shows a flowchart which schematically indicates a further embodiment of the method shown in FIGS. 8 and 9:

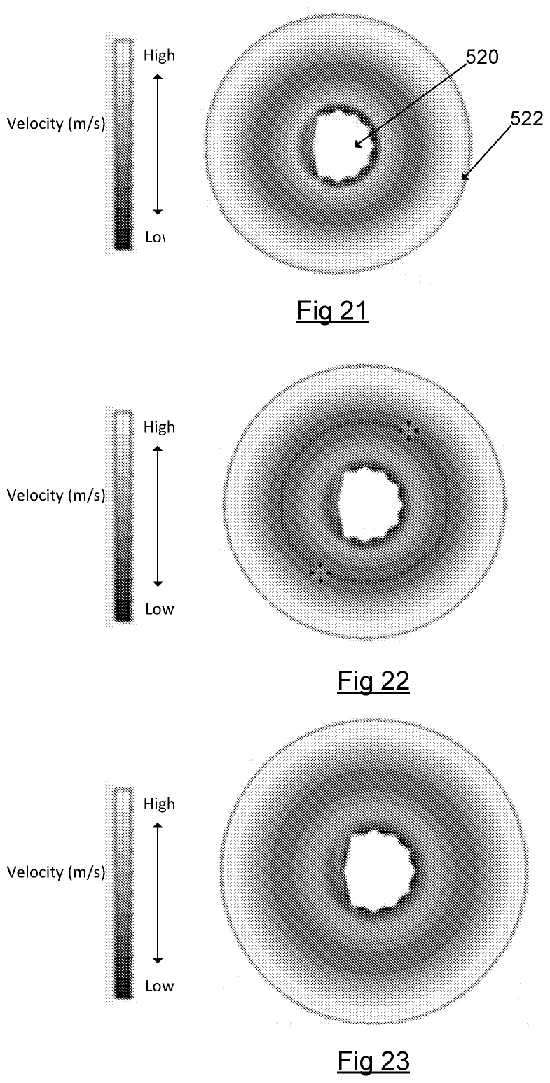

FIG. 21 shows a plot illustrating a velocity profile of exhaust gas for the first wastegate valve configuration at the turbine wheel nut plane;

FIG. 22 shows a plot illustrating a velocity profile of exhaust gas for the second wastegate valve configuration at the turbine wheel nut plane;

FIG. 23 shows a plot illustrating a velocity profile of exhaust gas for the third wastegate valve configuration at the turbine wheel nut plane;

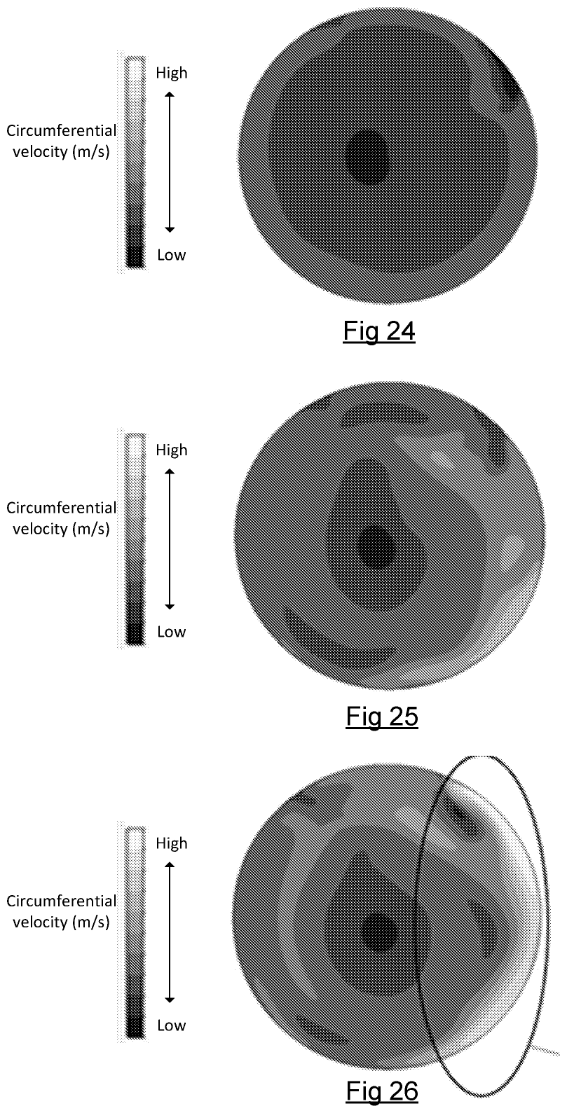

FIG. 24 shows a plot illustrating a tangential velocity profile of exhaust gas for the first wastegate valve configuration at the turbine outlet;

FIG. 25 shows a plot illustrating a tangential velocity profile of exhaust gas for the second wastegate valve configuration at the turbine outlet;

FIG. 26 shows a plot illustrating a tangential velocity profile of exhaust gas for a the third wastegate valve configuration at the turbine outlet;

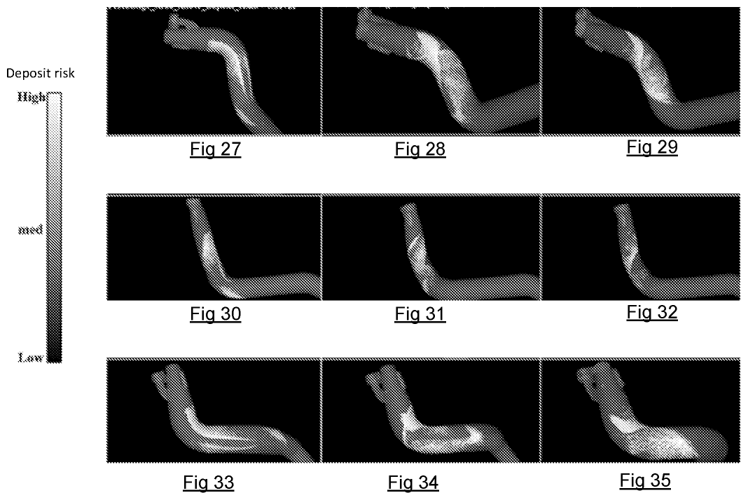

FIG. 27 shows a plot illustrating a risk of deposit build-up in a first embodiment of an exhaust system for the first wastegate valve configuration;

FIG. 28 shows a plot illustrating a risk of deposit build-up in the first embodiment of an exhaust system for the second wastegate valve configuration;

FIG. 29 shows a plot illustrating a risk of deposit build-up in the first embodiment of an exhaust system for the third wastegate valve configuration;

FIG. 30 shows a plot illustrating a risk of deposit build-up in a second embodiment of an exhaust system for the first wastegate valve configuration;

FIG. 31 shows a plot illustrating a risk of deposit build-up in the second embodiment of an exhaust system for the second wastegate valve configuration;

FIG. 32 shows a plot illustrating a risk of deposit build-up in the second embodiment of an exhaust system for the third wastegate valve configuration;

FIG. 33 shows a plot illustrating a risk of deposit build-up in a third embodiment of an exhaust system for the first wastegate valve configuration;

FIG. 34 shows a plot illustrating a risk of deposit build-up in the third embodiment of an exhaust system for the second wastegate valve configuration;

FIG. 35 shows a plot illustrating a risk of deposit build-up in the third embodiment of an exhaust system for the third wastegate valve configuration;

FIG. 36 shows a plot illustrating a magnitude of wall shear stress in the first embodiment of an exhaust system for the first wastegate valve configuration;

FIG. 37 shows a plot illustrating a magnitude of wall shear stress in the first embodiment of an exhaust system for the second wastegate valve configuration;

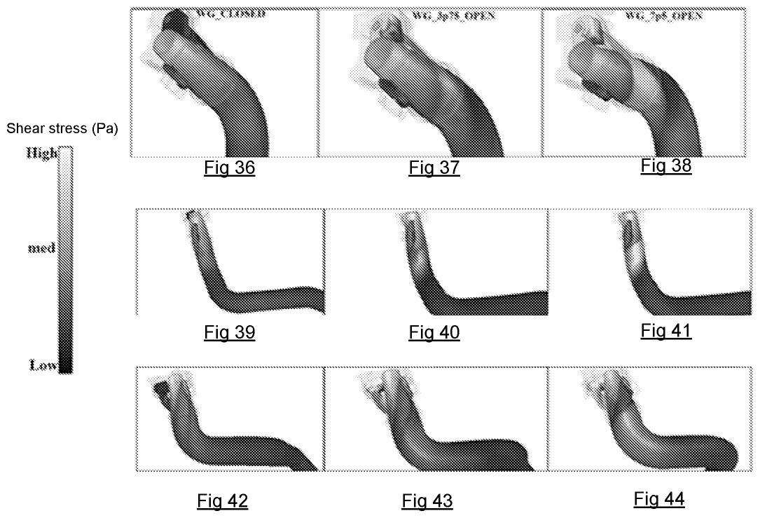

FIG. 38 shows a plot illustrating a magnitude of wall shear stress in the first embodiment of an exhaust system for the third wastegate valve configuration;

FIG. 39 shows a plot illustrating a magnitude of wall shear stress in the second embodiment of an exhaust system for the first wastegate valve configuration;

FIG. 40 shows a plot illustrating a magnitude of wall shear stress in the second embodiment of an exhaust system for the second wastegate valve configuration;

FIG. 41 shows a plot illustrating a magnitude of wall shear stress in the second embodiment of an exhaust system for the third wastegate valve configuration;

FIG. 42 shows a plot illustrating a magnitude of wall shear stress in the third embodiment of an exhaust system for the first wastegate valve configuration;

FIG. 43 shows a plot illustrating a magnitude of wall shear stress in the third embodiment of an exhaust system for the second wastegate valve configuration;

FIG. 44 shows a plot illustrating a magnitude of wall shear stress in the third embodiment of an exhaust system for the third wastegate valve configuration;

FIG. 45 shows a plot illustrating the velocity magnitude and streamline of exhaust gas in a fourth embodiment of an exhaust system at a first engine operating point;

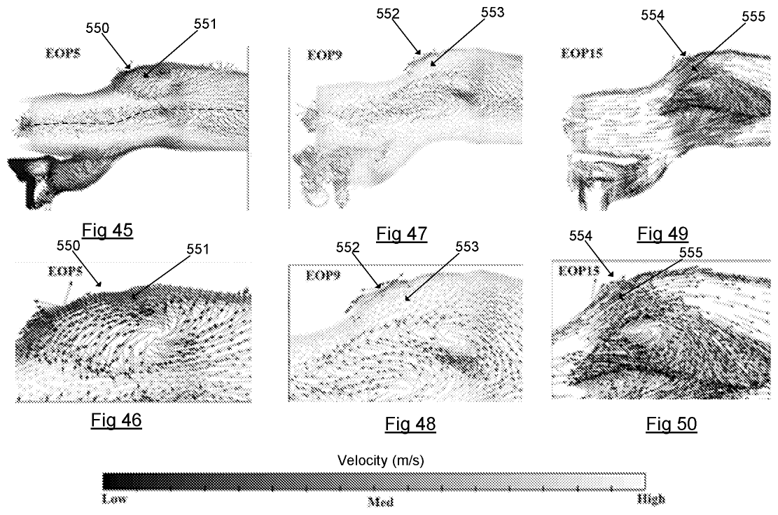

FIG. 46 shows a magnified view of a first region of interest of FIG. 45;

FIG. 47 shows a plot illustrating the velocity magnitude and streamline of exhaust gas in a fifth embodiment of an exhaust system at a second engine operating point;

FIG. 48 shows a magnified view of a second region of interest of FIG. 47;

FIG. 49 shows a plot illustrating the velocity magnitude and streamline of exhaust gas in a sixth embodiment of an exhaust system at a third engine operation point;

FIG. 50 shows a magnified view of a third region of interest of FIG. 49;

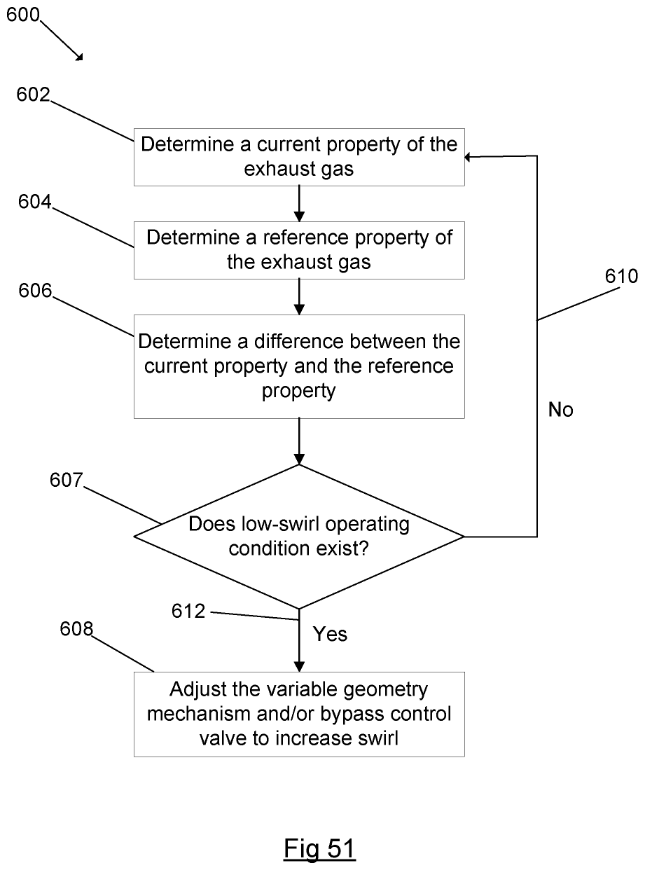

FIG. 51 shows a flowchart which schematically indicates a further embodiment of the method shown in FIGS. 8 and 9;

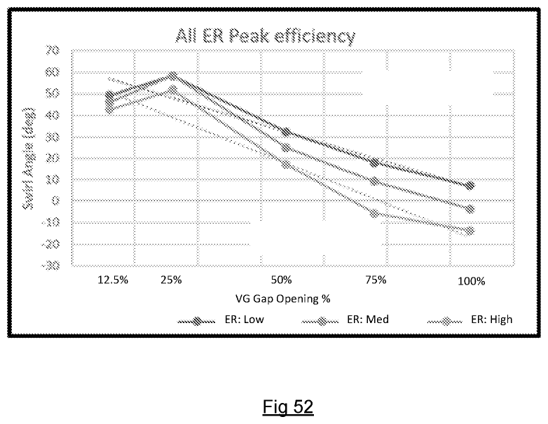

FIG. 52 is a graph showing swirl angle in a turbine outlet passage, as a function of inlet gap size of a variable geometry mechanism, at different expansion ratios across the turbine;

FIGS. 53 to 55 show plots of velocity magnitude, and streamlines, of exhaust gas for the turbine of FIGS. 2 to 6 at a wastegate valve closed configuration;

FIGS. 56 to 58 show plots of velocity magnitude, and streamlines, of exhaust gas for the turbine of FIGS. 2 to 6 at a wastegate valve partially open configuration;

59 to 61 show plots of velocity magnitude, and streamlines, of exhaust gas for the turbine of FIGS. 2 to 6 at a wastegate valve fully open configuration;

FIG. 62 shows a three-dimensional view of an exhaust system, with various planes schematically indicated;

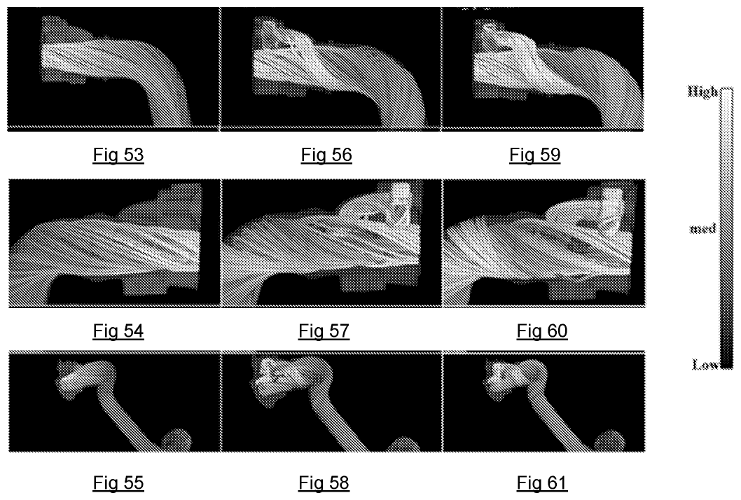

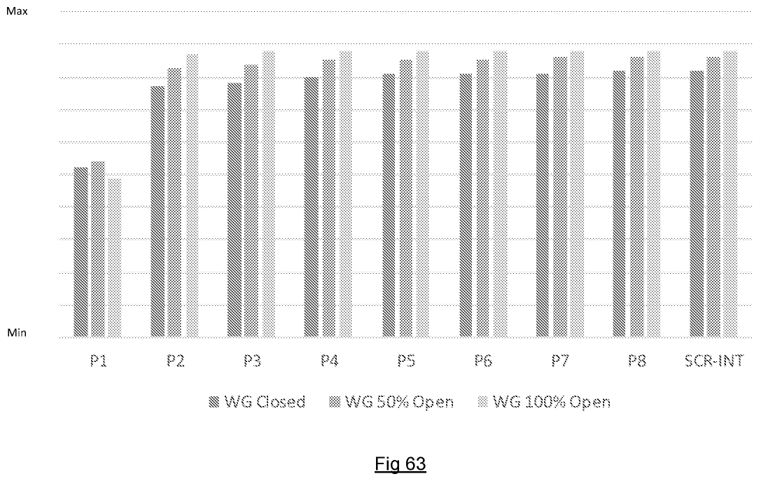

FIG. 63 is a graph showing the relative amount of aftertreatment fluid decomposition, at each of the planes indicated in FIG. 54, for three different wastegate valve configurations;

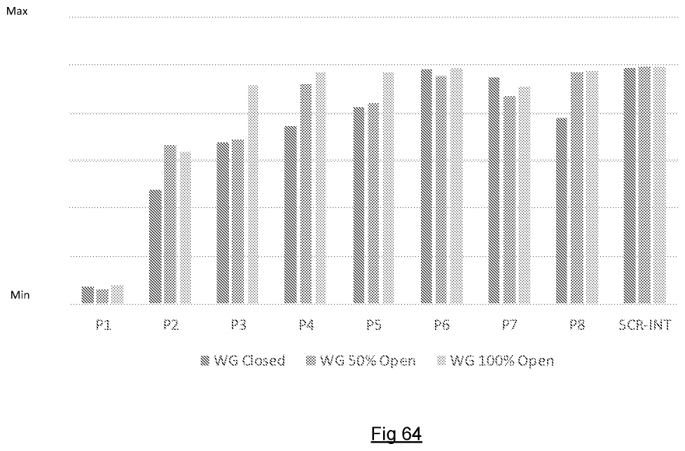

FIG. 64 is a graph showing the relative uniformity index (UI) of the exhaust gas mixture at each of the planes indicated in FIG. 54, for three different wastegate valve configurations;

FIG. 65 is a graph showing the relative amount of aftertreatment fluid decomposition at each of the planes indicated in FIG. 54 at three different swirl angles in the turbine outlet;

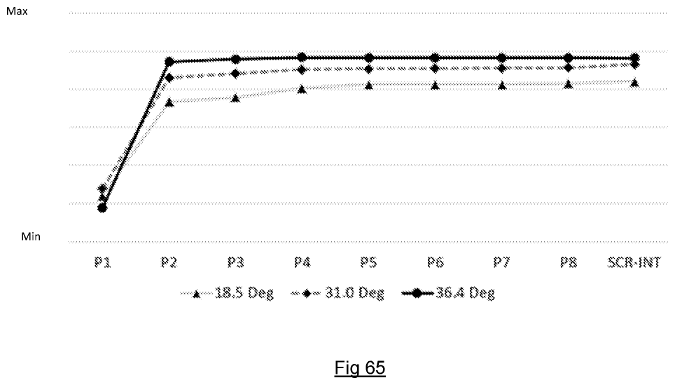

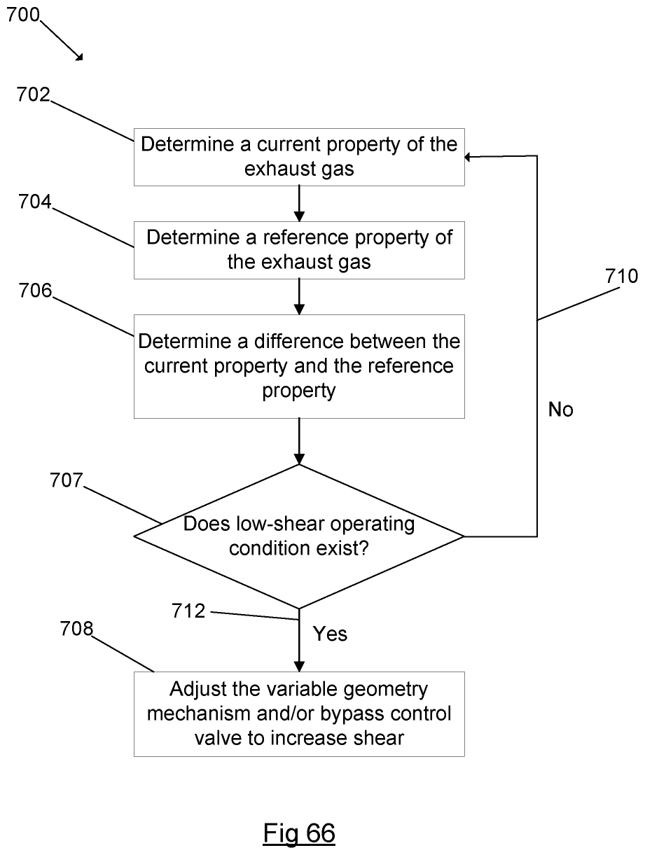

FIG. 66 shows a flowchart which schematically indicates a further embodiment of the method shown in FIGS. 8 and 9;

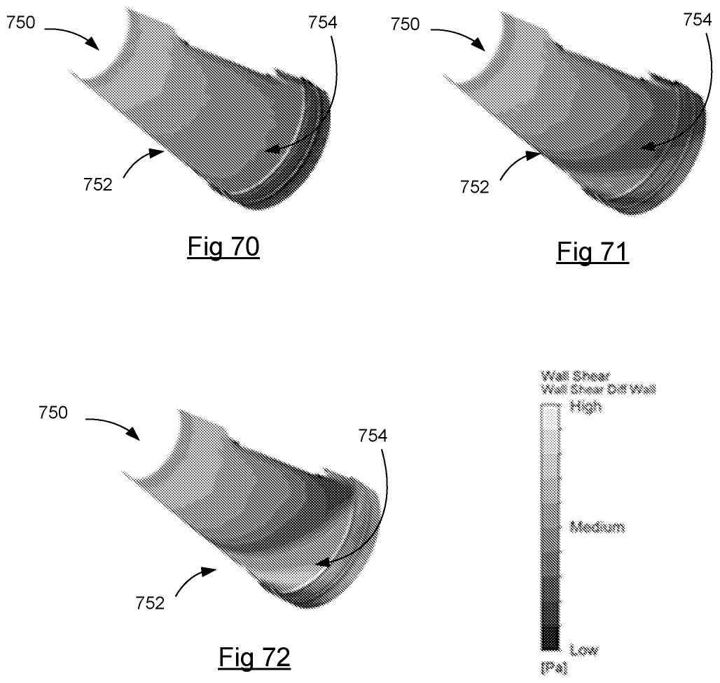

FIGS. 70 to 72 shows plots of wall shear stress within the interior of a turbine outlet for three different wastegate valve configurations;

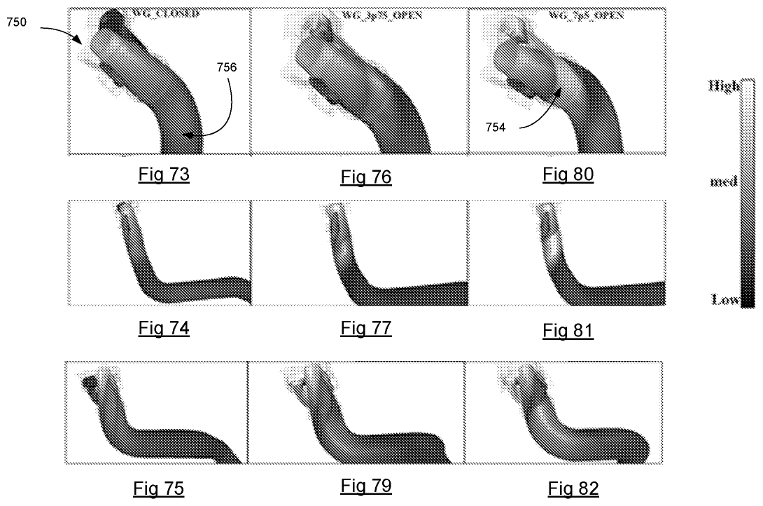

FIGS. 73 to 75 show plots of wall shear stress in an exhaust system for a wastegate valve closed configuration;

FIGS. 76 to 79 show plots of wall shear stress in an exhaust system for a wastegate valve partially open configuration;

FIGS. 80 to 82 show plots of wall shear stress in an exhaust system for a wastegate valve fully open configuration; and

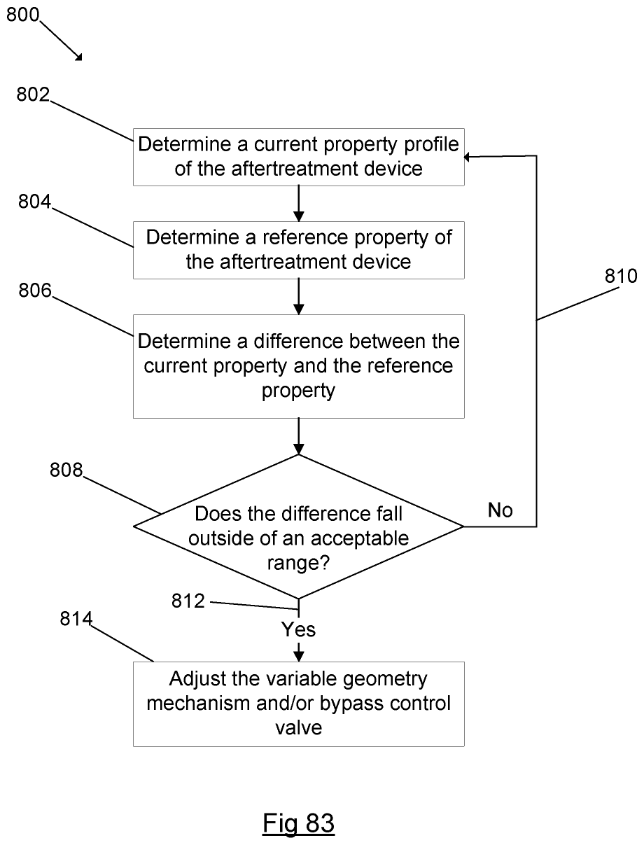

FIG. 83 shows a schematic block diagram of a method according to another embodiment.

### DETAILED DESCRIPTION OF THE DISCLOSURE

FIG. 1 is a schematic view of a known turbocharged diesel engine system 2. The system 2 comprises a diesel internal combustion engine 4, a turbocharger 6 and an exhaust gas aftertreatment system 8.

The turbocharger 6 comprises a compressor 10, and a turbine 12, each comprising a respective one of a compressor wheel and turbine wheel. The compressor wheel and turbine wheel are mounted to a common turbocharger shaft 14 such that they rotate in unison.

The compressor 10 receives intake air from a low pressure intake duct 16 connected to atmosphere. The low pressure intake duct 16 may comprise a particulate filter to dean the intake air. The compressor 10 compresses the intake air using power provided by the turbine 12 (via the turbocharger shaft 14) and supplies the compressed intake air to the engine 4 via a high pressure intake duct 18 and an intake manifold 20. Although not shown, the high pressure intake duct 18 may comprise an intercooler configured to cool the intake air before it reaches the engine 4.

Inside the engine 4, an internal combustion process takes place and useful work is produced. As a result of the internal combustion process, exhaust gases are created by the engine 4. The engine 4 is fluidly connected to an exhaust manifold 22 which is, in turn, connected to the turbine 12 via a high pressure exhaust gas duct 24. The turbine 12 (specifically the turbine wheel thereof) extracts energy from the exhaust gas to drive the turbocharger shaft 14 and thereby power the compressor 10. Exhaust gas leaving the turbocharger 12 is supplied to the exhaust gas aftertreatment system 8 via a downpipe 26. The downpipe 26 is relatively long in extent, for example at least 2 metres in length, as indicated by the broken line in FIG. 1.

The exhaust gas aftertreatment system 8 comprises a decomposition chamber 28 having a diameter larger than that of the downpipe 26. The decomposition chamber 28 comprises a mixing element 30 disposed therein. The mixing element 30 typically comprises a number of baffles configured to deflect the flow through the decomposition chamber 28 to cause turbulence within the decomposition chamber 28. The exhaust gas aftertreatment system 8 comprises a dosing module 32 configured to inject an exhaust gas aftertreatment fluid, and specifically diesel exhaust fluid (DEF), into the decomposition chamber 28 downstream of the mixing element 30 in the region where the exhaust gas is most turbulent. Heat exchange between the DEF and the exhaust gas within the decomposition chamber 28 causes the urea contained within the DEF to decompose into the reductants ammonia (NH₃) and isocyanic acid (HNCO). The mixture of reductants and exhaust gas is then passed to a selective catalytic reducer (SCR) 34 and a diesel oxidation catalyst (DOC) 36. Finally, the exhaust gas is passed to an outlet duct 38 and onwards to a muffler (not shown) before being discharged to atmosphere.

FIG. 2 is a perspective view of a turbocharger 100, generally from above, comprising an exhaust system 105 (which may be referred to as a turbine dosing system) according to an embodiment of the present disclosure. The turbocharger 100 comprises a turbine 101 and a compressor 103 interconnected by a bearing housing 106. Owing to the incorporation of a wastegate (as will be described in detail later in this document), the turbocharger 100 may be described as a wastegate turbocharger, and the exhaust system may be described as a wastegate exhaust system.

In the illustrated embodiment, the turbine 101 forms part of the exhaust system 105. This is owing to the incorporation of a dosing module 126. This will be described in detail later in this document.

The turbine 101, and so exhaust system 105 more generally, comprises a turbine housing assembly 102. The turbine housing assembly 102 comprises a turbine housing 108 and a connection adapter 110. The turbine housing assembly 102 differs from, for example, a monoblock turbine housing, owing to the multi-part assembly of the turbine housing 108 and the connection adapter 110 (in comparison to the single-piece turbine housing construction of a monoblock turbine housing). The turbine housing 108 is the part of the turbine housing assembly 102 proximate the bearing housing 106. The turbine housing 108 is configured to engage the bearing housing 106. The connection adapter 110 is separated from the bearing housing 106 by at least an extent of the turbine housing 108. Described another way, the connection adapter 110 is provided downstream of the turbine housing 108.

In the illustrated embodiment, the turbine housing 108 defines a turbine inlet passage 112, a turbine wheel chamber (not visible in FIG. 2) and part of a turbine outlet passage 116. In particular, the turbine housing 108 defines an upstream portion (not visible in FIG. 2) of the turbine outlet passage 116. The turbine inlet passage 112 is defined by a volute 113 (which may otherwise be referred to as a scroll) and is configured to receive exhaust gas from an internal combustion engine (not shown). The volute 113 is thus the structure that defines the turbine inlet passage 112. The turbine inlet passage 112 encourages swirling of the exhaust gas about a turbine wheel axis (not shown in FIG. 2 but labelled 144 in FIG. 4). Described another way, the turbine inlet passage 112 geometry encourages swirl of the exhaust gas flow upstream of a turbine wheel (not visible in FIG. 2 but labelled 118 in FIG. 4). In some embodiments the turbine inlet passage 112 may also impart an axial component to the exhaust gas flow (e.g., in the case of a mixed flow turbine wheel, but not in the illustrated embodiment). The turbine inlet passage 112 may be described as extending in at least in a circumferential and a radial direction about the turbine wheel axis. The swirl of the exhaust gas is changed as the exhaust gas is expanded across the turbine wheel and may even be reversed depending upon flow conditions and surrounding geometry.

The connection adapter 110 defines a downstream portion 116b of the turbine outlet passage 116. Said downstream portion 116b may be referred to as a connection adapter passage. A first end 118 of the connection adapter 110 engages the turbine housing 108 (via an interposing gasket 117). The downstream portion 116b of the turbine outlet passage 116, which is defined by the connection adapter 110, is thus in fluid communication with an upstream portion 116a of the turbine outlet passage 116 (defined by the turbine housing 108 and not visible in FIG. 2 but shown in FIG. 4). It will be appreciated that the interposing gasket 117 is an optional feature and an interposing gasket 117 may not be present in other embodiments.

In the illustrated embodiment (and as will be appreciated from FIG. 4), the connection adapter 110 defines a diffuser (e.g., a diverging portion of the turbine outlet passage 116). Exhaust gas thus expands as it passes through the connection adapter 110. The connection adapter 110 may therefore be said to define a diffuser cone, outlet diffuser, or turbine stage outlet diffuser. Described another way, the connection adapter 110 defines at least part of a diffuser of the turbine 102, and, optionally, an entirety of a diffuser of the turbine 102.

Defining part of the turbine outlet passage 116 by the connection adapter 110 is advantageous because different connection adapters can be fixed, or attached, to the same turbine housing 108 design. Different connection adapters may incorporate different features for different applications.

Returning to FIG. 2, the connection adapter 110 comprises an interior surface 111. The connection adapter 110 further comprises a dosing module mount 122 and a NOx sensor mount 124. The dosing module mount 122 is engaged by the dosing module 126. The dosing module mount 122 thus aligns, and supports, the dosing module 126. The dosing module 126 is configured to deliver aftertreatment fluid into the exhaust gas in the turbine outlet passage 116. The dosing module mount 122 and the dosing module 124 are described in more detail below. The dosing module 126 is provided in fluid communication with a tank, or reservoir, in which a supply (e.g., volume) of aftertreatment fluid is stored.

The exhaust system 105 further comprises an exhaust gas sensor which, in this embodiment, is a NOx sensor 128. The exhaust system 105 further comprises a NOx sensor mount 124. The NOx sensor mount 124 is engaged by a NOx sensor 128.

Finally, FIG. 2 also shows a wastegate passage outlet 138. The wastegate passage outlet 138 is an aperture defined in the interior surface 111 (e.g., wall) of the connection adapter 110. In use, (bypass) exhaust gases can be diverted around the turbine wheel, through a wastegate passage 136 and into the turbine outlet passage 116 via the wastegate passage outlet 138.

Turning to FIG. 3, an alternative perspective view of the turbocharger 100 is provided.

FIG. 3 illustrates that the turbocharger 100 is a wastegate turbocharger comprising a wastegate arrangement 132. The wastegate arrangement 132 forms part of the exhaust system 105. The wastegate arrangement 132 comprises a valve assembly (not visible in FIG. 3) and the wastegate passage 136. As mentioned above, the wastegate passage 136 defines a fluid pathway from the turbine inlet passage 112 directly to the turbine outlet passage 116. The wastegate passage 136 is partly defined by the turbine housing 108 and partly defined by the connection adapter 110 in the illustrated embodiment. For example, neither the turbine housing 108, nor the connection adapter 110, may define an entire wastegate passage. The wastegate passage 136 provides selective fluid communication between the turbine inlet passage 112 and the turbine outlet passage 116, bypassing the turbine wheel chamber and turbine wheel. As such, (bypass) exhaust gas in the turbine inlet passage 112 can flow through the wastegate passage 136, to the turbine outlet passage 116, without passing through, or being expanded across, the turbine wheel 118. This allows control the rotational speed of the turbine wheel.

The wastegate passage 136 comprises a wastegate passage inlet and the wastegate passage outlet (neither of which are visible in FIG. 3). The wastegate passage inlet is defined by an opening in a wall of the turbine housing 108 which defines the turbine inlet passage. As such, exhaust gas flow passes into the wastegate passage 136 via the wastegate passage opening and leaves the wastegate passage 136 via the wastegate passage outlet (not visible in FIG. 3). As the (bypass) exhaust gas leaves the wastegate passage 136 it mixes with the (turbine bulk flow) exhaust gas in the turbine outlet passage 116.

In accordance with the terminology used throughout this document, the wastegate passage 136 refers to a volume through which (bypass) exhaust gas flows. The wastegate passage 136 may be described as being defined by a wastegate channel (the wastegate channel specifically being visible in FIG. 3). In the illustrated embodiment, the wastegate channel is defined by an upstream portion 133 and a downstream portion 135. The upstream portion 133 of the wastegate channel is defined by the turbine housing. The downstream portion 135 of the wastegate channel is defined by the connection adapter 110. The connection adapter 110 may thus be described as comprising at least part of the wastegate channel and/or at least part of the wastegate passage 136. The combination of the upstream portion 133 and downstream portion 135 may the entire wastegate channel/entire wastegate passage.

The bypass exhaust gas flowing through the wastegate passage outlet is a high-energy exhaust gas flow which has not been expanded across the turbine wheel. A zone in which two high velocity gas streams (e.g., a turbine bulk flow and a bypass flow) merge is thus defined proximate the wastegate passage outlet. A high level of mixing can be realised in this zone, the level of mixing being influenced by the momentum exchange of the two gas flows. For reasons described in detail below, the high level of mixing is utilised by locating the dosing module 126 proximate the wastegate passage outlet.

The wastegate valve assembly comprises a valve member (an example of a bypass control valve), which is rotatable by an actuation rod 142. In use, the actuation rod 142 is configured to cause rotation of the valve member such that the valve member contacts, or does not contact, a corresponding valve seat, which is defined by the turbine housing 108. The valve member acts to selectively sealingly engage the valve seat to selectively open and close the wastegate passage 136 so as to permit, or substantially prevent, exhaust gas flow through the wastegate passage 136. When the valve member sealingly engages the valve seat, the wastegate passage 136 is effectively closed and all exhaust gas which passes through the turbine inlet passage is expanded across the turbine wheel. When the valve member does not sealingly engage the valve seat, the wastegate passage 136 is at least partly open and at least a portion of exhaust gas which passes through the turbine inlet passage is not expanded across the turbine wheel and is instead diverted around the turbine wheel via the wastegate passage 136. The valve seat may therefore be described as defining an inlet of the wastegate passage 136, and specifically a cross-sectional area of the inlet of the wastegate passage 136.

The actuation rod 142 is a pneumatic actuator in the illustrated embodiment. In other embodiments the actuator may be hydraulic or electric.

The turbine 101 is a wastegate turbine (as indicated by the actuation rod 142). However, in some embodiments described throughout this document the turbine may not incorporate a wastegate assembly. The turbine may be a variable geometry turbine. Examples of variable geometry turbines include turbines comprising a swing vane assembly and/or an axially displaceable nozzle ring or other geometry which varies the extent to which a nozzle, through which exhaust gas flows, is open (upstream of the turbine wheel).

FIG. 4 is a side cross-sectional view of the turbocharger 100. FIG. 4 shows further features of the exhaust system 105 which forms part of the turbocharger 100.

The connection adapter 110 comprises the generally tapered interior surface 111 (e.g., a conical wall), whereat the cross-sectional area of the interior of the connection adapter 110 increases, from the first end 115 to an opposing second end 120, along an axial extent of the connection adapter 110. The cross-sectional area of the turbine outlet passage 116 may thus be said to diverge along the connection adapter 110. The second end 120 is the end of the connection adapter 110 which is furthest away from the turbine housing 108. The increasing cross-sectional area defines a diffuser. As exhaust gas travels through the connection adapter 110, from the first end 118 to the second end 120, the velocity of the exhaust decreases, and the static pressure of the exhaust gas increases, owing to the cross-sectional area of the turbine outlet passage 116 increasing. Increasing the static pressure of the exhaust gas in the connection adapter 110 increases the efficiency of the turbine wheel 101 because pressure recovery which is achieved by the connection adapter 110 allows for a greater pressure ratio across the turbine wheel and therefore an increase in the turbine wheel efficiency.

As shown in FIG. 4, the turbine wheel chamber 114 houses a turbine wheel 118. The turbine wheel 118 is configured to rotate about a turbine wheel axis 144. The turbine inlet passage 112 is in fluid communication with the turbine wheel chamber 114. The turbine wheel chamber 114 is in fluid communication with the turbine outlet passage 116.

In use, exhaust gas passes through the turbine inlet passage 112 and into the turbine wheel chamber 114. The exhaust gas is then expanded across the turbine wheel 118 (i.e., does work on the turbine wheel 118) which, in turn, drives rotation of the turbine wheel 118 about the turbine wheel axis 144. As exhaust gas passes over the turbine wheel 118, the magnitude of swirl and/or swirl direction of the exhaust gas changes. The turbine wheel 118 is a radial turbine wheel in that exhaust gas flow from the turbine inlet passage 112 impinges the turbine wheel 118 in a generally radial direction relative to the turbine wheel axis and exits the turbine wheel 118 in a generally axial direction relative to the turbine wheel axis 144 (albeit with a swirling component). As the exhaust gas exits the turbine wheel 118 and leaves the wheel chamber 114, it passes into the upstream portion 116a of the turbine outlet passage 116. In other embodiments, the turbine may be an axial turbine, whereby exhaust gas enters a turbine wheel in a generally axial direction and leaves the turbine wheel in a generally axial direction (albeit with a swirling component).

The turbine wheel 118 is supported for rotation about the turbine wheel axis 144 by a shaft 146. The shaft 146 extends from the turbine housing 108 to the compressor housing 104 through the bearing housing 106. The turbine wheel 118 is mounted to one end of the shaft 146 and a compressor wheel 148 is mounted on the other end of the shaft 146. The turbine wheel 118 may be mounted to the end of the shaft 146 by friction welding, laser welding, electron beam welding, or any other suitable method. The turbine wheel 118 and the compressor wheel 150 are therefore in power communication with one another. The shaft 146 rotates about the turbine wheel axis 144 on bearing assemblies 150 located in the bearing housing 106.

The turbine outlet passage 116 is defined by the turbine housing 108 and the connection adapter 110 in the illustrated embodiment. The cross-sectional area of the turbine outlet passage 116 increases linearly from the most upstream end of the passage (i.e., proximate the turbine wheel 118) to the most downstream end of the passage (i.e., distal the turbine wheel 118), so as to define a diffuser.

A flow axis 145 is defined by the turbine outlet passage 116. The flow axis 145 is the (nominal) geometric centreline of the turbine outlet passage 116 as defined by the turbine housing 108 and the connection adapter 110. In this embodiment, and as will be appreciated from FIG. 5, the flow axis 145 is coincident with the turbine axis 144. However, in other embodiments, where the turbine outlet passage 116 is not a linear passage, i.e., the turbine outlet passage 116 may comprise a bend, the flow axis 145 will deviate away from the turbine wheel axis 144.

The turbine wheel 118 is visible in FIG. 4 and comprises a plurality of turbine blades 119. The turbine wheel 118 comprises an inducer 172 configured to receive exhaust gas flow 152a from the turbine inlet passage 112. The exhaust gas 152a is received in a radial direction relative to the turbine wheel axis 144. The turbine wheel 118 further comprises an exducer 174 configured to discharge the exhaust gas flow from the turbine wheel 118. The exhaust gas flow is discharged along a flow axis 145. The exducer 174 defines an exducer diameter 176. The exducer diameter 176 is the distance across the turbine wheel 118, in a plane normal to the turbine wheel axis 144, at downstream tips of the blades 119. A downstream end, or tip, of the turbine wheel 118 is labelled 178 in FIG. 4. In some embodiments the downstream end of the turbine wheel 118 may be defined by a wheel nut, the downstream end of the turbine wheel lying in a wheel nut plane. As will be described later in this document, the exducer diameter 176 can be used as a metric for defining the position of the dosing module 126 with respect to the downstream end of the turbine wheel 118. In the illustrated embodiment the exducer diameter 176 is approximately 60 mm (e.g., 58 mm, 59 mm, 61 mm, 62 mm, etc.). In other embodiments, the exducer diameter may be between around 30 mm and around 200 mm.

The cross-sectional area of the upstream portion 116a of the turbine outlet passage 116 increases from the downstream end 178 of the turbine wheel 118. The cross-sectional area increases linearly (i.e., the inner wall surface diverges at a constant angle). In other embodiments, the turbine outlet passage, or a portion thereof, may have a constant cross-sectional area. In further embodiments, the turbine outlet passage may have a constant cross-sectional area, and then the cross-sectional area increases after a particular point along the flow axis. For example, the upstream portion of the turbine outlet passage, defined by the turbine housing, may be constant, and the downstream portion of the turbine outlet passage, defined by the connection adapter may have a cross-sectional area that increases linearly.

In the illustrated embodiment, the interior surface 111 of the connection adapter 110 diverges linearly along the flow axis 145. In other embodiments, the interior surface 111 may diverge in a non-linear fashion. The angle of the divergence may be varied dependent upon the design conditions of each turbocharger. The divergence may be defined by an angle 121 by which inner wall surfaces 162a, 162b of a wall 162 of the connection adapter 110 are inclined relative to one another. The angle 121 may be described as a diffuser angle. The angle 121 is around 7.5° in the illustrated embodiment. The angle 121 is preferably between around 5° and around 20°. The angle 121 is preferably between around 6° and around 15°. The angle 121 is preferably between around 7° and around 10°. The wall 162 is an example of a structure which defines at least part of the turbine outlet passage 116. In other embodiments, the connection adapter 110 may define a constant cross-sectional area before diverging linearly along the flow axis 145.

The angle 121 thus defines a diffuser angle of the turbine outlet passage 116. In the illustrated embodiment, the diverging portion of the turbine outlet passage 116 extends continuously across both the upstream and downstream portions 116a, 116b of the turbine outlet passage 116 (e.g., as defined by the turbine housing 102 and the connection adapter 110). Described another way, the turbine outlet passage 116 diverges, at a constant angle, from an upstream point of the turbine outlet passage 116 (at the downstream end 178 of the turbine wheel 118) to at least a second end 192 of the connection adapter 110. Part of the divergence also extends further upstream of the downstream end 178 of the turbine wheel 118 into the wheel chamber 114. Part of the wheel chamber 114 thus diverges. In other embodiments, the diverging portion may be bound by the connection adapter 110 (e.g., not extend beyond the connection adapter 110).

As previously described, the connection adapter 110 comprises the dosing module mount 122. The dosing module mount 122 is integrally formed with the connection adapter 110 in the illustrated embodiment. In other words, the dosing module mount 122 and the connection adapter 110 are a unitary structure. Accordingly, the dosing module mount 122 and the connection adapter 110 may be manufactured by casting the single, combined structure. The dosing module mount 122 defines an opening 164 in the interior surface 111 of the connection adapter 110. The opening 164 may be described as a dosing aperture. Aftertreatment fluid is injected into exhaust gas through the opening 164. For completeness, the dosing module mount 122 may be incorporated as part of a turbine housing (e.g., a monoblock turbine housing—a one-piece, or unitary, turbine housing and diffuser), a connection adapter or a conduit. That is to say, the dosing module 126 may be mounted to a turbine housing, a monoblock turbine housing, a connection adapter, or a conduit downstream of the turbine.

The dosing module 126 is a self-atomising dosing module that it is configured to inject aftertreatment fluid from an outlet 166 of the dosing module 126 as a fine spray. The dosing module 126 is configured to inject aftertreatment fluid into a bulk exhaust gas flow 152b in the turbine outlet passage 116 downstream of the turbine wheel 118. Because the aftertreatment fluid is injected as a fine spray, there is no need for the aftertreatment fluid to be injected into a structure which promotes atomisation of the aftertreatment fluid, such as a rotary dosing cup provided in the turbine wheel, before being mixed with the bulk exhaust gas flow 152b. The dosing module 126 injects aftertreatment fluid from the outlet 166 as a fine spray in a generally conical manner. A spray cone (of atomised aftertreatment fluid) is labelled 139.

Where the spray 139 meets the interior surface 111, a primary impingement zone is defined. It is desirable that at least the primary impingement zone of the interior surface 111 have some corrosion-resistant properties, owing to a risk of corrosion from byproducts of the aftertreatment fluid. For example, a sleeve made of corrosion-resistant material may be incorporated. In other embodiments, the connection adapter 110 may be manufactured from a corrosion-resistant material. Stainless steel is one example of a corrosion-resistant material. An entirety of the interior surface 111 may be covered in, or manufactured from, a corrosion-resistant material such as stainless steel. Other materials which are also resistant to corrosion may be utilised in place of, or in combination with, stainless steel.

In the illustrated embodiment the dosing module 126 is angled towards the flow axis 145 such that the dosing module 126 (specifically the outlet 166 thereof) points in a downstream direction (e.g., towards the second end 120 of the connection adapter 120, and away from the turbine wheel 118). Aftertreatment fluid expelled by the dosing module 126 is thus injected in a direction (slightly) with the flow. Given that the orientation of the dosing module 126 is defined by the dosing module mount 122, it follows that the dosing module mount 122 is also angled towards the flow axis 145 such that the opening 164 of the dosing module mount 122 points in a downstream direction. This orientation is desirable for reasons of a more predictable spray placement at a wider range of engine operating conditions.

It will, nevertheless, be appreciated that, in other embodiments, the dosing module 126 and dosing module mount 122 may be angled so that aftertreatment fluid is injected in a perpendicular direction relative to the flow axis 145 (e.g., in a radial direction). In further embodiments, the dosing module 126 and dosing module mount 122 may be angled so that aftertreatment fluid is injected in an upstream direction (i.e., towards the turbine wheel 118).

A minimum distance 180 between a centroid of the outlet 166 of the dosing module 126 (and, by virtue of concentric alignment, also a centroid of the opening 164 of the dosing module mount 122) and the flow axis 145 defines an outlet intersection point 182 along the flow axis 145. The outlet intersection point 182 marks the axial position of the opening 164, and outlet 166, along the flow axis 145.

Similarly, a minimum distance between a centroid 139 of the wastegate passage outlet 138 defines a wastegate passage intersection point 183 along the flow axis 145. The wastegate passage intersection point 183 marks the axial position of the wastegate passage outlet 138 along the flow axis 145.

An axial distance 185 between the outlet intersection point 182 and the wastegate passage intersection point 183, along the flow axis 145, defines a location of the dosing module 126 with respect to the wastegate passage outlet 138.

By locating the dosing module 126 within and/or around 3 turbine outlet passage diameters of the wastegate passage outlet 138 along the flow axis 145, the location at which aftertreatment fluid is injected into the turbine outlet passage 116 is positioned relatively close to the wastegate passage outlet 138. The aftertreatment fluid is thus injected into relatively high-energy exhaust gas flow, which has not been expanded across the turbine wheel 118. The aftertreatment fluid is also injected into a zone in which two high velocity gas streams (e.g., a turbine bulk flow 152b and a bypass flow 152c) merge. A high level of mixing is thus realised, the level of mixing being influenced by the momentum exchange of the two gas flows. By injecting the aftertreatment fluid near the wastegate passage outlet 138, the increased levels of mixing, in the aforementioned zone, facilitate the dispersal of aftertreatment fluid (specifically the reductant thereof) throughout the exhaust gas flow. The aftertreatment fluid is also subjected to high levels of relative velocities (i.e., gas velocity vs reductant droplet velocity), which increases the convective heat transfer to the droplet, in turn increasing decomposition. As a droplet traverses a high-mixing zone, it is exposed to many different local velocities that push, pull, & shear the droplet in different directions. This chaotic flow field (as can be indicated by a turbulent kinetic energy (TKE) metric) facilitates the mixing. The temperature of the bypass flow 152c is also comparatively higher than the turbine bulk flow 152b, owing to that the bypass flow 152c not having been expanded across the turbine wheel 118. The higher exhaust gas temperature promotes decomposition of the injected aftertreatment fluid by facilitating evaporation of the deionised water and the thermal decomposition of urea into constituent reductants.

The removal of harmful gases from the bulk exhaust gas flow 152b is thus promoted.

The distance between the downstream end 178 of the turbine wheel 118 and the intersection point 182 is approximately 2.4 exducer diameters (i.e., around 2.4 times the distance indicated by numeral 176) measured along the flow axis 145. The intersection point 182 is preferably up to around 10 exducer diameters downstream of the downstream end 178 of the turbine wheel 118, measured along the flow axis 145. The intersection point 182 may be between around 3 and around 7 exducer diameters, downstream of the downstream end 178 of the turbine wheel 118, measured along the flow axis 145. In other embodiments, the distance between the downstream end 178 of the turbine wheel 118 and the outlet intersection point 182 may be different. However, said distance is preferably no more than around 10 exducer diameters, and is preferably within around 5 exducer diameters.

By locating the dosing module 126, and so dosing module outlet 166, relatively close to the turbine wheel 118, decomposition of the injected aftertreatment fluid, into reductants, for example, ammonia (NH₃) and isocyanic acid (HNCO), (to support a downstream SCR reaction) is improved. This is because the distance between where aftertreatment fluid is injected and a downstream selective catalytic reduction (SCR) catalyst is increased, and hence the time available for decomposition before reaching the SCR catalyst is also increased, thereby increasing the amount of decomposition of the injected aftertreatment fluid. This is particularly advantageous when operating at relatively low exhaust gas temperatures, for example at engine start-up.

Decomposition is improved, at least in part, because the swirl of the bulk exhaust gas flow 152b, after being discharged from the turbine wheel 118, is greater than, for example, the exhaust gas significantly downstream of the turbine wheel (e.g., in a decomposition chamber). Regions within the exhaust gas flow, having a high turbulent kinetic energy (beneficial for promoting the mixing of aftertreatment fluid with the bulk exhaust gas flow, due to increased momentum exchange between the aftertreatment fluid and the bulk exhaust gas flow) are thus present, and greater in magnitude, owing to the proximity to the turbine wheel 118. The higher turbulent kinetic energy of the bulk exhaust gas flow also promotes droplet break-up of the injected aftertreatment fluid. Increasing droplet break-up of aftertreatment fluid improves the uniformity of mixing of the aftertreatment fluid with the bulk exhaust gas flow and, in turn, increases decomposition of the aftertreatment fluid.

The temperature of the bulk exhaust gas flow 152b is also comparatively higher in proximity to the turbine wheel 118. The higher exhaust gas temperature promotes decomposition of the injected aftertreatment fluid by facilitating evaporation of the deionised water and the thermal decomposition of urea into constituent reductants. Decomposition is also promoted by way of higher convective heat transfer of the turbine bulk flow to the droplets of aftertreatment fluid.

The velocities of the bulk exhaust gas flow at the walls of the turbine outlet passage 116 are also higher closer to the turbine wheel 118 than at locations further downstream. The higher velocities generate comparatively high shear forces in these regions and reduce the risk of aftertreatment fluid settling on the interior surface 111 (for example) which defines the turbine outlet passage 116. The risk of undesirable deposit build-up within the turbine outlet passage 116 is therefore also reduced. The comparatively high velocities of the turbine bulk flow also contribute to improved convective heat transfer to the aftertreatment fluid droplets.

The removal of harmful gases from the bulk exhaust gas flow 152b (e.g., the denoxification of exhaust gas) is thus promoted.

The placement of the dosing module 126, in proximity to the downstream end 178 of the turbine wheel 118, may facilitate solutions for or otherwise mitigate: i) poor decomposition of the aftertreatment fluid due to low exhaust gas temperatures and/or low turbulent kinetic energy of the exhaust gas flow; ii) packaging considerations/constraints when locating the dosing module significantly downstream of the engine; iii) unwanted system backpressure due to the use of a traditional, downstream decomposition chamber, which can decrease the efficiency of an upstream engine; iv) aftertreatment deposit formation on any proximate interior surfaces; and v) high thermal mass of the downstream aftertreatment components (e.g., decomposition chamber) of a traditional system.

In the illustrated embodiment, the dosing module 126 is positioned such that the outlet 166 overlaps the wastegate passage outlet 138 along the flow axis 145. Furthermore, in the illustrated embodiment a centroid of the outlet 166 lies within the axial extent 137 of the wastegate passage outlet 138. The outlet intersection point 182 (indicating the position of the outlet 166 of the dosing module 126) thus lies within the axial extent 137 of the wastegate passage outlet 138. The centroid of the outlet 166 is also substantially axially aligned with the centroid 181 of the wastegate passage outlet 138 in the illustrated embodiment. It will be appreciated that in other embodiments the axial offset 185 between the dosing module 126 and the centroid of the wastegate passage outlet 138 may be greater, and up to within around 3 turbine outlet passage diameters along the flow axis 145.

Throughout the above description, it will be appreciated that the references to the position of the outlet 166 of the dosing module 126 also apply to the opening 164 of the dosing module mount 122. This is owing to the dosing module 126 being concentrically mounted to the dosing module mount 122. The outlet 166 and opening 164 may be said to share a centroid owing to the concentric alignment between the components.

The wastegate passage outlet 138 is circumferentially spaced from the outlet 166 about the flow axis 145. As also shown in FIG. 5, the wastegate passage outlet 138 is circumferentially spaced, by approximately 90 degrees around the flow axis 145, from the outlet 166 of the dosing module 126. In preferred embodiments the wastegate passage outlet 138 is circumferentially spaced from the outlet 166 of the dosing module 126, around the flow axis 145, by between around 30 degrees and around 110 degrees.

Returning to FIG. 4, the wastegate passage 136 is aligned such that a wastegate passage exhaust gas flow 152c (i.e., a bypass flow) exits the wastegate passage outlet 138 and enters the turbine outlet passage 116 (specifically the downstream portion 116b thereof), with a velocity which is generally tangential to the flow axis 145. This is also indicated in FIG. 5.

The outlet 166 is shown overlapping the axial extent 137 of the wastegate passage outlet 138. The outlet 166 is also substantially axially aligned with the centroid 181 of the wastegate passage outlet 138 by virtue of the axial distance 185 being less than around a major dimension (e.g., diameter) of the opening 164.

The elongate geometry of the wastegate passage outlet 138 (e.g., the aperture being letterbox-shaped) in the flow axis 145 direction, and the tangential introduction of the wastegate passage exhaust gas flow, generates comparatively high shearing forces in the wastage passage exhaust gas flow. The shearing forces are generated by virtue of a layer of comparatively high velocity exhaust gases proximate the interior surface 111. Such shearing forces are desirable for reasons of improved mixing of aftertreatment fluid with exhaust gas, and reduced risk of deposit build-up on the interior surface 111, particularly proximate a primary impingement zone (e.g., a surface generally opposite the outlet 166 of the dosing module 126 and bound by spray cone 139 in FIG. 4). The letterbox-shaped wastegate passage outlet 138 also means that the shearing forces are generated over a comparatively larger surface area (e.g., along the flow axis 145).

The bulk flow 152b leaving the turbine wheel 118 will swirl around the centreline 145 in a positive angular direction. The wastegate passage outlet 138 is configured so that the flow layer 153c enters the diffuser in a generally tangential direction to the centreline 145 in the positive angular direction. According the bulk flow 152b and the flow layer 152c swirl around the centreline 145 in the same angular direction. This enables the flow layer 152c to add to the angular component of velocity of the bulk flow 152b, so as to contribute the overall angular momentum of the combined flows.

Although FIG. 4 shows the outlet 166 of the dosing module 126 substantially aligned with the interior surface 111, in other embodiments the outlet 166 (optionally a nozzle of the dosing module 126 in which the outlet 166 is provided) may protrude into the turbine outlet passage 116 (e.g., proud of the opening 164). Substantially aligned (i.e., substantially flush) is intended to mean that the outlet 166 is within around ±2 mm, along the dosing module axis 167, of the opening 164 in the interior surface 111. This reduces the risk that exhaust gas recirculates proximate the outlet 166 of the dosing module 126.

FIG. 5 is an end view of the turbocharger 100 from the turbine housing assembly 102 end.

An angle 184 between the dosing module axis 167 and the central axis 186 of the NOx sensor 128 (i.e., a circumferential offset between the dosing module 126 and the NOx sensor 128) is approximately 90 degrees in the illustrated embodiment (about the flow axis 145). The angle 184 is preferably between around 30 degrees and around 90 degrees. Similarly, an angle 187 between a wastegate passage outlet axis 189, which passes the through the centroid of the wastegate passage outlet 138, and the dosing module axis 167 (i.e., a circumferential offset between the centroid of the wastegate passage outlet 138 and the dosing module 126), is also approximately 90 degrees about the flow axis 145 in the illustrated embodiment. The angle 187 is preferably between around 45 degrees and around 110 degrees. An angle 188 between the wastegate passage outlet axis 189 and the central axis 302 of the NOx sensor 128 (i.e., a circumferential offset between the centroid of the wastegate passage outlet 138 and the NOx sensor 128) is approximately 180 degrees in the illustrated embodiment. The angle 188 is preferably between around 75 degrees and around 180 degrees. In the illustrated embodiment the dosing module 126 interposes the wastegate passage outlet 138 and the NOx sensor 128 circumferentially.

FIG. 5 also shows the wastegate passage exhaust gas flow 152c entering the turbine outlet passage 116 in a generally tangential direction. As indicated in FIG. 5, wastegate passage exhaust gas flow 152c swirls in a generally counterclockwise direction when viewed from an outer end of the connection adapter 110. This direction of swirl is the same direction as the swirl of the bulk exhaust flow 152b once expanded across the turbine wheel 118. As such, the wastegate passage exhaust gas flow 152c may be said to swirl in the same direction as the bulk exhaust flow 152b. The swirl direction may be described in relation to a direction in which the volute 113 extends, around the turbine wheel axis (which, in the illustrated embodiment, is coincident with the flow axis 145) towards the wheel chamber. Specifically, the exhaust gas flow swirls in the same direction as the volute 113 extends. The swirl direction of the bulk exhaust flow 152b may vary with engine operation condition. For example, in some operating conditions the bulk exhaust flow, or a portion of the bulk exhaust flow, may swirl in the opposite direction to that which the volute 113 extends. For example, at operating conditions whereby the turbine achieves a peak power output, the bulk exhaust flow may swirl in substantially the same direction as the volute 113 extends. Whereas, if the turbine is operating at a lower load condition, then a portion, or all, of the bulk exhaust flow may swirl in a direction which is opposite the direction in which the volute 113 extends. However, for the purposes of this document the swirl direction of the turbine bulk exhaust flow is referred to as a nominal swirl direction. The nominal swirl direction is the same direction in which the volute 113 extends, and the same direction in which the turbine wheel 118 rotates (or is rotatable in use).

FIG. 6 is a cross-sectional end view of the turbocharger 100 taken from the plane A-A indicated in FIG. 4.

FIG. 6 illustrates that the NOx sensor 128 is axially upstream (i.e., closer to the turbine wheel 118) of the dosing module 126. This is for reasons of reducing the risk of aftertreatment fluid impinging upon the NOx sensor 128.

FIG. 6 illustrates how the dosing module mount 122 and the NOx sensor mount 124 are both integral with the connection adapter 110. In other words, the dosing module mount 122 and the NOx sensor mount 124 form a unitary structure with the connection adapter 110. In other embodiments, the dosing module mount 122 and/or the NOx sensor mount 124 may be formed from separate components which are subsequently connected to the connection adapter 110.

FIG. 6 also shows part of the wastegate passage 136, the valve member 140, and more of the path taken by the wastegate passage exhaust gas flow 152c. The valve member 140 is mounted within the turbine housing in the illustrated embodiment but could be mounted within the connection adapter 110 in other embodiments.

FIG. 7 is a schematic block diagram of an exhaust system 200 according to an embodiment of the disclosure. The exhaust system 200 is configured to receive exhaust gas from an internal combustion engine 202. The exhaust system 200 comprises a turbine 204 having a turbine inlet 206, a turbine wheel 208, and a turbine outlet 210. The turbine inlet 206 receives exhaust gas from the internal combustion engine 202. The turbine wheel 208 is positioned within a turbine wheel chamber (not shown) and receives exhaust gas from the turbine inlet 206. The turbine outlet 210 receives exhaust gas from the turbine wheel 208. The turbine outlet 210 may be an axial turbine outlet having a constant cross-sectional area or may comprise a diffuser having an increasing cross-sectional area and configured to expand the exhaust gas received from the turbine wheel 208. The turbine 204 further comprises a bypass passage 212 configured to route exhaust gas from a position upstream of the turbine wheel 208 to a position downstream of the turbine wheel 212 without passing through the turbine wheel 212. The bypass passage 212 comprises a bypass control valve 214 configured to selectively permit, prevent, or otherwise control or regulate the flow of exhaust gas through the bypass passage 212. The bypass control valve 214 may be a wastegate valve and/or rotary control valve in some embodiments. The turbine 204 further comprises a variable geometry mechanism 216 configured to control the flow of exhaust gas from the turbine inlet 206 to the turbine wheel 208. The variable geometry mechanism 216 may be any suitable variable geometry mechanism, for example a so-called swing vane mechanism or a so-called sliding nozzle mechanism. In alternative embodiments, the turbine 204 may comprise only one of the bypass passage 212 (including control valve 214) and the variable geometry mechanism 216. For example, the turbine 204 may be the same turbine described above in relation to FIGS. 2 to 6 (albeit with a variable geometry mechanism incorporated) or may be a different turbine comprising only the variable geometry mechanism 216. Although the exhaust system 200 described above comprises a turbine 204 having both the bypass control valve 214 and the variable geometry mechanism 216, in other embodiments the turbine may incorporate only one of a bypass control valve and a variable geometry mechanism.

The exhaust system 200 further comprises an aftertreatment device 218 configured to receive exhaust gas from the turbine outlet 210. The aftertreatment device 218 may be, for example, a catalyst such as a diesel oxidation catalyst (DOC) or a selective catalytic reduction (SCR) catalyst. The exhaust system 200 further comprises a dosing module 220 configured to deliver an aftertreatment fluid to the turbine outlet passage 210. Where the aftertreatment device is a DOC the aftertreatment fluid may be, in particular, a hydrocarbon such as gasoline or diesel, and where the aftertreatment device 218 is a SCR catalyst, the aftertreatment fluid may be, in particular, an ammonia and water mixture, for example in the proportion of 67.5% by volume water to 32.5% by volume urea (sometimes called diesel exhaust fluid (DEF) and sold under the registered trademark AdBlue). As described in connection with FIGS. 2 to 5, the dosing module 220 may be mounted to a turbine housing (which may be a single-piece so-called ‘monoblock’ turbine housing), a connection adapter of a turbine or, in some embodiments, to a conduit downstream of the turbine.

The exhaust system 200 additionally comprises a plurality of sensors configured to measure one or more physical properties of the exhaust gas. In particular, the exhaust system 200 comprises a turbine inlet sensor 222, a turbine outlet sensor 224, an aftertreatment device outlet sensor 226, and an engine sensor 227. The turbine inlet sensor 222 may be configured to sense one or more of: a pressure of the exhaust gas in the turbine inlet, a temperature of the exhaust gas in the turbine inlet, a mass flow rate of the exhaust gas in the turbine inlet or a volumetric flow rate of the exhaust gas in the turbine inlet. The turbine outlet sensor 224 may be configured to sense one or more of: a pressure of the exhaust gas in the turbine outlet, a temperature of the exhaust gas in the turbine outlet, a mass flow rate of the exhaust gas in the turbine outlet, a volumetric flow rate of the exhaust gas in the turbine outlet, or a NOx concentration of the exhaust gas in the turbine outlet. The aftertreatment device outlet sensor 226 may be configured to sense one or more of: a pressure of the exhaust gas at the outlet of the aftertreatment device, a temperature of the exhaust gas at the outlet of the aftertreatment device, a mass flow rate of the exhaust gas at the outlet of the aftertreatment device, a volumetric flow rate of the exhaust gas at the outlet of the aftertreatment device, or a NOx concentration of the exhaust gas at the outlet of the aftertreatment device. The engine sensor 227 may be configured to sense one or more of an engine speed, an engine air mass flow rate, an engine inlet pressure, an engine inlet temperature, an engine boost pressure, an engine load, an engine cylinder temperature, an engine cylinder pressure, and an engine fuel pressure.

The above notwithstanding, it will be appreciated that the above-described sensors 222, 224, 226, 227 may be configured to sense further properties of the exhaust system 200 and/or internal combustion engine 202 including, but not limited to, for example: a turbine inlet pressure; a turbine inlet temperature, a turbine outlet pressure, a turbine outlet temperature, an engine speed, a throttle position, an engine air mass flow rate, an engine inlet pressure, an engine inlet temperature, a NOx concentration, a catalyst gas temperature, an engine fuel flow rate, an engine air flow rate, an engine boost pressure, an engine intake pressure, an engine load, an engine rotational speed, an engine cylinder temperature, an engine cylinder pressure, or an engine fuel pressure. Moreover, the exhaust system 200 may comprise a greater or fewer number of sensors suited for the purposes of obtaining the information listed above and positioned at any relevant location within the system. For example, the exhaust system 200 may comprise further sensors (e.g., temperature sensors) at the inlet of the aftertreatment device 218 (e.g., between the turbine outlet sensor 224 and the aftertreatment device 218) to measure the aftertreatment device inlet temperature and/or pressure and/or within the aftertreatment device 218 to measure the temperature and/or pressure of the exhaust gas passing through the aftertreatment device 218.

The exhaust system 200 comprises a controller 228 in communication with the sensors 222, 224, 226, 227 to receive information therefrom. The controller 228 is further in communication with the bypass control valve 214 and the variable geometry mechanism 216. As will be described in detail below, the controller 228 is operable to receive and process information obtained by the sensors and to issue commands to the bypass control valve 214 and/or variable geometry mechanism 216. The operating characteristics of the bypass control valve 214 and variable geometry mechanism 216 are adjustable in response to the commands issued by the controller 228. For example, the bypass control valve 214 may be moved by an actuator (not shown) in response to a command issued by the controller 228 to control the flow rate of exhaust gas through the bypass passage 212. Likewise, the variable geometry mechanism may be moved by an actuator in response to a command issued by the controller 228 to control the flow rate of exhaust gas through the turbine inlet 206 to the turbine wheel 208.

FIG. 8 shows a schematic block diagram of a method 300 of operating the exhaust system 200 described above. The method may be implemented in use as computational program stored within the controller 228. In a first step 302, the method comprises determining a current property of the exhaust gas. The current property of the exhaust gas may be determined based upon information received, for example, from the sensors 222, 224, 226, 227. The current property may be a quantity that is directly measurable by the sensors (for example temperature, pressure, or the like) at a particular location of the exhaust system 200. In other embodiments, the current property may be a property of the exhaust gas that is not directly measurable by the sensors but is instead inferred by the controller 228 based upon information received from the sensors in relation to other properties of the exhaust system 200. In particular, the controller 228 may include one or more formulas or datasets (e.g., ‘look up’ tables) that allow the controller 228 to infer a property of the exhaust gas based upon one or more inputs from the sensors. For example, it may be possible to infer the amount of swirling momentum of the exhaust gas in the turbine outlet 210 based upon knowledge of the current operating efficiency of the turbine 204, which may in turn be inferred based upon parameters such as the turbine inlet and turbine outlet pressures and temperatures, the engine mass flow rate, and the engine speed. In general, it will be appreciated that the current property of the exhaust gas may be any quantifiable property, and moreover may comprise not only a single quantity of the property at a particular spatial position but may instead comprise an array of the quantities of the property across a range of spatial positions. For example, the current property may be a temperature or velocity profile at a particular position or range of positions within the turbine outlet 210.

In a second step 304, the method 300 comprises making a determination of the existence (or otherwise) of a difference between the current property of the exhaust gas determined in step 302 to a reference property of the exhaust gas. As in the case of the current property of the exhaust gas, the reference property of the exhaust gas may be any quantifiable property of the exhaust gas, and moreover may comprise a single quantity of the property at a particular spatial position or an array of the quantities of the property across a range of spatial positions. The reference property of the exhaust gas may be stored in a memory associated with the controller 228, for example as part of a data set. The controller compares the current property to the reference property to determine whether any differences between the two exist. In some arrangements, the level of the difference between the two may be quantified. In other arrangements, merely the existence of the difference is identified. For example, the current property may be the magnitude of the swirling momentum of the exhaust gas in the turbine outlet passage 210. The reference property may be a magnitude of the swirling momentum in the turbine outlet passage 210 required to provide optimum mixing of exhaust gas and aftertreatment fluid. When the controller 228 determines that there is a difference between the current quantity of swirling momentum (for example) in the turbine outlet 210 and the reference quantity of swirling momentum in the turbine outlet 210, this indicates that the amount of swirling momentum of the exhaust gas in the turbine outlet 210 does not correspond to the amount of swirling momentum required for optimum mixing (for example).

In a third step 306, the method 300 comprises, in response to the determination of the difference in step 204, adjusting the variable geometry mechanism 216 and/or the bypass control valve 214. Adjusting the variable geometry mechanism 216 and/or the bypass control valve 214 will influence the properties of the exhaust gas in the turbine outlet 210. Accordingly, the variable geometry mechanism 216 and/or the bypass control valve 214 can be adjusted by the controller 228 to influence the properties of the exhaust gas in the turbine outlet 210 in a manner that addresses the nature of the difference between the current property and the reference property. In particular, following the swirl example discussed above, when the controller 228 determines that there is a difference between the current quantity of swirling momentum in the turbine outlet 210 and the reference quantity of swirling momentum in the turbine outlet 210 (and that, consequently, the amount of swirling momentum of the exhaust gas in the turbine outlet 210 does not correspond to the amount of swirling momentum required for optimum mixing), the controller 228 outputs a control command to the variable geometry mechanism 216 and/or the bypass control valve 214 to move either or both mechanisms to a position that will optimise the amount of swirling momentum in the turbine outlet 210. This may include increasing or decreasing the amount of swirl and/or changing the direction of swirl of the flow at large or at a particular point in the flow. The configurations of the variable geometry mechanism 216 and/or the bypass control valve 214 that provide optimum swirling can be determined through computer simulations and testing during the design and development of the exhaust system 200 and may be stored in a memory associated with the controller 228.

For example, during some operating conditions, the flow in the turbine outlet 210 exhibits angular velocities in two or more layers of opposing angular velocities, in generally annular rings surrounding the axis of the turbine. In response to the difference, the variable geometry mechanism can be placed in a configuration in which the magnitude between the velocities in the opposing angular directions is increased, and by doing so thereby increase the amount of turbulent mixing occurring within the turbine outlet 201, in turn promoting better dispersion of the aftertreatment fluid and better heat transfer to the aftertreatment fluid. In such circumstances, the current property of the turbine may be a velocity profile of the turbine outlet, and the difference may be indicative of a magnitude of the velocities in opposing angular directions in the turbine outlet.

It may be preferable for the turbine to operate at an expansion ratio that provides maximum turbine efficiency (this may be known as the optimum expansion ratio). The optimum expansion ratio will be a property of the physical geometry of the turbine itself. At the optimum expansion ratio, the swirl angle of the exhaust gas in the turbine outlet will be zero. Therefore, the variable geometry mechanism 216 and/or bypass control valve 214 may be controlled to increase or decrease swirl so as to arrive at the optimum expansion ratio. For example, during use, one or more reference properties of the exhaust gas may be used to determine the current expansion ratio. A suitable reference property may be, in particular, the turbine inlet pressure and/or turbine outlet pressure (although the latter may be assumed to be atmospheric). Once the current expansion ratio is calculated, a lookup table can be used to determine the current swirl angle of the exhaust gas in the turbine outlet based. The lookup values will be a property of the turbine geometry. Based upon the current swirl angle, the variable geometry mechanism 216 and/or bypass control valve 214 may be controlled to increase or decrease swirl so as to cause the swirl angle to approach zero, and thereby arrive at the optimum expansion ratio for the turbine.

If it is determined that it is necessary to increase the temperature of the exhaust gas, this may be achieved by widening (opening) the variable geometry mechanism 216. This will decrease the work extracted from the exhaust gas by the turbine wheel 208 and thereby increase the exhaust gas temperature. Likewise, if it is determined that it is necessary to decrease the temperature of the exhaust gas, this may be achieved by narrowing (closing) the variable geometry mechanism 216 for corresponding reasons.

If it is determined that the wall shear stress applied by the exhaust gas to the turbine outlet passage 210 should be increased, this may be achieved by widening (opening) the variable geometry mechanism 216. This will reduce flow constriction within the variable geometry mechanism and thereby allow a greater volumetric flow rate. Because shear stress is proportional to velocity, by increasing the volumetric flow rate, wall shear stress can be increased. Likewise, it is determined that the wall shear stress should be decreased, this may be achieved by narrowing (closing) the variable geometry mechanism 216 for corresponding reasons.

It will be appreciated that as well as operating conditions where it is necessary to increase swirl, there may be operating conditions of the exhaust system 200 where it may be determined that it is necessary to decrease swirl. For example, excessive swirl may cause wake zones to form in sensitive areas such as near the tip of the dosing module 220 or the NOx sensor 128.

It will be appreciated that adjustment of the variable geometry mechanism 216 and/or bypass control valve 214 will cause a change in the expansion ratio across the turbine wheel 208. Changing the expansion ratio across the turbine wheel 208 will result in a change in the exit dynamics of the turbine wheel, including, in particular, changes to the axial and angular components of velocity of the exhaust gas. By accurately modelling the behaviour of the exit dynamics and storing this in the controller 228 in the form of one or more formulas or datasets, it is possible to actuate the variable geometry mechanism 216 and/or bypass control valve 214 to one or more configurations that correspond to desired turbine wheel exit flow dynamics, and thereby enhance or mitigate the occurrence of one or more particular effects in the exhaust system.

In light of the above, it can be seen that the exhaust system 200 and method 300 of the present disclosure are operable to provide control over the flow characteristics downstream of the turbine wheel 208 using only the variable geometry mechanism 216 and/or the bypass control valve 214. In particular, the exhaust system 200 and method 300 do not require the use of any additional componentry other than that which is already provided as part of the turbine 204, and, in particular, avoids the use of additional baffles, fuel injectors, throttle valves, or the like. As such, the exhaust system 200 and method 300 represent a more compact, economical, and flexible way of influencing the flow of exhaust gas to achieve one or more desired flow characteristics to improve the performance of an aftertreatment device 218.

FIG. 9 shows a further embodiment of the method 300. In the first and second step 302, 304 the current property of the exhaust gas and the reference property of the exhaust gas are determined as described herein above. In the third step 306, the difference between the current and reference properties is determined. The determination of the difference between the current property and the reference property includes quantifying the difference between the current property and the reference property. Quantifying the difference may include, for example arriving at a scalar value representing the difference in magnitude between the current property and the reference property. The method 300 of FIG. 9 includes an additional step 307 in which the quantity of the difference is compared to an acceptable range or threshold. If the quantity of the difference lies within the acceptable range, the method returns to step 302 via decision branch 310. However, if the quantity of the difference falls outside of the acceptable range, the method proceeds via branch 312 to step 308 in which the variable geometry mechanism 216 and/or the bypass control valve 214 is adjusted.

Turning to FIG. 10, a flowchart is provided which schematically indicates a method 400 according to another embodiment of the disclosure. In this embodiment, the property of the exhaust gas that is determined is a temperature profile (i.e., a current temperature profile) of the exhaust gas.

At a first step 402, a current temperature profile of the exhaust gas is determined. The current temperature profile may be determined by directly measuring the temperature of exhaust gas at one or more positions (e.g., by using a temperature sensor, such as a thermocouple). In other embodiments, the current temperature profile may be determined based upon the measurement of another property, processing that measurement and inferring the temperature profile of the exhaust gas from the processing. For example, the current temperature profile of the exhaust gas may be determined and/or inferred based upon one or more of: a current NOx reduction amount across one or more catalytic converters, an inlet exhaust gas temperature of an aftertreatment device (e.g., a catalytic converter), an outlet exhaust gas temperature of the aftertreatment device, an exhaust gas temperature within the aftertreatment device, engine speed, engine load/throttle position, inlet manifold temperature, and an excess energy ratio (EER). The EER may be defined by the following equation:

$$EER = \frac{( {\dot{m}}_{exhaust} * {C}_{{p}_{air}} * {T}_{exhaust} )}{{\dot{m}}_{DEF} * {C}_{{p}_{water}} * ( 100 - 70 ) + ( {\dot{m}}_{DEF} * {h}_{{fg}_{water}} )}$$

### Where:

\dot{m}ₑₓₕₐᵤₛₜ is the mass flow rate of exhaust gas;
c_{p,air} is the specific heat capacity of air;
Tₑₓₕₐᵤₛₜ is the temperature of the exhaust gas in the turbine outlet;
\dot{m}_{DEF} is the mass flow rate of aftertreatment fluid (DEF) delivered to the turbine outlet by the dosing module;
c_{p,water} is the specific heat capacity of water; and
h_{fg,water} is the specific enthalpy of vaporisation of water.

As mentioned above, any of the above quantities (e.g., NOx reduction amount, inlet exhaust gas temperature etc.) may be measured, and the measured quantity or quantities be processed in a computational operation to infer the current temperature profile of the exhaust gas.

The current temperature profile may be a single temperature at a single spatial position (e.g., at a position along the flow axis, in the turbine outlet passage). The current temperature profile may comprise a plurality (e.g., a distribution) of temperatures across a single spatial position (e.g., a temperature profile taken normal to the flow axis). The current temperature profile may comprise an average of a plurality of different temperatures at a single spatial position. In other embodiments, the current temperature profile may comprise any of the options above taken across multiple spatial positions. For example, the current temperature profile may comprise a 3D distribution of temperatures along an extent of the flow axis. Spatial positions of particular interest may include the location of the dosing module and, if different, a primary impingement zone defined by the dosing module. A turbine outlet is a further spatial position which may be of particular interest.

Turning to step 404, a reference temperature profile of the exhaust gas is determined. It will be appreciated that the reference temperature profile preferably corresponds to the current temperature profile insofar as the type of temperature profile used (e.g., as set out above, a single temperature at a single spatial position, a plurality of temperatures across a single spatial position etc.).

Turning to step 406, a difference is determined between the current temperature profile and the reference temperature profile. Where the temperature profile is a single temperature at a single spatial position, the difference may be a subtraction equation. Where the temperature profile comprises a plurality of temperatures, the difference may be calculated on the basis of a statistical comparison. The difference may be based upon an area-averaged comparison. For example, the comparison may be an area-weighted comparison of exhaust gas temperature at a core of the flow and at a periphery of the flow (e.g. proximate a wall). The comparison thus preferably takes spatial variants into account (e.g. whether the temperature is taken at a core of the flow, or a periphery of the flow).

At step 408, the difference determined in step 406 is analysed to ascertain whether the difference falls outside of an acceptable range. The acceptable range may be, for example, a deviation from a preferred operating profile (e.g., within 10%, within 20%, or within 30% of an optimum operating profile). The acceptable range may be based upon the likelihood of reductant in the aftertreatment fluid not being sufficiently decomposed in the exhaust gas stream and/or excessive deposit build-ups. The acceptable range may be based upon a permissible level of NOx reduction by one or more catalytic converters. The acceptable range may be based upon an anticipated level of soot in the system. One example of an acceptable range is that a temperature at a periphery of the flow (e.g. proximate a wall) is at least around 550° K (280° C.). The acceptable range may thus incorporate a lower limit (i.e. minimum) temperature.

If the difference calculated at step 408 does not fall outside an acceptable range, the method returns to step 402 as indicated by line 410. There may be a delay before the method 400 restarts at step 402. In other embodiments, the method 400 may continue to cycle repeatedly without any delay. The method is preferably carried out periodically. The method may be carried out in a dynamic periodic manner. For example, a minimum target interval of use, such as 100 hours, may be set before a regeneration event. Put another way, a regeneration event may be carried out only after 100 hours of use.

The difference calculated at step 408 falling outside an acceptable range may be indicative of at least one of: a rate of decomposition of aftertreatment fluid droplets in the flow of exhaust gas being undesirably low and/or a risk of deposit build-up being undesirably high.

In response to the difference calculated at step 408 falling outside an acceptable range, as indicated by line 412, the method moves to step 414. At step 414 the variable geometry mechanism and/or bypass control valve is adjusted. Based upon the difference falling outside of an acceptable range, as calculated at step 408, the variable geometry mechanism and/or bypass control valve may be adjusted to increase a region of focussed heating by the exhaust gas flow. The region of focused heating may be the core of the exhaust gas flow (e.g., to aid NOx reduction and decrease aftertreatment device warm-up time). The region of focused heating may be proximate the walls/a periphery of the flow (to increase the temperature of the walls to reduce the risk of wall films and an associated risk of deposit build-up). For completeness, it will be appreciated that increasing the temperature of the core of the exhaust gas flow may also realise a heating effect proximate the walls of the conduit. Similarly, increasing the temperature of the exhaust gas proximate the walls may also provide a corresponding increased temperature at the core of the exhaust gas flow. However, method 400 sets out to prioritise one of these two options based upon the current temperature profile. It may also be desirable to avoid focussing heat at the periphery of the flow due to the heat being lost to atmosphere via the walls (and so reducing the rate of decomposition of reductant in the exhaust gas flow).

The core of the exhaust gas flow may refer to a radial cross-section of the flow which extends by up to around 30%, up to around 50%, or up to around 70% of a radial extent from the flow axis. The exhaust gas flow proximate the walls may refer to up to an outmost 5%, 10%, or 25% of a radial cross-section of the exhaust gas flow. A boundary layer of the exhaust gas may correspond to exhaust gas flow proximate the walls. Fully developed flow outside of (e.g., beyond) the boundary layer may correspond to the core exhaust gas flow.

Turning to FIGS. 11 to 13, plots showing the results of computational fluid dynamics (CFD) simulations are provided. Each of FIGS. 11 to 13 show the temperature profile at the turbine wheel nut plane (e.g., at an axial position between the exducer and an outermost end of the nut (e.g., at an axial position partway along the nut]) for three different configurations of wastegate valve position (the wastegate valve being an example of bypass control valve) of the turbine shown in FIGS. 2 to 6, and exhaust system shown in FIG. 7. For completeness, the engine operating point (e.g., engine load and RPM/torque) is the same for each simulation.

FIG. 11 shows the temperature profile when the wastegate valve is closed, FIG. 12 when the wastegate valve is 50% open, and FIG. 13 when the wastegate valve is 100% open. As will be appreciated by comparing FIGS. 11 to 13, it can be discerned that the position of the wastegate valve (e.g., the wastegate valve configuration) has an effect on the temperature profile of the exhaust gas. In particular, by generally comparing FIGS. 11 through to 13 it will be appreciated that the greater extent to which the wastegate valve is opened, the generally greater the temperature is across the temperature profile of the exhaust gas. This is owing, at least in part, to the fact that the (bypassed/wastegate) exhaust gases have not been expanded across the turbine wheel and are therefore of a comparatively higher energy than exhaust gases which have been expanded across the turbine wheel. Furthermore, increasing the extent to which the wastegate valve is opened generally increases the exhaust gas temperature at the core of the flow. In particular, for arrangements which have a generally tangential wastegate passage (see wastegate passage 136 in FIG. 6), opening the wastegate focuses a heating at a periphery of the flow (e.g. proximate a wall). This, in turn, increases the wall temperature of the surrounding components (e.g. the turbine). For arrangements which have a non-tangential wastegate passage, opening the wastegate focusses a heating at a core of the flow. This may be used to increase the temperature of downstream components (e.g. an aftertreatment device). A variable geometry mechanism may be adjusted (e.g. opened) to increase the exhaust temperature at both the periphery and the core of the flow. For completeness, the feature labelled 420 in FIG. 11 is the region of the computational domain representing the turbine wheel hub, downstream of the turbine wheel blades, where there may be a nut to secure the turbine wheel to the shaft (or a generally nut-shaped profile, integral to the turbine wheel, to assist assembly of an integral turbine and shaft assembly with the compressor). The temperature profile of this region is not predicted by fluid dynamics computation, hence represents a fluid/solid boundary of the computational domain and not a region of very high temperature.

Although FIGS. 11 to 13 are described in the context of a wastegate valve opening position, for a fixed geometry turbine, it will be appreciated that similar effects can be obtained by varying the variable geometry mechanism of a fixed geometry turbine. For a variable geometry mechanism, opening the mechanism reduces the work done/extracted by the turbine, and will generally increase exhaust gas temperatures. This effect is compounded if the exhaust gas is bypassed by a bypass valve such as a wastegate valve. It will also be appreciated that similar effects can be obtained by varying the wastegate valve opening position of a variable geometry turbine. FIGS. 11 to 13 thus indicate that selective variation of the wastegate valve position can be used to increase the temperature in, or at, a region of focused heating, in response to step 408 identifying a particular operational risk, to reduce the risk. Specifically, adjusting a variable geometry mechanism and/or bypass control valve can be used to alter the temperature profile of exhaust gas in an exhaust system. Also of note, whilst FIGS. 11 to 13 show results for an exhaust system comprising a wastegate valve, other varieties of bypass control valve could otherwise be used to obtain similar results.

Turning now to FIGS. 14 to 16, three further temperature profiles are provided. FIGS. 14 to 16 show temperature profiles at an outlet of the turbine (e.g., the turbine of FIGS. 2 to 6 or the exhaust system of FIG. 7) when a corresponding wastegate valve is in three different configurations. FIG. 14 shows the temperature profile with the wastegate valve in a 100% closed configuration, FIG. 15 shows the temperature profile with the wastegate valve in a 50% open configuration, and FIG. 16 shows the temperature profile with the wastegate valve in a 100% open configuration. As will be appreciated from FIGS. 14 to 16, increasing the extent to which the wastegate valve is opened generally increases the temperature of exhaust gas across the turbine outlet passage. Furthermore, as will be appreciated from FIGS. 15 and 16, the temperature increases are particularly noticeable proximate the walls/at a periphery of the flow (e.g., see annotations 430 and 432). For completeness, the location at which the temperature profiles shown in FIGS. 14 to 16 are taken correspond to the second end 192 of the connection adaptor 110 shown in FIG. 4. This may be more generally described as an outlet of the turbine.

Turning to FIGS. 17 to 19, three plots are provided showing the temperature profile at walls of the diffuser (e.g., a diverging portion of the turbine outlet passage for the embodiment shown in FIGS. 2 to 6) when the wastegate valve is in three different operating configurations. FIG. 17 shows the temperature profile when the wastegate valve is in a 100% closed configuration. FIG. 18 when the wastegate valve is in a 50% open configuration, and FIG. 19, when the wastegate valve is in a 100% open configuration.

As will be appreciated by comparing FIGS. 17 to 19, and as mentioned above, it is generally the case that opening the wastegate valve to any extent, and diverting exhaust gases around the turbine wheel, increases the temperature downstream of the turbine wheel. In particular, FIGS. 18 and 19 show two regions 434, 436 of very high temperature, those regions not being present in FIG. 17.

FIGS. 17 to 19 illustrate that manipulation of the wastegate valve can be used to alter the temperature profile at the turbine outlet. Taking FIGS. 18 and 19 as an example, if it were the case that regions 434, 436 were identified as being liable to a risk of deposit build-up, by opening the wastegate to the 50% open or 100% open configuration, shown in FIGS. 18 and 19, any wall film (an indicator of deposit built-up), could be burned off before the deposits develop.

In connection with the above description, relating to the temperature profile, it will be appreciated that the temperature profile, which may be a turbine outlet temperature profile, may need to be balanced, or managed, alongside engine demands at a given operational point.

Adjusting a variable geometry mechanism and/or bypass control valve can thus be used to alter the temperature profile of exhaust gas in an exhaust system. The adjustment may seek to increase the temperature of exhaust gas at a core of the flow, or a temperature of exhaust gas at a periphery of the flow. The adjustment may seek to increase the temperature of exhaust gas at a location of the dosing module or another position downstream of the dosing module. Said locations may constitute regions of focused heating, depending upon the operational parameters in question.

Turning to FIG. 20, a flowchart is provided which schematically indicates a method 500 according to another embodiment of the disclosure. In this embodiment, the property of the exhaust gas that is determined is a velocity profile (i.e., a current velocity profile) of the exhaust gas. For completeness, and as will be described in detail below, it will be appreciated that the velocity profile may be used to determine, or at least partly determine, velocity, swirl, and shear stress exerted by the exhaust gas flow.

At a first step 502, a current velocity profile of the exhaust gas is determined. The current velocity profile may be determined based upon the measurement of another property, processing that measurement and inferring the velocity profile of the exhaust gas from the processing. For example, the current velocity profile of the exhaust gas may be determined based upon one or more of: a pressure ratio across the turbine, a turbine inlet pressure, a turbine outlet pressure, turbine inlet temperature, turbine rotational speed and an engine mass flow rate.

The current velocity profile may be the velocity at a single spatial position (e.g., at a position along the flow axis, in the turbine outlet passage). The current velocity profile may comprise a plurality (e.g., a distribution) of velocities across a single spatial position (e.g., a velocity profile taken normal to the flow axis). The current velocity profile may comprise an average velocity at a single spatial position. In other embodiments, the current velocity profile may comprise any of the options above taken across multiple spatial positions. For example, the current velocity profile may comprise a 3D distribution of velocity across along an extent of the flow axis. Spatial positions of particular interest may include the location of the dosing module and, if different, a primary impingement zone defined by the dosing module.

Turning to step 504, a reference velocity profile of the exhaust gas is determined. It will be appreciated that the reference velocity profile preferably corresponds to the current velocity profile insofar as the type of velocity profile used (e.g., as set out above, a velocity at a single spatial position, a distribution of velocities across a single spatial position etc.).

Turning to step 506, a difference is determined between the current velocity profile and the reference velocity profile. Where the velocity profile is a velocity at a single spatial position, the difference may be a subtraction equation. Where the velocity profile comprises a distribution of velocities, the difference may be calculated on the basis of a statistical comparison. For example, the comparison may be an area-weighted comparison of the distribution of velocities. The comparison thus preferably takes spatial variants into account (e.g. the position at which the velocity is taken).

At step 508, the difference determined in step 506 is analysed to ascertain whether the difference falls outside of an acceptable range. The acceptable range may be, for example, a deviation from a preferred operating profile (e.g., within 10%, within 20%, or within 30% of an optimum operating profile). The acceptable range may be based upon the likelihood of excessive deposit build-ups.

If the difference calculated at step 508 does not fall outside an acceptable range, the method returns to step 502 as indicated by line 510. There may be a delay before the method 500 restarts at step 502. In other embodiments, the method 500 may continue to cycle repeatedly without any delay. The method is preferably carried out periodically. The method may be carried out in a dynamic periodic manner. For example, a minimum target interval of use, such as 100 hours, may be set before a regeneration event. Put another way, a regeneration event may be carried out only after 100 hours of use.

The difference calculated at step 508 falling outside an acceptable range may be indicative of a risk of deposit build-up. This may be by way of aftertreatment fluid not being sufficiently decomposed by the exhaust gas and/or regions of recirculation of exhaust gas, particularly proximate the dosing module.

In response to the difference calculated at step 508 falling outside an acceptable range, as indicated by line 512, the method moves to step 514. At step 514 the variable geometry mechanism and/or bypass control valve is adjusted. Based upon the difference falling outside of an acceptable range, as calculated at step 508, the variable geometry mechanism and/or bypass control valve may be adjusted to adjust the velocity profile in a particular region. The region may be a location of the dosing module, where comparatively low velocities may otherwise risk flow separation and the suspension of aftertreatment fluid in the exhaust gas flow. The region may be another region having an elevated deposit build-up risk, such as a bend in the turbine outlet passage (or any other location where aftertreatment fluid may be liable to impinge upon a wall and risk the build-up of deposits). The velocity of exhaust gas may be comparatively low at an inside of the bend, which may increase the risk of aftertreatment fluid being suspended (and, in turn, increase the risk of deposit build-up). The region may therefore be a bend, specifically an inside thereof. The region may be an impingement region (e.g. generally opposite a dosing module). The region may be a joint between components, such as a bellows or flexible pipe (e.g. having a corrugated or pleated surface). The region may be any region having a step change transition (e.g. not a smooth transition) where eddy currents are prone to form. The region may be an expanding joint. The region may be one or more of the aforementioned regions (e.g. multiple different regions may be targeted). For completeness, it will be appreciated that adjusting the velocity profile of the exhaust gas flow in one region may cause a corresponding effect on the velocity profile in another region. However, method 500 sets out to prioritise adjusting the velocity profile in a particular region in response to the current velocity profile.

The velocity profile may be adjusted to increase (or decrease) the velocity of the exhaust gas, to increase (or decrease) wall shear and to increase (or decrease) convective heat transfer for a given engine operating condition. For example, where step 508 indicates a risk of deposit build-up proximate the dosing module, the variable geometry mechanism and/or bypass control valve may be adjusted to increase the velocity of exhaust gas proximate the dosing module. This, in turn, reduces, or eliminates, a region of separation where the boundary layer of exhaust gas may be liable to separate from the wall (or have already separated) and create a recirculation zone in which aftertreatment fluid is suspended. The suspended aftertreatment fluid risks damage to an outlet of the dosing module and deposit build-up. In another example, where a need for high shear stress exists, e.g., at a region liable for deposit build-up, such as a bend, the variable geometry mechanism and/or bypass control valve may be adjusted to increase the velocity of exhaust gas at, or just upstream of, that region. Swirl, and shear stress exerted by the exhaust gas flow, may also be increased as a result.

Turning to FIGS. 21 to 23, plots showing the results of computational fluid dynamics (CFD) simulations are provided. Each of FIGS. 21 to 23 show the velocity profile at the turbine wheel nut plane (e.g., at a downstream end of the turbine wheel) for three different configurations of wastegate valve position (the wastegate valve being an example of bypass control valve). For completeness, the engine operating point (e.g., engine speed and load or engine speed and torque) is the same across each simulation. The plots of FIGS. 21 to 23 correspond to the equivalent temperature plots of FIGS. 11 to 13 described earlier in this document.

FIG. 21 shows the temperature profile when the wastegate valve is closed, FIG. 22 when the wastegate valve is 50% open, and FIG. 23 when the wastegate valve is 100% open. As will be appreciated by comparing FIGS. 21 to 23, it can be discerned that the position of the wastegate valve has an effect on the velocity profile of the exhaust gas. In particular, by generally comparing FIGS. 21 through to 23 it will be appreciated that the greater the extent to which the wastegate valve is opened, the higher the velocity is across the velocity profile of the exhaust gas. This is owing, at least in part, to the fact that the (bypassed/wastegate) exhaust gases have not been expanded across the turbine wheel and are therefore of a comparatively higher energy than exhaust gases which have been expanded across the turbine wheel. FIGS. 21 to 23 indicate the variation of the wastegate valve configuration affects both a core of the exhaust gas flow and a boundary layer of the flow at the wall (e.g., a periphery of the flow, proximate the wall). A lower velocity wall boundary layer (labelled 522) visible in FIG. 21 is reduced or eliminated when the wastegate valve is opened (e.g., as shown in FIGS. 22 and 23). For completeness, at a given Engine Operating Point, when a wastegate valve is opened, less exhaust gas is expanded across the turbine. A local reduction of exhaust gas velocity is thus experienced, downstream of the turbine wheel but before the wastegate passage outlet (e.g. where the bypass exhaust gas rejoins the turbine bulk flow). The velocity of the exhaust gas flow then increases again, at and downstream of the wastegate passage outlet, owing to the introduction of the high velocity bypassed exhaust gas.

For completeness, the feature labelled 520 in FIG. 21 represents a fluid/solid boundary of the computational domain and not a region of very high temperature. Although FIGS. 21 to 23 are described in the context of a wastegate valve opening position, for a fixed geometry turbine, it will be appreciated that similar effects can be obtained by varying the variable geometry mechanism of a fixed geometry turbine. In particular, opening the variable geometry mechanism reduces the constriction across the turbine, allowing for a greater volumetric flow rate of exhaust gas (and hence a higher velocity of exhaust gas, and associated increased shear stress). It will also be appreciated that similar effects can be obtained by varying the wastegate valve opening position of a variable geometry turbine. FIGS. 21 to 23 thus indicate that selective adjustment of the wastegate valve position can be used to adjust the velocity profile of the exhaust gas.

Turning now to FIGS. 24 to 26, three further velocity profiles are provided. FIGS. 24 to 26 show velocity profiles at an outlet of the turbine when a corresponding wastegate valve is in three different configurations. FIG. 24 shows the velocity profile with the wastegate valve in a 100% closed configuration, FIG. 25 shows the velocity profile with the wastegate valve in a 50% open configuration, and FIG. 26 shows the velocity profile with the wastegate valve in a 100% open configuration. FIGS. 24 to 26 generally correspond to FIGS. 11 to 13, save for the velocity profile, rather than a temperature profile, being shown. Also of note, FIGS. 24 to 26 show the contours of tangential/circumferential velocity of exhaust gas in an axial plane (i.e., a swirl velocity).

As will be appreciated from FIGS. 24 to 26, increasing the extent to which the wastegate valve is opened generally increases the swirl of exhaust gas across the turbine outlet passage, particularly at the boundary layer of the flow (e.g., the periphery of the flow, proximate the wall). Doing so increases the shear force exerted by the exhaust gas on the wall, and the convective heat transfer from the exhaust gas flow to the wall.

Turning to FIGS. 27 to 35, plots showing the results of computational fluid dynamics (CFD) simulations are provided. FIGS. 27 to 35 show the risk of deposit build-up in three different embodiments of exhaust system for three different configurations of wastegate valve position (the wastegate valve being an example of a bypass control valve). FIGS. 27 to 29 relate to a first embodiment, FIGS. 30 to 32 relate to a second embodiment, and FIGS. 33 to 35 relate to a third embodiment. Each of the embodiments differs in the position of the dosing module and/or layout of the turbine outlet passage. FIGS. 27, 30 and 33 show the results for a wastegate valve being in a 100% closed configuration, FIGS. 28, 31 and 34 show the results for a wastegate valve being in a 50% open configuration, and FIGS. 29, 32 and 35 show the results for a wastegate valve being in a 100% open configuration (which corresponds to a 7.5° open position in the illustrated embodiments).

It will be appreciated that even partially opening the wastegate valve has the effect of moving a region of deposit build-up risk downstream. Furthermore, across the board, an observed risk of deposit build-up is reduced by around 20% when the wastegate valve is 100% open (i.e., FIGS. 29, 32, 35) in comparison to the wastegate valve being 100% closed (i.e., FIGS. 27, 30, 33).

FIGS. 36 to 44 show corresponding embodiments and wastegate valve configurations to those of FIGS. 27 to 35 described above, but with a magnitude of wall shear stress indicated. Each of FIGS. 38, 41 and 44, which show embodiments with the wastegate valve in a 100% open configuration, illustrate a significantly larger region of high shear stress (e.g., shear zone) in comparison to FIGS. 36, 37, 39, 40 and 42, 43 respectively. The shear zone is increased both in size (e.g., extent) and intensity when the wastegate valve is in a 100% open configuration. This increased shear zone advantageously promotes the spreading of a wall film (e.g., to zones of higher wall temperature) and stripping the wall film back into the exhaust gas stream. Both reduce the likelihood of deposit build-up.

FIGS. 45 to 50 are velocity plots, including streamlines, showing results from CFD simulations carried out on an embodiments of exhaust system at three different engine operating points (EOP's). FIGS. 45 and 46 relate to a first EOP, FIGS. 47 and 48 relate to a second EOP, and FIGS. 49 and 50 to a third EOP. Each of FIGS. 46, 48 and 50 are magnified views of a region of interest of each of FIGS. 45, 47 and 49 respectively: a location of the dosing module, labelled 550, 552, 554.

Taking FIGS. 45 and 46 as an example, a recirculation region 551 is present proximate the location 550 of the dosing module. The recirculation region 551 is caused by the exhaust gas flow having separated from walls of the turbine outlet passage. Flow separation is also problematic due to the dosing module, which is mounted just downstream of a divergence, or ‘hump’ (e.g., an undercut) in the turbine outlet passage. The recirculation region 551 risks aftertreatment fluid being suspended in the exhaust gas flow without being decomposed and/or transported downstream, and risks deposit build-up at the outlet of the dosing module. This, in turn, increases the risk of deposit build-up in the region, and particularly at the outlet of the dosing module. The separation of exhaust gas flow from walls of the turbine outlet passage is caused by low velocities in this region, and results in a lack of uniformity of the velocity profile in the region. FIGS. 45 and 46 thus indicate the presence of the recirculation region 551 at this EOP, and that it is desirable to be able to reduce or eliminate the recirculation region 551 at the EOP by adjusting the bypass control valve and/or variable geometry mechanism.

In contrast to FIGS. 45 and 46, FIGS. 47 and 48 show a relatively uniform directionality of the streamlines of the exhaust gas proximate the location of the dosing module 552 e.g., in a region 553. FIGS. 47 and 48 also show the region 553 of exhaust gas, proximate an effective outlet of the dosing module (e.g., at a periphery of the flow, proximate the walls), indicating exhaust gas having a comparatively higher velocity (in comparison to, for example, region 551 of FIG. 46). The improved uniformity of directionality of the exhaust gas, and comparatively higher velocity, in region 553 proximate the outlet of the dosing module advantageously reduces the risk of deposit build-up at the outlet (e.g., tip) of the dosing module. Described another way, the higher velocity region 553 of exhaust gas at the periphery of the exhaust gas flow, proximate the location of the dosing module outlet, can be used to clean the outlet of the dosing module. This may be at least in part due to the exhaust gas exerting comparatively higher shear forces at (e.g., upon) the outlet of the dosing module. Similarly, the less chaotic/random directionality of streamlines reduces the risk of the aftertreatment fluid being suspended within the exhaust gas.

For completeness, FIGS. 49 and 50 also show streamlines in region 555 remaining attached to the wall (i.e., not separating), providing a desirable flow field.

FIGS. 45 to 50 thus show why it is desirable to be able to modify the velocity profile of the exhaust gas flow e.g., by adjustment (e.g., modulation) of a wastegate valve and/or variable geometry mechanism.

Adjusting (e.g., modulating) at least one of a variable geometry mechanism and a bypass control valve can be used to alter the velocity profile at the location of the dosing module (e.g., in response to a risk of deposit build-up, e.g., at the location of the dosing module, falling outside of an acceptable range). Adjusting (e.g., modulating) at least one of a variable geometry mechanism and a bypass control valve can therefore be used to reduce the risk of deposit build-up at a location of the dosing module, specifically at an outlet of the dosing module (e.g., at a periphery of the flow). Adjusting at least one of the variable geometry mechanism and the bypass control valve can also be used to alter the velocity profile of exhaust gas at a location downstream of the dosing module (e.g., a region of increased deposit build-up, such as a bend in the pipe/conduit).

The location of the dosing module may be described as a centroid of an outlet of the dosing module and/or a centroid of an opening of a dosing module mount.

FIG. 51 discloses a further embodiment of a method 600 according to the present disclosure. In a first step 602 the method 600 comprises, determining a current property of the exhaust gas at a position downstream of the turbine wheel. The current property may be, in particular, a current NOx reduction amount across one the aftertreatment device 218. The current NOx reduction amount across the aftertreatment device 218 may be measured, calculated or inferred from the difference between a measurement of the NOx concentration in the turbine outlet 210 taken by the turbine outlet sensor 224 and a measurement of the NOx concentration at the outlet of the aftertreatment device 218 taken by the aftertreatment device outlet sensor 226. The NOx reduction amount across the aftertreatment device 218 is indicative of the relative proportion of the NOx entering the aftertreatment device 218 that is reduced by the aftertreatment device 218 before exiting the aftertreatment device 218.

In the second step 604, the reference property is determined. In the example above, the reference property may be a reference NOx reduction amount across the aftertreatment device. In the third step 606, a difference between the current property and the reference property is determined and quantified. In particular, the current NOx reduction amount across the aftertreatment device 218 is compared to a reference reduction amount across the aftertreatment device 218 and the difference therebetween is quantified.

In the fourth step 607, the existence of an operating condition of the exhaust system in which an insufficient swirl angle of the exhaust gas in the turbine outlet passage is identified. The operating condition of the exhaust system in which an insufficient swirl angle of the exhaust gas in the turbine outlet passage exists may be referred to as the ‘low-swirl’ operating condition. The low-swirl operating condition is identified by comparing a quantity of the difference to an acceptable range or threshold. In particular, the quantity of the difference between the current NOx reduction amount across the aftertreatment device 218 to the reference NOx reduction amount across the aftertreatment device 218 is compared to an acceptable range or threshold. The acceptable range or threshold may be set so as to identify that the low-swirl operating condition exits when the current NOx reduction amount across the aftertreatment device 218 drops below, for example, around 98%, around 95%, or around 90%. When the NOx reduction across the aftertreatment device 218 reduces below such thresholds, this is indicative of a state in which the aftertreatment fluid delivered by the dosing module 220 has not fully decomposed before it reaches the aftertreatment device 218, and therefore the products of decomposition (for urea, isocyanic acid and ammonia) are not available in sufficient quantities within the aftertreatment device 218 to reduce the NOx in the exhaust gas. The lack of decomposition may indicate that the swirling momentum in the exhaust gas downstream of the turbine wheel 208 is insufficient to provide adequate mixing of the exhaust gas and the aftertreatment fluid to promote decomposition. Therefore, it may be beneficial to increase the amount of swirling momentum in the exhaust gas.

In other embodiments, as illustrated in the embodiment of FIG. 51, the current property may be the current operating efficiency of the turbine 204. The current operating efficiency may be determined based upon any suitable parameter or group of parameters. In particular, the current operating efficiency may be determined based upon the turbine inlet temperature, the turbine inlet pressure, the turbine outlet temperature and/or the turbine outlet pressure. The turbine outlet temperature may be measured and/or inferred based upon one or more of the turbine inlet temperature, the turbine inlet pressure, the turbine outlet pressure, the compressor power, the engine air mass flow, and the engine air to fuel ratio. The compressor power may be measured and/or inferred based upon the compressor inlet temperature, the compressor outlet temperature, the compressor inlet pressure and/or the compressor outlet pressure.

In such embodiments, the reference property may also be an operating efficiency of the turbine 204. The low-swirl operating condition may be identified when the current operating efficiency is above a particular range or threshold. The acceptable range or threshold may be set so as to identify that the low-swirl operating condition exits when the turbine efficiency is at least around 70%, around 80%, around 90% or around 95% of the maximum efficiency of the turbine. The maximum efficiency of the turbine may be the efficiency of the turbine 204 when it is operating at its most efficient operating condition, as determined by simulations or testing. When the current operating efficiency of the turbine 204 is high, this may indicate that the flow of exhaust gas in the turbine outlet 210 is has a large axial component of velocity in comparison to its angular velocity, and therefore the swirl angle is low. Low swirl angle may reduce the amount of mixing taking place between the aftertreatment fluid and the exhaust gas, resulting in poorer decomposition of the aftertreatment fluid, and lower NOx conversion in the aftertreatment device 218.

In some embodiments, a difference based upon NOx reduction and a difference based upon turbine efficiency may be used in conjunction to identify the existence of a low-swirl operating condition. Regardless of the current property used to identify the low-swirl operating condition, if the low-swirl operating condition does not exist, the method 600 returns to the first step via branch 310. If the low-swirl operating condition does exist, the method 600 moves via branch 312 to step 308, in which the controller 228 outputs a command to the variable geometry mechanism 216 and/or the bypass control valve 212 to adjust the current operating configuration of the variable geometry mechanism 216 and/or the bypass control valve 212. In the case of the variable geometry mechanism 216, this may include moving the variable geometry mechanism to or towards a configuration (e.g., position of the mechanism or the like) corresponding to a maximum swirl angle of exhaust gas leaving the turbine wheel 208. The configuration corresponding to a maximum swirl angle of exhaust gas may be determined during the design and development of the exhaust gas system, for example using computer simulations such as computational fluid dynamics and/or by testing in an engine test cell. In the case of the bypass control valve, this may include moving the bypass control valve 214 to or towards a configuration corresponding to a maximum swirl angle of the exhaust gas in the turbine outlet passage 210. This may be determined during the design and development of the exhaust gas system, for example using computer simulations such as computational fluid dynamics and/or by testing in an engine test cell. When the turbine 204 is the same or has the same construction as the turbine described above in relation to FIGS. 2 to 6, in which the bypass flow enters the turbine outlet in a tangential direction, the configuration corresponding to a maximum swirl angle of the exhaust gas in the turbine outlet passage 210 may be a configuration corresponding to a maximum flow rate through the bypass valve.

FIG. 52 shows a graph of inlet gap size of a variable geometry mechanism 216 to swirl angle in the turbine outlet passage 210. The variable geometry mechanism is, in particular, a sliding-nozzle type variable geometry mechanism, however similar principles will apply to swing-vane type variable geometry mechanisms. FIG. 52 shows three plots of swirl angle taken at different expansion ratios (ER) of the turbine 204. The expansion ratio of the turbine, sometimes called pressure ratio, is the relative proportion of the pressure of the exhaust gas upstream of the turbine wheel 208 (i.e., in the turbine inlet 206) to the pressure of the exhaust gas downstream of the turbine wheel 208 (i.e., in the turbine outlet 210). As can be seen in the figure, when the variable geometry opening is large, the swirl angle is low, and when the variable geometry opening is small, the swirl angle is high. The swirl angle peaks at an opening distance of around 4 mm. The graph of FIG. 52 may be stored as a formula or dataset in the controller 228 to enable the configuration of the variable geometry mechanism 216 to be adjusted to achieve a desired swirl angle.

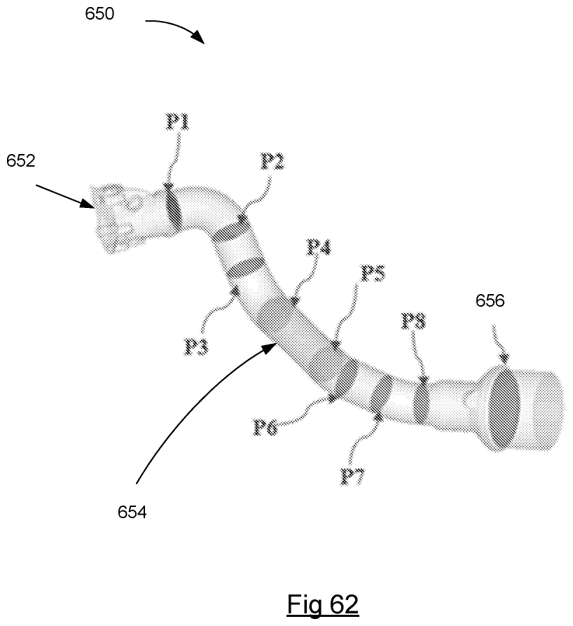

FIG. 53 shows a computational fluid dynamics plot of the turbine of FIGS. 2 to 6 at various opening positions of the wastegate. In the first column (FIGS. 53 to 55), the wastegate is closed and the turbine is operating at high turbine efficiency. It can be seen that the flow in the turbine outlet has a large axial component of velocity compared to its angular component of velocity. This may indicate that insufficient mixing of aftertreatment fluid and exhaust gas is taking place, leading to reduced NOx conversion in the aftertreatment device 218. In the second column (FIGS. 56 to 58), the wastegate is partially open. As discussed above in relation to FIG. 2 to 6, the wastegate passage outlet is configured to introduce wastegate flow in a direction that is generally tangential to the turbine axis in the direction of swirl. By partially opening the wastegate, the wastegate flow provides momentum to the exhaust gas in the tangential direction, increasing the angular component of velocity and thereby increasing swirl. In the final column (FIGS. 59 to 61), the wastegate is fully open. It can be seen that by fully opening the wastegate, the swirl of the exhaust gas is significantly increased.

Although the wastegate arrangement shown in FIGS. 53 to 61 introduces flow in a tangential direction and thereby directly influences the angular component of velocity in the turbine outlet, it will be appreciated that it is possible to influence the angular component of velocity in the turbine outlet passage with non-tangential bypass designs. In particular, opening the wastegate causes a decrease in the inlet pressure and temperature of the turbine, thus reducing the expansion ratio of the turbine. Reducing the expansion ratio causes a change in the dynamics of the exhaust gas leaving the turbine wheel, which will result in changes of axial and angular velocity. Therefore, in a wastegated turbine lacking a tangential wastegate passage outlet, it is still possible to adjust the swirl angle of the exhaust gas in the turbine passage outlet by adjusting the expansion ratio of the turbine using the wastegate.

FIG. 62 shows a three-dimensional view of an exhaust gas system 650 comprising a turbine 652, a downpipe 654, and an SCR catalyst 656. The figure further shows the positions of a number of planes P1 to P8 positioned at various points along the downpipe 654 before the SCR catalyst 656.

FIG. 63 shows a graph of the relative amount of aftertreatment fluid decomposition at each of the planes P1 to P8 under three operating configurations of the wastegate, namely: closed, 50% open, and fully open. It can be seen that for planes P2 onwards, the amount of reductant decomposition occurring before that plane increases with increased wastegate opening. As explained above, increased wastegate opening increases the swirl of the exhaust gas in the downpipe 654, which improves mixing and leads to more heat transfer into the aftertreatment fluid. In addition, because the wastegate flow has not passed through the turbine wheel, the wastegate flow is hot and therefore also provides heat to the aftertreatment fluid. Increasing heat transfer to the aftertreatment fluid increases the energy available to cause decomposition of the urea component of the aftertreatment fluid into the reductants isocyanic acid and ammonia that are required to support NOx reduction in the SCR catalyst 656. Increasing the amount of mixing and heat transfer to the aftertreatment fluid is particularly advantageous at low operating temperatures where less heat is available and where it would normally take longer for decomposition to occur.

FIG. 64 shows a graph of the relative uniformity index (UI) of the exhaust gas at each of the planes P1 to P8 under the three opening configurations of the wastegate. The uniformity index is a measure of how evenly distributed the aftertreatment fluid and/or decomposed reductants (isocyanic acid and ammonia) is distributed throughout the exhaust gas. Higher uniformity index indicates more even distribution and promotes more efficient operation of the SCR catalyst 656. As can be seen in the figure, for planes P2 onwards, increased wastegate opening increases the swirl of the exhaust gas in the downpipe 654, leading to improved mixing and therefore improved uniformity index. Increasing uniformity index especially facilitates improvement in SCR reduction performance at higher operating temperatures. Moreover, improving uniformity index may enable the downpipe 654 to be made shorter, thus leading to space claim savings in the engine compartment.

FIG. 65 shows a graph of the relative amount of aftertreatment fluid decomposition at each of the planes P1 to P8 at three different swirl angles in the turbine outlet, namely 18.5°, 31.0°, and 36.4°. Again, it can be seen that for planes P2 onwards, increasing the swirl angle increases the amount of decomposition of the aftertreatment fluid. As explained above in relation to FIGS. 52 and 53, swirl angle can be adjusted based upon operation of a variable geometry mechanism and/or a bypass control valve.

It will be appreciated that using the techniques described above, it is possible to modulate the swirl of the exhaust gas in the turbine outlet to maintain optimum mixing across a range of engine operating conditions. Moreover, this can be achieved without the need for additional mixing elements or the like. Typically, such mixing elements are only designed for the ‘worst case’ operating condition, to ensure that sufficient mixing is provided across all engine operating conditions. However, this incurs additional back pressure across the operating range of the engine. Such additional backpressure can be avoided using the techniques described herein, thus leading to improved system efficiency.

FIG. 66 discloses a further embodiment of a method 700 according to the present disclosure. In a first step 702 the method 700 comprises, determining a current property of the exhaust gas at a position downstream of the turbine wheel. The current property may be, in particular, an excess energy ratio (EER). The EER is, in general terms, the ratio of the total energy available in the exhaust gas to the energy required to completely decompose the aftertreatment fluid entrained by the exhaust gas. The EER may be expressed as the thermal energy of the exhaust gas divided by the sum of: the heating energy and vaporisation energy of water, and the heating energy and vaporisation energy of urea. This may be expressed by the formula previously set out herein above. Accordingly, the EER can be calculated or inferred from the temperature of the exhaust gas in the turbine outlet, the mass flow rate of the engine, and the mass flow rate of aftertreatment fluid, all of which may be sensed by sensors in the exhaust gas system and provided to the controller 228.

In the second step 704, the reference property is determined. The reference property may be an excess energy ratio (EER). In the third step 706, a difference between the current property and the reference property is determined and quantified. In particular, the current EER may be compared to a target EER and a difference therebetween quantified.

In the fourth step 707, the existence of an operating condition of the exhaust system in which an insufficient shear stress is applied to the wall of the exhaust system by the exhaust gas at a particular location is identified. The operating condition of the exhaust system in which an insufficient shear stress is applied to the wall of the exhaust system by the exhaust gas at a particular location exists may be referred to as the ‘low-shear’ operating condition. The low-shear operating condition is identified by comparing a quantity of the difference to an acceptable range or threshold. In particular, the quantity of the difference between the current EER to the reference EER is compared to an acceptable range or threshold. Typically, EERs of around 30 are considered to correspond to high shear conditions in the turbine outlet passage. The acceptable range or threshold may be set so as to identify that the low-shear operating condition exits when the current EER drops below, for example, around 10, around 15, or around 20. The lower the EER, the lower the shearing forces on the walls of the turbine outlet, and the greater the chance of urea deposits solidifying. In some operating conditions of the exhaust system it is desirable to increase the shearing forces in the turbine outlet. Increasing the shearing forces improves heat transfer to any aftertreatment fluid that has impinged upon the walls of the turbine outlet passage (or downpipe), thus promoting evaporation of impinged aftertreatment fluid. In addition, increasing shear encourages molecules of aftertreatment fluid on the free surface of any impinged fluid to be stripped from the wall and re-entrained in the exhaust gas. Finally, increased shear acts to spread out any impinged aftertreatment fluid, providing a greater surface area for heat transfer. Accordingly, increased shear can reduce the chance of deposit solidification in the turbine outlet and/or downpipe.

In other embodiments, as shown in FIG. 58, the current property may be the current operating efficiency of the turbine 204. The current operating efficiency may be determined based upon any suitable parameter or group of parameters, such as those previously described herein above. In such embodiments, the reference property may also be an operating efficiency of the turbine 204. The low-shear operating condition may be identified when the current operating efficiency is above a particular range or threshold. The acceptable range or threshold may be set so as to identify that the low-swirl operating condition exits when the turbine efficiency is at least around 70%, around 80%, around 90% or around 95% of the maximum efficiency of the turbine. The maximum efficiency of the turbine may be the efficiency of the turbine 204 when it is operating at its most efficient operating condition, as determined by simulations or testing. When the current operating efficiency of the turbine 204 is high, this may indicate that the flow of exhaust gas in the turbine outlet 210 is has a large axial component of velocity in comparison to its angular velocity and therefore the swirl angle is low. Increasing the swirl angle increases the distance that the individual particles of exhaust must travel as they progress through the turbine outlet passage/downpipe, and therefore increases the shearing action on the walls. Moreover, although the static component of the turbine outlet pressure is fixed by the atmospheric pressure applied to the tailpipe, the dynamic component of pressure is dependent upon the velocity and density of the exhaust gas. Accordingly, increasing the path distance (by increasing the swirl angle) results in a corresponding increase in particle velocity. Accelerating the exhaust gas particles further increases the shear applied to the wall of the turbine outlet, thus providing the advantages listed above.

In yet other embodiments, the current property may be a turbine inlet pressure and the reference property may be a turbine inlet pressure. The low-shear operating condition may be identified when the current operating efficiency is above a particular range or threshold.

In some embodiments, the low shear operating condition can be identified based upon one or more of the EER, turbine efficiency or turbine inlet pressure. Regardless of the current property used to identify the low-shear operating condition, if the low-shear operating condition does not exist, the method 700 returns to the first step via branch 710. If the low-swirl operating condition does exist, the method 700 moves via branch 712 to step 708, in which the controller 228 outputs a command to the variable geometry mechanism 216 and/or the bypass control valve 212 to adjust the current operating configuration of the variable geometry mechanism 216 and/or the bypass control valve 212. In the case of the variable geometry mechanism 216, this may include moving the variable geometry mechanism to or towards a configuration (e.g., position of the mechanism or the like) corresponding to a maximum shear applied by the exhaust gas at a particular location of the turbine outlet passage 210. The configuration corresponding to a maximum shear at the particular location may be determined during the design and development of the exhaust gas system, for example using computer simulations such as computational fluid dynamics and/or by testing in an engine test cell. In the case of the bypass control valve, this may include moving the bypass control valve 214 to or towards a configuration corresponding to a maximum shear applied by the exhaust gas at a particular location of the turbine outlet passage 210. This may be determined during the design and development of the exhaust gas system, for example using computer simulations such as computational fluid dynamics and/or by testing in an engine test cell. When the turbine 204 is the same or has the same construction as the turbine described above in relation to FIGS. 2 to 6, in which the bypass flow enters the turbine outlet in a tangential direction, the configuration corresponding to a maximum shear of the exhaust gas in the turbine outlet passage 210 may be a configuration corresponding to a maximum flow rate through the bypass valve.

FIGS. 70 to 72 show computational fluid dynamics plots of wall shear within the interior of the turbine outlet 750 at three different wastegate operating conditions. The turbine outlet 750 is, in particular, the turbine outlet of the turbine described above in relation to FIGS. 2 to 6. The top left plot (FIG. 70) shows the wall shear when the wastegate is closed, the top right plot (FIG. 71) shows the wall shear when the wastegate is 50% open, and the bottom left plot (FIG. 72) shows the wall shear when the wastegate is fully open. The wastegate flow enters the turbine outlet 750 via the wastegate passage outlet, the position of which is generally indicated by reference numeral 752.

Reference numeral 754 identifies a particular location of the turbine outlet passage 750. The particular location 754 is a region of the turbine outlet passage wall that is positioned directly opposite a dosing module (not shown) that delivers aftertreatment fluid to the turbine outlet passage 750. During use, the momentum imparted on the aftertreatment fluid by the dosing module carries the aftertreatment fluid across the turbine outlet 750, such that some of the aftertreatment fluid may impinge upon the wall of the turbine outlet 750 at the location 754. It can be seen from the plots that when the wastegate passage is closed, the shear stress at the location 754 is low. Accordingly, there is a risk that urea contained in the aftertreatment fluid could solidify at the location 754 and cause a restriction in the turbine outlet 750. However, when the wastegate passage is partially or fully open, the shearing forces at the location 754 are increased. Increasing the shearing forces applied by the exhaust gas to the location 754 acts to spread out any impinged fluid, increases heat transfer to the impinged fluid, and re-entrains molecules from the free surface of the impinged fluid into the flow. Accordingly, the risk of deposit solidification at the location 754 is mitigated by increasing the shear forces at the location 754.

FIGS. 73 to 82 show further computational fluid dynamics plots of wall shear stress in the exhaust system. FIGS. 73 to 82 differ from FIGS. 70 to 72 in that they show the turbine outlet passage 750 and the downpipe 756. In the first column (FIGS. 73 to 75), the wastegate is closed, in the second column (FIGS. 76 to 79) the wastegate is partially open, and in the third column (FIGS. 80 to 82) the waste gate is fully open. Again, it can be seen that by opening the wastegate the shear applied to one or more particular locations of the turbine outlet and/or downpipe can be increased.

It will be appreciated that the technique described above therefore allows the bypass and/or variable geometry mechanisms to be used to adjust shearing forces in the exhaust system at a particular location of the exhaust system. The effect of wastegate and/or variable geometry operating conditions on shear forces can be modelled using simulations or testing and stored as one or more formulas or datasets in the controller. Accordingly, the controller can modulate the actuation of the bypass control valve and/or variable geometry mechanism to mitigate against deposit formation across a range of operating conditions of the exhaust system.

Turning to FIG. 83, a flowchart is provided which schematically indicates a method 800 according to another embodiment of the disclosure. In this embodiment, a current property and reference property are of an aftertreatment device (such as a catalytic converter). The property of the aftertreatment device that is determined may be a temperature (i.e., a current temperature) of the aftertreatment device. The property of the aftertreatment device that is determined may be a metric indicative of the need to regenerate the aftertreatment device. The property of the aftertreatment device that is determined may be an efficiency of the aftertreatment device.

The aftertreatment device may be, in particular, the aftertreatment device of any of the exhaust systems previously described herein above. For example, the aftertreatment device may be the aftertreatment device 218 of the embodiment of FIG. 7. The turbine may be, in particular, the turbine of any of the exhaust systems previously described herein above. For example, the turbine may be the turbine 204 of the embodiment of FIG. 7, or the turbine of the embodiment of FIGS. 2 to 6.

At a first step 802, a current property of the aftertreatment device is determined. The current property may be determined by directly measuring the property (e.g., by measuring a temperature using a temperature sensor, such as a thermocouple). Alternatively, the current property may be determined based upon the measurement of another property (whether a property of the aftertreatment device or otherwise, such as for example a property of an exhaust mixture passing through the exhaust system), processing that measurement and inferring the current property of the aftertreatment device from the processing. For example, the current property may be determined based upon one or more of: a time period since a previous regeneration event, a time period since engine ignition, a current NOx reduction amount over one or more catalytic converters, pressure drop across the turbine, and/or turbine inlet pressure. An unexpected (e.g., increasing) pressure drop across the turbine and/or increasing turbine inlet temperature may be indicative of a build-up of deposits (e.g., in the aftertreatment device). The current property of the aftertreatment device may be based upon one or more properties of exhaust gas (e.g., a temperature of exhaust gas, pressure drop across the aftertreatment device, reduction of NOx across the aftertreatment device etc.).

Turning to step 804, a reference property of the exhaust gas is determined. It will be appreciated that the reference property preferably corresponds to the current property insofar as the type of property used (e.g., as set out above, a temperature of the aftertreatment device).

Turning to step 806, a difference is determined between the current property and the reference property. Where the current property is a single property at a single spatial position, the difference may be a subtraction equation. Where the current property comprises a plurality of properties, the difference may be calculated on the basis of a statistical comparison.

At step 808, the difference determined in step 806 is analysed to ascertain whether the difference falls outside of an acceptable range. The acceptable range may be based upon a permissible level of degradation of the aftertreatment device (e.g., a range of acceptable working efficiencies of the aftertreatment device). The acceptable range may be based upon a temperature range in which the catalyst functions but does not degrade. The acceptable range may be a permissible pressure drop across the aftertreatment device (e.g., indicative that significant deposits have not built-up). The acceptable range may be an acceptable reduction of NOx across the aftertreatment device.

If the difference calculated at step 808 does not fall outside of an acceptable range, the method returns to step 802 as indicated by line 810. There may be a delay before the method 800 restarts at step 802. Alternatively, the method 800 may continue to cycle repeatedly without any delay. The method is preferably carried out periodically. The method may be carried out in a dynamic periodic manner. For example, a minimum target interval of use, such as 100 hours, may be set before a regeneration event. Put another way, a regeneration event may be carried out only after 100 hours of use.

The difference calculated at step 808 falling outside an acceptable range may be indicative of a need to regenerate the aftertreatment device. In response to the difference calculated at step 808 falling outside an acceptable range, as indicated by line 812, the method moves to step 814. At step 814 the variable geometry mechanism and/or bypass control valve is adjusted. Based upon the difference falling outside of an acceptable range, as calculated at step 808, the variable geometry mechanism and/or bypass control valve may be adjusted to increase the temperature of the aftertreatment device. The temperature of the aftertreatment device may be increased to, for example, at least around 500° K, at least around 700° K, and at least around 800° K. In order to regenerate the aftertreatment device, the temperature is increased and then held at the increased level. The temperature may be increased for at least around 600 seconds, more preferably at least around 1200 seconds, and more preferably at least around 1800 seconds. The variable geometry mechanism and/or bypass control valve may be adjusted for at least around 600 seconds, more preferably at least around 1200 seconds, and more preferably at least around 1800 seconds

The effect of increasing the temperature of the aftertreatment device, and maintaining the increased temperature for a time period, is that the aftertreatment device is regenerated. Deposits within the aftertreatment device are thus burned off (e.g., oxidised), increasing the operating efficiency of the aftertreatment device. Deposits encompasses soot. Typical regeneration temperatures of soot are around 800° K, although the regeneration temperature may be reduced to around 500° K if a sufficient level of NO₂ is present.

In preferred embodiments, responsive to step 808 identifying the difference falls outside of an acceptable range, it is the bypass control valve which is adjusted. In particular, the bypass control valve is opened so that high energy, and high temperature, (bypass) exhaust gas which has not been expanded across the turbine wheel is placed in fluid communication with the aftertreatment device. When used in conjunction with a wastegate passage geometry, the exhaust gas velocity is increased from the wastegate passage into the turbine outlet passage (e.g., a tangential reintroduction of bypassed exhaust gas). The engine speed may also be adjusted (e.g., ramped) before the bypass control valve is adjusted.

The regeneration of an aftertreatment device as described above has been found to be comparatively fast in comparison to known methods, owing to the use of bypassed exhaust gas. Regeneration may otherwise be defined as the aftertreatment device reaching a target temperature, and then being held at least at that target temperature for a period of time.

The regeneration referred to above may specifically be applied to a catalytic converter (an example of an aftertreatment device).

Throughout this document, adjusting a variable geometry mechanism or position of a bypass control valve may otherwise be described as adjusting an expansion ratio across the turbine.

For any of the embodiments described above: the bypass control valve may be an eWastegate (e.g., an electronically actuated wastegate), a rotary control valve, a pneumatically controlled wastegate valve, or other variety of valve.

For any of the embodiments described above: bypassed exhaust gas, having passed through the bypass control valve, is preferably discharged into the turbine outlet passage upstream of, or at a corresponding position to, the dosing module. Described another way, a wastegate passage outlet is preferably upstream of, or generally aligned with (e.g., encompassing overlying), the dosing module (e.g., an outlet thereof, or a primary impingement zone defined by the dosing module).

As a general principle, in all of the embodiments described above it will be appreciated that because the dosing module 220 is positioned close to the turbine wheel 208 this ensures that aftertreatment fluid is delivered to the exhaust system in a region that has relatively high temperature and flow velocity, and that is heavily influenced by the operating characteristics of the variable geometry mechanism 216 and/or bypass control valve 214. The control methodologies described above will provide a pronounced effect on the flow characteristics (velocity, swirl, temperature etc.) in the vicinity of the region in which the aftertreatment fluid is delivered. Accordingly, the control methodologies described herein are particularly suitable for and advantageous within dosing systems in which dosing occurs close to the turbine wheel (e.g., within 10 turbine exducer diameters or less).

1. A method of operating an exhaust system for receiving exhaust gas from an internal combustion engine, the exhaust system comprising:
a turbine configured to receive exhaust gas from the internal combustion engine, the turbine comprising a turbine wheel configured to extract energy from the exhaust gas;
a dosing module configured to deliver an aftertreatment fluid to the exhaust gas at a position downstream of the turbine wheel;
at least one of:
a variable geometry mechanism configured to control the flow of exhaust gas delivered to the turbine wheel; and
a bypass control valve configured to bypass a portion of the exhaust gas from a position upstream of the turbine wheel to a position downstream of the turbine wheel; and
a controller configured to execute the method, the method comprising:
determining a current property of the exhaust gas at a position downstream of the turbine wheel;
determining a difference between the current property of the exhaust gas at the position downstream of the turbine wheel and a reference property of the exhaust gas at the position downstream of the turbine wheel; and
in response to the difference, adjusting the at least one of the variable geometry mechanism and the bypass control valve.

2. A method according to claim 1, wherein determining the current property comprises:
measuring a quantity of one or more properties of an internal combustion engine system in which the exhaust system is incorporated;
processing the measured quantity or quantities in a computational operation; and
inferring the current property of the exhaust gas from the computational operation.

3. A method according to claim 2, wherein measuring the one or more properties of the exhaust gas comprises measuring one or more of:
a turbine inlet pressure;
a turbine inlet temperature;
a turbine outlet pressure;
a turbine outlet temperature;
an engine speed;
a throttle position;
an engine air mass flow rate;
an engine inlet pressure;
an engine inlet temperature;
a NOx concentration;
a catalyst gas temperature;
an engine fuel flow rate,
an engine air flow rate,
an engine boost pressure,
an engine load,
an engine cylinder temperature,
an engine cylinder pressure,
an engine fuel pressure, or
a turbine rotational speed.

4. A method according to claim 1, wherein the current property of the exhaust gas comprises a current temperature profile of the exhaust gas and the reference property of the exhaust gas comprises a reference temperature profile of the exhaust gas.

5. A method according to claim 4, wherein the current temperature profile of the exhaust gas is determined based upon one or more of: a current NOx reduction amount across one or more catalytic converters; an inlet exhaust gas temperature of an aftertreatment device; an outlet exhaust gas temperature of an aftertreatment device; a temperature of exhaust gas within an aftertreatment device; and an excess energy ratio (EER).

6. A method according to claim 5, wherein if a rate of decomposition of aftertreatment fluid droplets in the flow of exhaust gas and/or if a start-up time of the aftertreatment device falls outside of an acceptable range, the at least one of the variable geometry mechanism and the bypass control valve is adjusted to increase a temperature of the exhaust gas at the core of the exhaust gas flow.

7. A method according to claim 5, wherein if a risk of deposit build-up falls outside of an acceptable range, the at least one of the variable geometry mechanism and the bypass control valve is adjusted to increase a temperature of the exhaust gas at a periphery of the exhaust gas flow.

8. A method according to claim 1, wherein the current property of the exhaust gas comprises a current velocity profile of the exhaust gas and the reference property of the exhaust gas comprises a reference velocity profile of the exhaust gas.

9. A method according to claim 8, wherein determining the current property of the exhaust gas is based upon one or more of: a pressure ratio across the turbine; a turbine inlet pressure; a turbine outlet pressure; turbine inlet temperature, a turbine outlet temperature, turbine rotational speed, and an engine mass flow rate.

10. A method according to claim 9, wherein if a risk of deposit build-up falls outside of an acceptable range, the at least one of the variable geometry mechanism and the bypass control valve is adjusted to vary the velocity profile at the position downstream of the turbine wheel.

11. A method according to claim 10, wherein the position downstream of the turbine wheel is: i) a location of the dosing module; or ii) downstream of the dosing module.

12. (canceled)

13. A method according to claim 1, wherein the method further comprises:
identifying, based upon the difference, the existence of an operating condition of the exhaust system in which an insufficient swirl angle of the exhaust gas in the turbine outlet passage is generated; and
adjusting the at least one of the variable geometry mechanism and the bypass control valve in response to the identification of the operating condition to increase the swirl angle of the exhaust gas in the turbine outlet passage.

14. A method according to claim 13, wherein adjusting the variable geometry mechanism to increase the swirl angle of the exhaust gas in the turbine outlet passage comprises moving the variable geometry mechanism to or towards a configuration corresponding to a maximum swirl angle of the exhaust gas in the turbine outlet passage.

15. (canceled)

16. A method according to claim 13, wherein the current property of the exhaust gas comprises a current NOx reduction amount across one or more catalytic converters, and wherein the reference property of the exhaust gas comprises a reference NOx reduction amount across the one or more catalytic converters.

17. (canceled)

18. (canceled)

19. (canceled)

20. A method according to claim 1, wherein the method further comprises:
identifying, based upon the difference, the existence of an operating condition of the exhaust system in which insufficient shear stress is applied to the wall of the exhaust system by the exhaust gas at a particular location; and
adjusting the at least one of the variable geometry mechanism and the bypass control valve in response to the identification of the operating condition to increase the amount of shear stress applied to the wall of the exhaust system by the exhaust gas at the particular location.

21. (canceled)

22. (canceled)

23. A method according to claim 20, wherein the current property of the exhaust gas comprises an excess energy ratio (EER) and the reference property of the exhaust gas comprises a reference excess energy ratio.

24. (canceled)

25. (canceled)

26. (canceled)

27. (canceled)

28. A method according to claim 1, wherein the turbine comprises:
a turbine outlet passage configured to receive exhaust gas form the turbine wheel, the exhaust gas received from the turbine wheel defining a turbine bulk flow; and
a bypass passage configured to receive exhaust gas from a position upstream of the turbine wheel and to deliver the exhaust gas to the turbine outlet passage, the exhaust gas received by the bypass passage defining a bypass flow, the bypass control valve being configured to regulate the flow rate of bypass flow through the bypass passage;
wherein the turbine wheel imparts a swirling momentum onto the turbine bulk flow, the swirling momentum of the turbine bulk flow defining a positive angular direction, and wherein the bypass passage is configured to deliver the bypass flow to the turbine outlet passage in a direction that induces swirling of the bypass flow about a centreline of the turbine outlet passage in the positive angular direction;
wherein the method further comprises:
identifying, based upon the difference, the existence of an operating condition of the exhaust system in which insufficient swirling momentum of exhaust gas is generated about the centreline of the turbine outlet passage; and
adjusting the bypass control valve to increase the delivery of bypass flow to the turbine outlet passage.

29. A method according to claim 1, wherein the turbine comprises:
a turbine outlet passage configured to receive exhaust gas form the turbine wheel, the exhaust gas received from the turbine wheel defining a turbine bulk flow; and
a bypass passage configured to receive exhaust gas from a position upstream of the turbine wheel and to deliver the exhaust gas to the turbine outlet passage, the exhaust gas received by the bypass passage defining a bypass flow, the bypass control valve being configured to regulate the flow rate of bypass flow through the bypass passage;
wherein the turbine wheel imparts a swirling momentum onto the turbine bulk flow, the swirling momentum of the turbine bulk flow defining a positive angular direction, and wherein the bypass passage is configured to deliver the bypass flow to the turbine outlet passage in a direction that induces swirling of the bypass flow about a centreline of the turbine outlet passage in the positive angular direction;
wherein the method further comprises:
identifying, based upon the difference, the existence of an operating condition of the exhaust system in which insufficient shear stress is applied to the wall of the exhaust system by the exhaust gas at a particular location; and
adjusting the bypass control valve in response to the identification of the operating condition to increase the delivery of bypass flow to the turbine outlet passage.

30. A method according to claim 29, wherein the particular location is a wall of the turbine outlet passage.

31. A method of operating an exhaust system for receiving and treating exhaust gas from an internal combustion engine, the exhaust system comprising:
a turbine configured to receive exhaust gas from the internal combustion engine, the turbine comprising a turbine wheel configured to extract energy from the exhaust gas;
a dosing module configured to deliver an aftertreatment fluid to the exhaust gas at a position downstream of the turbine wheel, wherein the dosing module is located within around 10 exducer diameters, along a flow axis, downstream of a downstream end of the turbine wheel;
at least one of:
a variable geometry mechanism configured to control the flow of exhaust gas delivered to the turbine wheel; and
a bypass control valve configured to bypass a portion of the exhaust gas from a position upstream of the turbine wheel to a position downstream of the turbine wheel;
an aftertreatment device located downstream of the turbine and configured to receive, and treat, exhaust gas from the turbine; and
a controller configured to execute the method, the method comprising:
determining a current property of the aftertreatment device;
determining a difference between the current property of the aftertreatment device and a reference property of the aftertreatment device; and
in response to the difference, adjusting the at least one of the variable geometry mechanism and the bypass control valve to regenerate the aftertreatment device.

32. A method according to claim 31, wherein determining a current property of the aftertreatment device comprises determining a temperature of the aftertreatment device.

33. (canceled)

34. (canceled)

35. An exhaust system for receiving exhaust gas from an internal combustion engine, the exhaust system comprising:
a turbine configured to receive exhaust gas from the internal combustion engine, the turbine comprising a turbine wheel configured to extract energy from the exhaust gas;
a dosing module configured to deliver an aftertreatment fluid to the exhaust gas at a position downstream of the turbine wheel;
at least one of:
a variable geometry mechanism configured to control the flow of exhaust gas delivered to the turbine wheel; and
a bypass control valve configured to bypass a portion of the exhaust gas from a position upstream of the turbine wheel to a position downstream of the turbine wheel; and
a controller configured to:
determine a current property of the exhaust gas at a position downstream of the turbine wheel;
determine a difference between the current property of the exhaust gas at the position downstream of the turbine wheel and a reference property of the exhaust gas at the position downstream of the turbine wheel; and
in response to the difference, adjust the at least one of the variable geometry mechanism and the bypass control valve.

36.-74. (canceled)

75. A turbocharger system comprising:
a compressor, the compressor comprising a compressor housing and a compressor wheel;
a bearing housing, the bearing housing being configured to support a shaft for rotation about an axis; and
the exhaust system according to claim 35;
wherein the compressor wheel and turbine wheel are coupled to the shaft in power communication with one another.

76. An engine arrangement comprising;
an internal combustion engine; and
the turbocharger system according to claim 75;
wherein the turbocharger is configured to receive exhaust gas from the internal combustion engine.

77. (canceled)

78. (canceled)
